(19) United States
(12) Patent Application Publication
(10) Pub. No.: US 2026/0251945 A1
(43) Pub. Date: Aug. 27, 2026

(54) DYNAMIC HOST AND GUEST INTERACTION FOR SUSTAINABLE ELECTROCHROMIC DISPLAY

(71) Applicant: BOARD OF REGENTS, THE UNIVERSITY OF TEXAS SYSTEM, Austin, TX (US)

(72) Inventors: Guihua YU, Austin, TX (US); Yuyang Wang, Austin, TX (US)

(73) Assignee: BOARD OF REGENTS, THE UNIVERSITY OF TEXAS SYSTEM, Austin, TX (US)

(21) Appl. No.: 19/160,952

(22) PCT Filed: Mar. 4, 2024
(86) PCT No.: PCT/US24/18368

§ 371 Date: Aug. 29, 2025

Related U.S. Application Data
(60) Provisional application No. 63/488,428, filed on Mar. 3, 2023.

(51) Int. Cl. G02F 1/1503; G02F 1/1516; G02F 1/1523

(52) U.S. Cl. CPC G02F 1/1503; G02F 1/15165; G02F 1/1525

(57) ABSTRACT

Described herein are electrochromic (EC) devices with improved reusability and recyclability. The EC devices described herein utilize an EC mechanism based on host unit and guest unit interactions. The host unit and guest unit can reversibly form a host-guest complex upon a first reduction or oxidation stimulation. The host-guest complex can reversibly dissociate to the host unit and the guest unit upon a second oxidation or reduction stimulation. The EC devices described herein can reversibly switch between transparent (or colorless) states and colored states based on the reversible dissociation of the host-guest complex as described herein. Also described herein are methods of making and using the EC devices described herein.

### CROSS-REFERENCE TO RELATED APPLICATIONS

This application claims the benefit of and priority to U.S. Provisional Application No. 63/488,428, filed on Mar. 3, 2023, which is hereby incorporated by reference in its entirety.

### FIELD

Embodiments of the present invention are in the field of electrochromic devices and displays. Embodiments relate generally electrochromic devices and methods of making and using the same.

### BACKGROUND

Smart windows, which may contribute energy saving in buildings via reducing lighting, cooling and heating loads, may be useful for decarbonization. Electrochromic displays, the transmittance of which can be reversibly switched under voltage stimulation, can be applied in smart windows and infotainment content displays due to their active control mode, reversibility, and optical properties.

### SUMMARY

Described herein are electrochromic (EC) devices with improved reusability and recyclability. The EC devices described herein utilize an EC mechanism based on host unit and guest unit interactions. The host unit and guest unit can reversibly form a host-guest complex upon a first reduction or oxidation stimulation. The host-guest complex can reversibly dissociate to the host unit and the guest unit upon a second oxidation or reduction stimulation. In some examples, the formation of the host-guest complex may correspond to a colored state in the EC device, whereas the dissociation of the host-guest complex into the host unit and guest unit may correspond to a transparent or colorless state in the EC device. The EC devices described herein can reversibly switch between transparent (or colorless) states and colored states based on the reversible dissociation of the host-guest complex as described herein. Also described herein are methods of making and using the EC devices described herein.

Provided herein is an electrochromic device, comprising a first electrode; an electrochromic layer over the first electrode, wherein the electrochromic layer comprises an electrolyte, a host unit, and a guest unit; an ion conducting layer over the electrochromic layer; an ion storage layer over the ion conducting layer; and a second electrode over the ion storage layer, wherein the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex.

Also provided herein is a method of making an electrochromic device, the method comprising positioning an electrochromic layer over a first electrode, wherein the electrochromic layer comprises an electrolyte, a host unit, and a guest unit; positioning an ion conducting layer over the electrochromic layer; positioning an ion storage layer over the ion conducting layer; and positioning a second electrode over the ion storage layer, wherein the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex.

Also provided herein is a method comprising providing an electrochromic device, the electrochromic device comprising a first electrode; an electrochromic layer over the first electrode, wherein the electrochromic layer comprises an electrolyte, a host unit, and a guest unit; an ion conducting layer over the electrochromic layer; an ion storage layer over the ion conducting layer; and a second electrode over the ion storage layer, wherein the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex; applying a first voltage between the first electrode and the second electrode corresponding to a first reduction or oxidation stimulation, and applying a second voltage between the first electrode and the second electrode corresponding to a second reduction or oxidation stimulation.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides a schematic illustration of an example electrochromic device.

FIG. 2 provides an overview of operation of an example electrochromic device.

FIG. 3A provides an example of a reversible color change of an example electrochromic device, FIG. 3B shows a reversible formation of a host-guest complex from separate host unit and guest unit, and FIG. 3C shows a reversible change between a colorless state and a colored state using iodide ions.

FIG. 4 provides a schematic illustration of an example of a method of making an electrochromic device.

FIG. 5 provides a schematic illustration of features of an electrochromic system in accordance with some examples.

FIG. 6A provides a plot showing absorption spectra and an inset of a digital photograph of an electrochromic system in accordance with some examples. FIG. 6B provides cyclic voltammograms of an electrochromic system in accordance with some examples. FIG. 6C provides absorption spectra an electrochromic system in accordance with some examples before and after voltage stimulation. FIG. 6D provides infrared (IR) spectra of an electrochromic system in accordance with some examples under the voltage of 1.5 V. FIG. 6E shows X-ray diffraction (“XRD”) of host-guest interactions in accordance with some examples. FIG. 6F shows Raman spectra of an electrochromic system in accordance with some examples under the voltage of 1.5 V.

FIGS. 7A-I generally correspond to an EC device optimization. FIG. 7A provides a schematic of an example EC device. FIG. 7B shows a schematic illustration of the ion and electron transfer involved in the tinting and color fading process. FIG. 7C provides plots of the peak current densities of an electrochromic system in accordance with some examples. FIG. 7D, FIG. 7E, FIG. 7F, FIG. 7G, and FIG. 7H provide transmittance of an electrochromic system in accordance with some examples. FIG. 7I shows radius and diffusion coefficient for different hydrated cations in aqueous solution.

FIG. 8 provides an illustration of an example electrochromic device including a cation conducting membrane.

FIG. 9 provides a sectional view of an example electrochromic layer of an electrochromic device.

FIG. 10 provides an illustration of three example ionic gel matrices including PDMAEA, PDMAPS, and PAM.

FIG. 11 provides a plot providing a comparison of change in transmittance and decay ratio for ionic gel matrices including PAM, PDMAEA, and PDMAPS.

FIG. 12A-H generally provide plots showing electrochromic device characteristics. FIG. 12A shows different grayscale displays with different voltage stimulation. FIG. 12B shows transmittance spectra of the optimized EC device under different voltage stimulations. FIG. 12C shows maximum transmittance changes of different EC systems described herein. FIG. 12D shows coloration efficiency of an example of an EC system as described herein. FIG. 12E shows reversibility of an example of an EC device as described herein. FIG. 12F shows transmittance change of an example of an EC device as described herein. FIG. 12G shows coloration efficiency of an example of an EC device as described herein. FIG. 12H shows comparison of different EC systems.

FIG. 13 provides a plot showing voltage stimulation and a corresponding amount of absorption at wavelengths ranging from 400 nm to 800 nm.

FIG. 14 provides a plot showing transmittance and wavelength at a voltage stimulation of +1.9 V and −1.2 V, respectively.

FIG. 15 provides a top plot of voltage stimulation over time and a bottom plot of transmittance over time for an example electrochromic device.

FIGS. 16A-E generally correspond to an example of the EC window and non-emissive transparent display based on dynamic host-guest interaction as described herein. FIG. 12A shows the display process of one example of the EC device described herein. FIG. 12B shows the transparent EC display based on one example of the EC device described herein. FIGS. 12C and 12D show the multicolor transparent EC display prototype and related absorption spectra. FIG. 12E shows HOMO and LUMO frontier orbitals of an example of the host unit, guest unit, and host-guest complex.

FIG. 17 provides data showing the ¹H NMR spectra (400 MHz, DMSO-d₆) of amylose extracted from corn.

FIG. 18 provides a diagram of electrolytic cell for fabricating a mixture of host and guest units in accordance with some examples.

FIG. 19 provides a scheme for the preparation of an electrochromic system in accordance with some examples.

FIG. 20 provides data showing cyclic voltammograms of Tempo-OH and hydroquinone (1.0×10⁻³ mol/L/1.0×10⁻³ mol/L) in aqueous solution. (WE: glass-carbon electrode; CE: Pt; RE: Ag/AgCl).

FIGS. 21A-D provide transmittance change of the device with different ratios of KI/amylose (1:0.5 for FIG. 21A, 1:1 for FIG. 21B, 1:2 for FIG. 21C, 1:2.5 for FIG. 21D) in electrochromic layer under the voltage of +1.9 V/−0.9 V.

FIGS. 22A-D provide plots showing transmittance change of electrochromic systems with different concentrations of KI/amylose (0.02 mol/L/0.05 mol/L for FIG. 22A, 0.03 mol/L/0.075 mol/L for FIG. 22B, 0.04 mol/L/0.10 mol/L for FIG. 22C, 0.05 mol/L/0.125 mol/L for FIG. 22D) in an electrochromic layer under the voltage of +1.9 V/−0.9 V in accordance with some examples.

FIGS. 23A-E provide plots showing transmittance change of electrochromic systems with different thicknesses of the electrochromic layer (183 μm for FIG. 23A, 220 μm for FIG. 23B, 240 μm for FIG. 23C, and 416 μm for FIG. 23D) under the voltage of +1.9 V/−0.9 V in accordance with some examples.

FIGS. 24A-E provide plots showing transmittance change of electrochromic systems with electrolytes (FIG. 24A for NaCl, FIG. 24B for KCl, FIG. 24C for MgCl₂, FIG. 24D for AlCl₃, and FIG. 24E for NH₄Cl) under the voltage of +1.9 V/−0.9 V in accordance with some examples.

FIG. 25 provides plots showing transmittance change of an electrochromic system under a voltage of 1.9 V/−0.9V with different irradiation times of UV light in accordance with some examples.

FIGS. 26A and 26C provide SEM images of electrodes involved in proton-coupled electron transfer (PCET) plots showing transmittance change of electrochromic systems in accordance with some examples. FIGS. 26B and 26D provide EDS elemental mappings of the electrodes involved in proton-coupled electron transfer (PCET) plots showing transmittance change of electrochromic systems in accordance with some examples.

FIGS. 27A and 27C provide SEM images of electrodes involved in dynamic coordination electrochromic devices. FIGS. 27B and 27D provide EDS elemental mappings of the electrodes involved in dynamic coordination electrochromic devices.

FIGS. 28A and 28C provide SEM images of electrodes involved in WO_{3-X} nanowires electrochromic devices. FIGS. 28B and 28D provide EDS elemental mappings of the electrodes involved in WO_{3-X} nanowires electrochromic devices.

FIGS. 29A and 29B provide images of electrodes, and FIG. 29C provides the reversibility of electrochromic devices of some examples.

FIG. 30A provides an SEM image of electrodes before involving in EC device of electrochromic systems in accordance with some examples. FIG. 30B provides EDS elemental mappings of electrodes before involving in EC device of electrochromic systems in accordance with some examples. FIG. 30C provides an SEM image of electrodes after 1200 reuses in the EC device of electrochromic systems in accordance with some examples. FIG. 30D provides EDS elemental mappings of electrodes after 1200 reuses in the EC device of electrochromic systems in accordance with some examples.

FIGS. 31A-D provide the coloration efficiency of the EC device of electrochromic systems by reusing different times (FIG. 31A for 1 cycle, FIG. 31B for 400 cycles, FIG. 31C for 800 cycles, FIG. 31D for 1200 cycles) of an ITO electrode and ion conducting film in accordance with some examples.

FIG. 32 provides a schematic for an etching process for non-emissive transparent display of electrochromic systems in accordance with some examples.

FIG. 33 provides molecular geometries determined using density functional theory (DFT) calculations for the optimized structure of the amyloid fragments.

### DETAILED DESCRIPTION

Described herein are electrochromic (EC) devices with improved efficiency, reusability, and recyclability, that can be applied in smart window, non-emissive transparent display, and multicolor display applications. Other technologies may have higher power consumption, with power needing to be applied to maintain a current state and/or may not include sustainable and/or biodegradable components. The EC devices described herein include an electrochromic layer that comprises host units and guest units. The host units and guest units described herein utilize an EC mechanism based on host unit and guest unit interactions. In some examples, the host units can be extracted from biomass, thus avoiding complex chemical synthesis. The host units described herein include, but are not limited to, starches and cyclodextrins. The guest units described herein include, but are not limited to, anions and organic redox molecules. In some examples, the host units and guest units of the EC devices described herein are water soluble, which helps minimize or limit the presence of insoluble particulates deposited onto the electrode and can help increase the lifespan of the electrode, such that the electrode can be reused at least 100 or up to 100000 times, for example.

The host unit and guest unit in the electrochromic layer described herein can reversibly form a host-guest complex upon a first reduction or oxidation stimulation. Prior to the first reduction or oxidation stimulation, the EC device may be in a transparent or colorless state (e.g., wherein the transmittance of visible, infrared, and/or ultraviolet electromagnetic radiation is at least 70%). Upon the first oxidation or reduction stimulation, the host unit and guest unit may form the host-guest complex, corresponding to a colored state in the EC device (e.g., wherein the transmittance of visible, infrared, and/or ultraviolet electromagnetic radiation is at most 70%). The host-guest complex of the EC device can reversibly dissociate to the host unit and the guest unit upon a second oxidation or reduction stimulation. Thus, the EC devices described herein can reversibly switch between transparent (or colorless) states and colored states based on the reversible dissociation of the host-guest complex as described herein.

Also described herein are methods of making and methods of using EC devices as described herein.

### Definitions

In general the terms and phrases used herein have their art-recognized meaning, which can be found by reference to standard texts, journal references, and contexts known to those skilled in the art. The following definitions are provided to clarify their specific use in the context of the invention.

“Electrochromic” and “electrochromism” refer to reversible transparency changes, color changes, or changes to absorption spectra of a material caused by an applied electric field or current.

“Host unit” refers to a molecule or structure that can reversibly bond or associate with another molecule or structure to form a host-guest complex, which may be held together by way of non-covalent bonds. In some examples, a host unit may refer to the larger of two molecules or structures that bond or associate or bond to form a host-guest complex. In some examples, a host unit may refer to a molecule or structure that adopts a particular characteristic charge or charge sign (e.g., a neutral molecule or structure or a cationic molecule or structure). Example host units useful in the context of the present disclosure include, but are not limited to a starch, a polymer, or a cyclodextrin. Specific example host units include, but are not limited to, cyclic polyether, cyclodextrin, dextrin, a starch, amylose, a cellulose, amylopectin, chitosan, pillararene, cucurbituril, calixarene, or a crown ether.

“Guest unit” refers to a molecule or structure that can reversibly bond or associate with another molecule or structure to form a host-guest complex, which may be held together by way of non-covalent bonds. In some examples, a guest unit may refer to the smaller of two molecules or structures that bond or associate or bond to form a host-guest complex. In some examples, a guest unit may refer to a molecule or structure that adopts a particular characteristic charge or charge sign (e.g., an anion). Example guest units useful in the context of the present disclosure include some atomic anions, molecular anions or organic redox molecules. Specific example guest units may include, but are not limited to, I⁻, Br⁻, Cl⁻, SO₃²⁻, NO₃²⁻, ClO⁻, PO₄³⁻, a p-benzoquinone derivative, a urea derivative, a hydroquinone derivative, or an organic redox molecule containing a carbonyl, carboxyl, amino and/or sulfhydryl group.

“Host-guest unit complex,” “host-guest complex,” “host-guest unit,” or “host-guest clatharate” refers to the association or complexation of a host unit and a guest unit by way of non-covalent bonds, allowing reversible complexation and dissociation to individual host unit and guest unit moieties. This association or complexation of the host unit and guest unit may proceed via, but is not limited to, dynamic hydrogen bonding interactions (hydrogen bonding) or Van der Waals interactions (Van der Waals forces), coordination interactions or other supramolecular interactions.

“Colorless” or “transparent” (or “colorless state” or “transparent state”) refers to the apparent color or transmissibility (e.g., when viewed by a human) of a component or device that is mostly see through and that may not exhibit any strong color. In some examples, a colorless or transparent component may be clear or neutral in color (e.g., light grey), as opposed to exhibiting a strong color or dark appearance (e.g., dark grey, black etc.). In some examples, when referring to EC devices or displays, colorless or transparent may refer the transmittance of visible, infrared, and/or ultraviolet electromagnetic radiation by the EC device or display being greater than or about 50% (e.g., greater than or about 60% or greater than or about 70%). In some examples, colorless or transparent materials may exhibit a uniform index of refraction, allowing photons passing through to follow Snell's law.

“Colored” or “opaque” (or “colored state” or “opaque state”) refers to the apparent color or transmissibility (e.g., when viewed by a human) of a component or device that is not see through and that may exhibit a strong color or dark appearance. In some examples, a colored or opaque component may prevent light from being directly transmitted through it, and may exhibit a dark (e.g., dark grey or black) color or appearance, as opposed to a clear or neutral but see through appearance (e.g., clear or light grey). In some examples, when referring to EC devices or displays, colored or opaque may refer to the transmittance of visible, infrared, and/or ultraviolet electromagnetic radiation by the EC device or display being less than or about 50% (e.g., less than or about 40%, less than or about 30%, less than or about 20%, or less than or about 10%). In some examples, components or devices that are opaque may alternatively be referred to as translucent, such as when they exhibit a transmittance greater than or about 10%, but the light is scattered such that photons that pass through do not follow Snell's law, such as because the component or device exhibits a non-uniform index of refraction.

Partially transparent may refer to transmittance levels less than levels considered transparent or greater than transmittance levels considered opaque, and may be between, for example about 10% and about 70%.

Various examples of electrochromic devices and methods and making and using the same are described in further detail below.

### 1. Electrochromic Devices

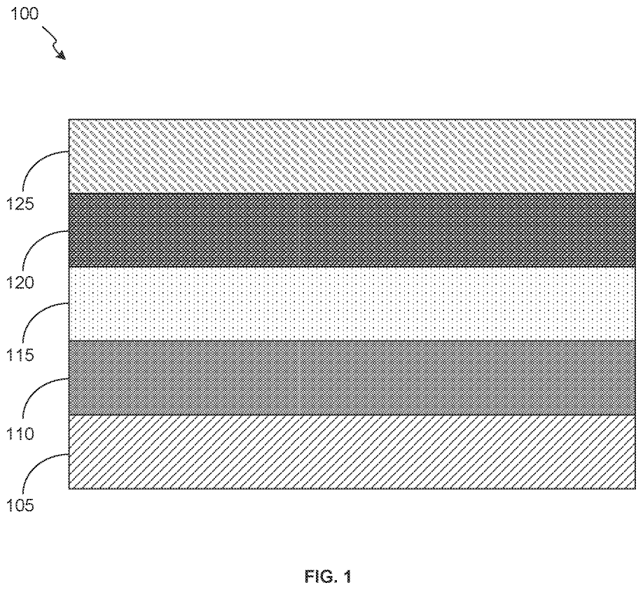

FIG. 1 provides a schematic illustration of an example electrochromic device 100 (EC device 100). Example electrochromic device 100 includes a first electrode 105, an electrochromic layer 110, an ion conducting layer 115, an ion storage layer 120, and a second electrode 125. In one example, the electrochromic layer 110 comprises an electrolyte, a host unit, and a guest unit. In some examples, the electrochromic layer may include one or more solvents and/or one or more polymer carriers.

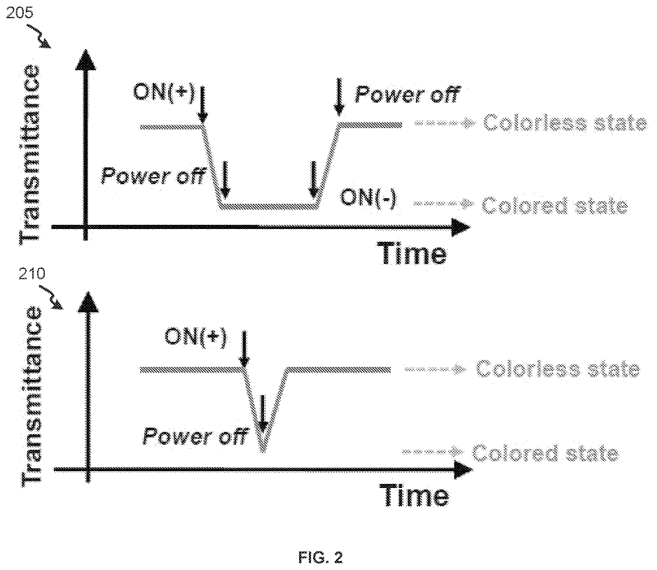

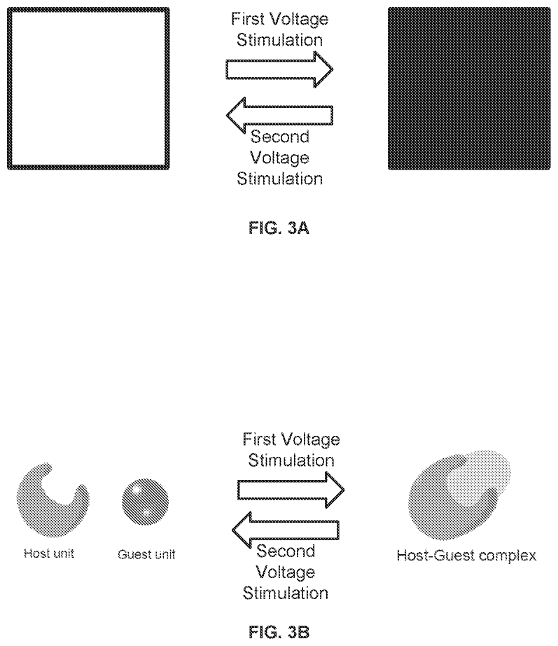

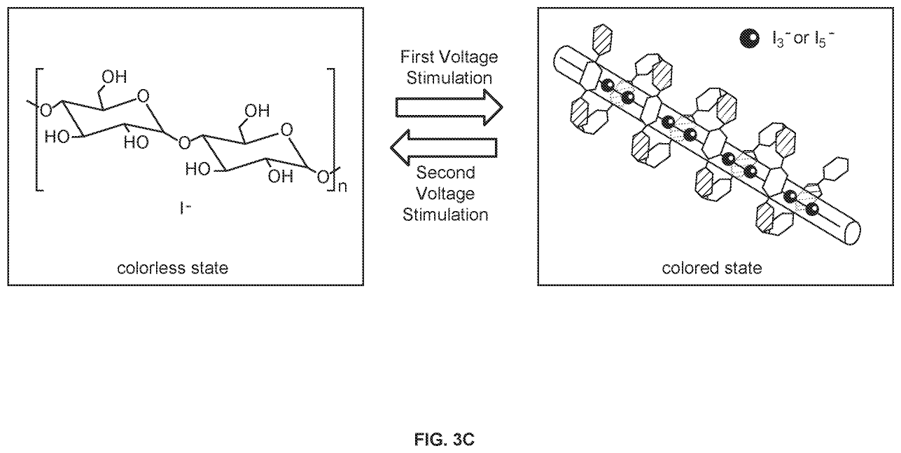

FIG. 2 provides an overview of operation of an example electrochromic device, wherein the electrochromic device is switched between a colorless state and a colored state based on voltage stimulations. As shown in FIG. 3A, the electrochromic device is transparent or colorless prior to a first voltage stimulation. Upon the first voltage stimulation step comprising applying an oxidizing or reducing voltage, the electrochromic device switches to a colored state. Upon a second voltage stimulation comprising applying a reducing or oxidizing voltage, the electrochromic device returns to the transparent or colorless state. In some examples, the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex, as shown in FIG. 3B.

In some examples, the first electrode 105 is an indium tin oxide (“ITO”) electrode. In some examples, the first electrode is graphene, glassy carbon, carbon nanomaterials, conjugated or conductive polymer, metal, metal oxide, MXenes or other conductive substance coated electrode.

In some examples, the second electrode 125 is an indium tin oxide (“ITO”) electrode. In some examples, the second electrode is graphene, glassy carbon, carbon nanomaterials, conjugated polymer, metal, metal oxide, MXenes or other conductive substance coated electrode. The first electrode 105 and the second electrode 125 can have any suitable or desired thickness. In some examples, the thickness of the first electrode 105 and/or the second electrode 125 may independently be from 15 nm to 2 cm, such as from 15 nm to 50 nm, from 50 nm to 100 nm, from 100 nm to 500 nm, from 500 nm to 1 m, from 1 m to 5 m, from 5 m to 10 m, from 10 m to 50 m, from 50 m to 100 m, from 100 m to 500 m, from 500 m to 1 mm, from 1 mm to 5 mm, from 5 mm to 1 cm, or from 1 cm to 2 cm.

In some examples, the electrochromic layer 110 may be or comprise an aqueous state, a gel state, or a solid film state. In some examples, the electrochromic layer 110 comprises an ionic gel. In some examples, the ionic gel is selected to provide an electrostatic interaction with the host unit, the guest unit, the host-guest complex, and any combination thereof. In some examples, the electrostatic interaction between the ionic gel and the host unit, the guest unit, the host-guest complex, and any combination thereof inhibits thermal diffusion of the host unit, the guest unit, the host-guest complex, and any combination thereof. In some examples, the electrochromic layer 110 comprises one or more solvents. In other examples, the electrochromic layer 110 comprises one or more polymer carriers. In other examples, the electrochromic layer 110 comprises one or more solvents and one or more polymer carriers. In some aspects, the solvent can include water, C1-C18-containing alcohols, C3-C24-containing ethers containing at least one oxygen atom, C2-C18-containing sulfoxides, C2-C18-containing sulfones, C3-C24-containing ketones, C3-C24-containing sulfides containing at least one sulfur atom, C1-C18-containing acids, C2-C18-containing esters, C1-C18-containing sulfonic acids, C1-C18-containing amides, C1-C18-containing alkenes, C1-C18-containing alkanes, C1-C18-containing alkynes, C3-C18-containing heterocycles containing at least one heteroatom O, S, N, P, C1-C18-containing aromatic hydrocarbons, alkanes containing at least one halogen atom, any combination of aromatic hydrocarbons containing at least one halogen atom, toluene, tetrahydrofuran, ethylene oxide, dichlormethane, ethyl acetate, oxacyclopropane, and/or propylene carbonate. In some aspects, the polymer carrier can include poly[2-(methacryloyloxy)ethyl]dimethyl-(3-sulfopropyl)ammonium hydroxide, polyvinylidene difluoride, poly(vinyl alcohol), conjugated polymer, poly(vinyl alcohol), hydroxypropyl cellulose, zwitterionic polymers, ionic polymers, polyethylene glycol, polystyrene, polystyrene propylene, polymethyl acrylate, polyethyl acrylate, polypropyl acrylate, polyisopropyl acrylate, polybutyl acrylate, polyisobutyl acrylate, polytert-butyl acrylate, polyamyl acrylate, polyisoamyl acrylate, polymethyl methacrylate, polyethyl methacrylate, polypropyl methacrylate, polyisopropyl methacrylate, polybutyl methacrylate, polyisobutyl methacrylate, poly(tert-butyl methacrylate), polyamyl methacrylate, polyisoamyl methacrylate, polyhexyl methacrylate, polyethylene glycol, polyvinyl alcohol, polyurethane, polyethylene, poly Carbonate, polyamide, polytetrafluoroethylene, polyethylene terephthalate, polybutylene terephthalate, polyvinyl acetate, polysilicone, polyacrylonitrile, polychlorotrifluoroethylene, acrylonitrile, butadiene-styrene copolymer, polydimethylsilicate, polypyrrole, and/or any combination or copolymerization of polymers described herein.

In some examples, the electrolyte comprises KCl, tetraalkyl quaternary ammonium salts, ionic liquids, or other inorganic or organic salts, including inorganic or organic salts containing metal ions. In some examples, the concentration of the electrolyte in the electrochromic layer 110 is from 0.01 M (mol/L) to 10.0 M (mol/L), such as from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M.

In some examples, the host unit comprises a starch or a cyclic polyether. In some examples, the host unit comprises cyclodextrin, dextrin, a starch, amylose, a cellulose, amylopectin, chitosan, pillararene, cucurbituril, calixarene, or a crown ether. In some examples, the host unit is derived from a biological source. In other examples, the host unit is obtained through synthesis. In some examples, the host unit optionally does not comprise a metal. In other examples, the host unit optionally does not comprise a transition metal. In some examples, the concentration of the host unit in the electrochromic layer 110 is from 0.01 M to 10.0 M, such as from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M.

In some examples, the guest unit comprises an anion or an organic redox molecule. In some examples, the guest unit comprises I⁻, Br⁻, Cl⁻, SO₃²⁻, NO₃²⁻, ClO⁻, PO₄³⁻, a p-benzoquinone derivative, a urea derivative, a hydroquinone derivative, or an organic redox molecule containing a carbonyl, carboxyl, amino and/or sulfhydryl group. In some examples, the guest unit optionally does not comprise a metal or metal ion. In some examples, the concentration of the guest unit in the electrochromic layer 110 is from 0.01 M to 10.0 M, such as from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M.

In some examples, the host unit and guest unit interact to form the host-guest complex via dynamic hydrogen-bonding upon oxidation or reduction, such as upon oxidation or reduction of the host unit or the guest unit. In other examples, the host unit and guest unit interact to form the host-guest complex via Van der Waals interactions or other supramolecular interactions upon oxidation or reduction, such as upon oxidation or reduction of the host unit or the guest unit.

In some examples, the host unit and guest unit and the host-guest complex are configured to reversibly cycle between the host and guest unit and the host-guest complex at least 100 times or up to 1000000 times, such as from 100 times to 500 times, from 500 times to 1000 times, from 1000 times to 5000 times, from 5000 times to 10000 times, from 10000 times to 50000 times, from 50000 times to 100000 times, from 100000 times to 500000 times, or from 500000 times to 1000000 times.

In some examples, the ion conducting layer 115 comprises a solid and/or gel electrolyte. In some examples, the concentration of the solid/and or gel electrolyte in the ion conducting layer 115 is from 0.01 M to 10 M, such as from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M. In some examples, the ion conducting layer 115 is selected to prevent an intermixing of redox ions from the electrochromic layer and from the ion storage layer 120.

In some examples, the ion storage layer 120 comprises an electrolyte and a redox molecule, and/or redox polymer, and/or solvent. In some aspects, the redox molecule is an organic redox molecule. In some examples, the electrolyte comprises tetraalkyl quaternary ammonium salts, ionic liquids, or other inorganic or organic salts, including inorganic or organic salts containing metal ions. In some examples, the redox molecule comprises multivalence metal ions, metal salts or compounds, such as metal salts or compounds including Ti, V, Cr, Mn, Fe, Co, Ni, Cu, Zn, Y, Zr, Nb, Mo, Te, Ru, Rh, Pd, Ag, Sn, Sb, W, Os, Ir, Pt, Au, and/or Pb. In some examples, the redox molecule comprises redox anions including I⁻, Br⁻, Cl⁻, SO₃²⁻, NO₃²⁻, ClO⁻, PO₄³⁻. In some examples, the redox molecule comprises organic redox molecules including p-benzoquinone derivatives, urea derivatives, hydroquinone derivatives, viologen derivatives, aniline derivatives. In some examples, the redox polymer comprises one or more redox molecules as described herein doped or grafted in polymer carrier or polymers containing redox chemical groups, such as polyanilines, polythiophenes, polypyrroles. In some examples, the solvent includes water, C1-C18-containing alcohols, C3-C24-containing ethers containing at least one oxygen atom, C2-C18-containing sulfoxides, C2-C18-containing sulfones, C3-C24-containing ketones, C3-C24-containing sulfides containing at least one sulfur atom, C1-C18-containing acids, C2-C18-containing esters, C1-C18-containing sulfonic acids, C1-C18-containing amides, C1-C18-containing alkenes, C1-C18-containing alkanes, C1-C18-containing alkynes, C3-C18-containing heterocycles containing at least one heteroatom O, S, N, P, C1-C18-containing aromatic hydrocarbons, alkanes containing at least one halogen atom, any combination of aromatic hydrocarbons containing at least one halogen atom, toluene, tetrahydrofuran, ethylene oxide, dichlormethane, ethyl acetate, oxacyclopropane, and/or propylene carbonate. In some examples, the concentration of the electrolyte in the ion storage layer 120 is from 0.01 M to 10.0 M, such as from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M. In some examples, the concentration of the redox molecule and/or redox polymer in the ion storage layer 120 is from 0.001 M to 10.0 M, such as from 0.001 M to 0.005 M, from 0.005 M to 0.01 M, from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M.

In some examples, the first reduction or oxidation stimulation comprises a first voltage application between the first electrode 105 and the second electrode 125, and wherein the second reduction or oxidation stimulation comprises a second voltage application between the first electrode 105 and the second electrode 125. In some examples, the first voltage is from about −10 V to about 10 V, (e.g., −9.5 V to 9.5 V, −9.0 V to 9.0 V, −8.5 V to 8.5 V, −8.0 V to 8.0 V, −7.5 V to 7.5 V, −7.0 V to 7.0 V, −6.5 V to 6.5 V, −6.0 V to 6.0 V, −5.5 V to 5.5 V, −5.0 V to 5.0 V, −4.5 V to 4.5 V, −4.0 V to 4.0 V, −3.5 V to 3.5 V, −3.0 V to 3.0 V, −2.5 V to 2.5 V, −2.0 V to 2.0 V, or −1.5 V to 1.5 V). In some examples, the second voltage is from about −10 V to about 10 V, (e.g., −9.5 V to 9.5 V, −9.0 V to 9.0 V, −8.5 V to 8.5 V, −8.0 V to 8.0 V, −7.5 V to 7.5 V, −7.0 V to 7.0 V, −6.5 V to 6.5 V, −6.0 V to 6.0 V, −5.5 V to 5.5 V, −5.0 V to 5.0 V, −4.5 V to 4.5 V, −4.0 V to 4.0 V, −3.5 V to 3.5 V, −3.0 V to 3.0 V, −2.5 V to 2.5 V, −2.0 V to 2.0 V, or −1.5 V to 1.5 V). In some examples, the first voltage is about −10 V to about 10 V and the second voltage is −10 V to about 10 V. It will be appreciated that, in some examples, the first and second voltages are independent of one another and will have a different magnitude and optionally a different sign.

Without being limited by theory, the applied first voltage may affect the chemical equilibrium between the host unit (H), the guest unit (G), and the host-guest complex (HG) in the electrochromic layer 110, thereby affecting the concentration of each in electrochromic layer 110, as shown in the equation below. Similarly, without being limited by theory, the applied second voltage may also affect the chemical equilibrium between the host unit (H), the guest unit (G), and the host-guest complex (HG) in the electrochromic layer 110, thereby affecting the concentration of each in electrochromic layer 110, as shown in the equation below. In some examples, an increased concentration of the host-guest complex in the electrochromic layer 110 may correspond to an increased colored or opaque state exhibited by the EC device 100 (e.g., a decreased transmittance of visible, infrared, and/or ultraviolet electromagnetic radiation by the EC device 100). In other examples, the increased concentration of the host-guest complex in the electrochromic layer 110 may correspond to an increased colorless or transparent state (e.g., a transmittance of visible, infrared, and/or ultraviolet electromagnetic radiation by the EC device 100).

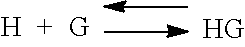

In some examples, the first voltage is greater than or about 0.1 V (e.g., greater than or about 0.2 V, 0.3 V, 0.4 V, 0.5 V, 0.6 V, 0.7 V, 0.8 V, 0.9 V, or 1.0 V). In some examples, the first voltage is less than or about 0.1 V (e.g., less than 0.05 V or 0.025 V). In some examples, the second voltage is greater than or about 0.1 V (e.g., greater than or about 0.2 V, 0.3 V, 0.4 V, 0.5 V, 0.6 V, 0.7 V, 0.8 V, 0.9 V, or 1.0 V). In some examples, the second voltage is less than or about 0.1 V (e.g., less than 0.05 V or 0.025 V). In some examples, the first voltage is greater than or about 0.1 V, and the second voltage is less than or about 0.1 V. In some examples, the first voltage is less than or about 0.1 V, and the second voltage is greater than or about 0.1 V.

In some examples, the first electrode 105, the electrochromic layer 110, the ion conducting layer 115, the ion storage layer 120, and the second electrode 125 exhibit a colorless state upon the second oxidation or reduction stimulation. In some aspects, the transparent or colorless state corresponds a magnitude of transmittance of visible, infrared, and/or, ultraviolet electromagnetic radiation through the first electrode 105, the electrochromic layer 110, the ion conducting layer 115, the ion storage layer 120, and the second electrode 125 that is at least 70% during the second oxidation or reduction stimulation (e.g., at least 75%, 80%, 85%, 90%, 95%, or 100%).

In some examples, the first electrode 105, the electrochromic layer 110, the ion conducting layer 115, the ion storage layer 120, and the second electrode 125 exhibit a colored state upon the first oxidation or reduction stimulation. In some examples, the colored state persists for approximately 2 hours, 1 hour to 1.5 hours, 1.5 to 2 hours, 2 to 2.5 hours, 2.5 to 3 hours, 3 to 5 hours, 5 to 10 hours, 10 to 24 hours, or more than 24 hours. In some aspects, the colored state comprises a magnitude of transmittance of visible, infrared, and/or, ultraviolet electromagnetic radiation through the first electrode 105, the electrochromic layer 110, the ion conducting layer 115, the ion storage layer 120, and the second electrode 125 is at most 70% during the first oxidation or reduction stimulation (e.g., at most 10%, 20%, 30%, 40%, 50%, or 60%).

In some examples, the magnitude of transmittance of visible, infrared, and/or, ultraviolet electromagnetic radiation through the first electrode 105, the electrochromic layer 110, the ion conducting layer 115, the ion storage layer 120, and the second electrode 125 varies upon application of different voltages between the first electrode 105 and the second electrode 125.

### 2. Methods of Making Electrochromic Devices

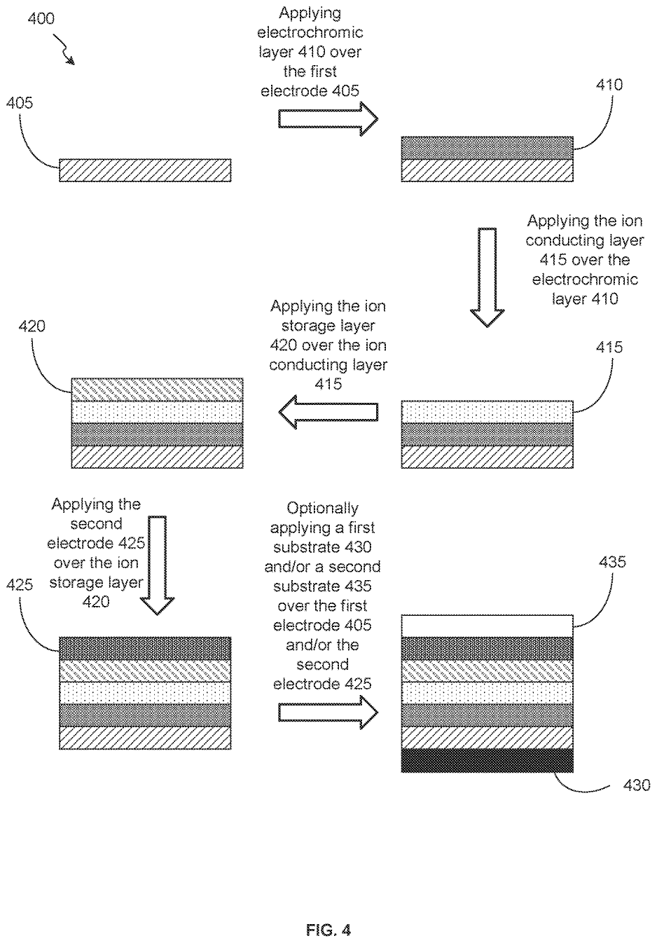

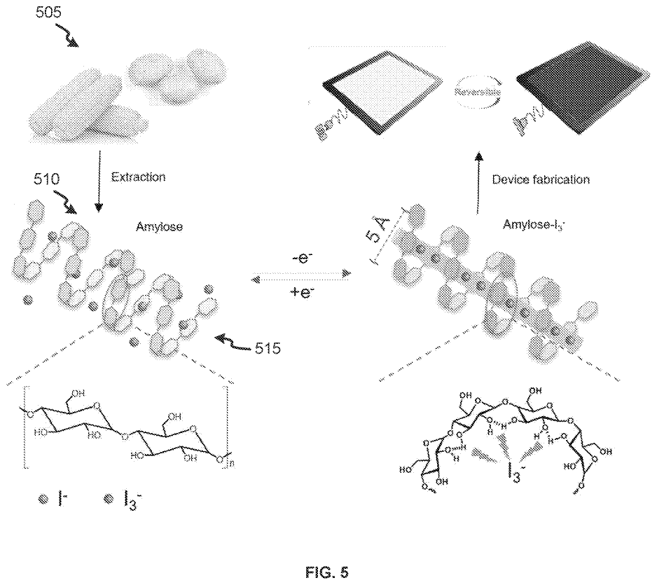

Provided herein are also methods of making EC devices as described herein. FIG. 4 provides a schematic illustration of an example of a method 400 of making an electrochromic device. In some examples, a method of making an EC device as described herein comprises positioning an electrochromic layer 410 over a first electrode 405, such as an electrochromic layer 410 that comprises an electrolyte, a host unit, and a guest unit; positioning an ion conducting layer 415 over the electrochromic layer 410; positioning an ion storage layer 420 over the ion conducting layer 415; and positioning a second electrode 425 over the ion storage layer 420. In some examples, the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex. Optionally, the method comprises positioning a first substrate 430 over the first electrode 405 and/or positioning a second substrate 435 over the second electrode 425. In some examples, the first electrode 405 may be positioned over the first substrate 430 prior to other steps shown in FIG. 4. In some examples, the second electrode 425 may be positioned over the second substrate 435 prior to other steps shown in FIG. 4 and optionally the second substrate 435 may be positioned over the ion storage layer 420 together with the second electrode 425.

In some examples, positioning the electrochromic layer 410 over the first electrode 405 comprises drop coating the electrochromic layer 410 onto the first electrode 405. In other examples, the positioning step may include spray-coating, spin-coating, slot-die coating, blade-coating, dip-coating, gravure-coating, Meyer bar-coating, natural fit, mechanically driven fit, and/or other techniques.

In some examples, positioning the ion conducting layer 415 over the electrochromic layer 410 comprises spray-coating, spin-coating, slot-die coating, blade-coating, dip-coating, gravure-coating, Meyer bar-coating, natural fit, mechanically driven fit, and/or other techniques.

In some examples, positioning the ion storage layer 420 over the ion conducting layer 415 comprises drop coating the ion storage layer 420 onto the ion conducting layer 415. In other examples, the positioning step may include spray-coating, spin-coating, slot-die coating, blade-coating, dip-coating, gravure-coating, Meyer bar-coating, natural fit, mechanically driven fit, and/or other techniques.

In some examples, positioning the second electrode 425 over the ion storage layer 420 comprises spray-coating, spin-coating, slot-die coating, blade-coating, dip-coating, gravure-coating, Meyer bar-coating, natural fit, mechanically driven fit, and/or other techniques.

In some examples, the electrochromic layer 410 may be or comprise an aqueous state, a gel state, or a solid film state. In some examples, the electrochromic layer 410 comprises or further comprises one or more solvents. In other examples, the electrochromic layer 410 comprises or further comprises one or more polymer carriers. In other examples, the electrochromic layer 410 comprises or further comprises one or more solvents and one or more polymer carriers. In some aspects, the solvent can include water, C1-C18-containing alcohols, C3-C24-containing ethers containing at least one oxygen atom, C2-C18-containing sulfoxides, C2-C18-containing sulfones, C3-C24-containing ketones, C3-C24-containing sulfides containing at least one sulfur atom, C1-C18-containing acids, C2-C18-containing esters, C1-C18-containing sulfonic acids, C1-C18-containing amides, C1-C18-containing alkenes, C1-C18-containing alkanes, C1-C18-containing alkynes, C3-C18-containing heterocycles containing at least one heteroatom O, S, N, P, C1-C18-containing aromatic hydrocarbons, alkanes containing at least one halogen atom, any combination of aromatic hydrocarbons containing at least one halogen atom, toluene, tetrahydrofuran, ethylene oxide, dichlormethane, ethyl acetate, oxacyclopropane, and/or propylene carbonate. In some aspects, the polymer carrier can include N,N,N-trimethyl-2-((2-methylbutanoyl)oxy)ethan-1-aminium, poly[2-(methacryloyloxy)ethyl]dimethyl-(3-sulfopropyl)ammonium hydroxide, polyvinylidene difluoride, poly(vinyl alcohol), conjugated polymer, poly(vinyl alcohol), hydroxypropyl cellulose, zwitterionic polymers, ionic polymers, polyethylene glycol, polystyrene, polystyrene propylene, polymethyl acrylate, polyethyl acrylate, polypropyl acrylate, polyisopropyl acrylate, polybutyl acrylate, polyisobutyl acrylate, polytert-butyl acrylate, polyamyl acrylate, polyisoamyl acrylate, polymethyl methacrylate, polyethyl methacrylate, polypropyl methacrylate, polyisopropyl methacrylate, polybutyl methacrylate, polyisobutyl methacrylate, poly(tert-butyl methacrylate), polyamyl methacrylate, polyisoamyl methacrylate, polyhexyl methacrylate, polyethylene glycol, polyvinyl alcohol, polyurethane, polyethylene, poly Carbonate, polyamide, polytetrafluoroethylene, polyethylene terephthalate, polybutylene terephthalate, polyvinyl acetate, polysilicone, polyacrylonitrile, polychlorotrifluoroethylene, acrylonitrile, butadiene-styrene copolymer, polydimethylsilicate, polypyrrole, or any combination or copolymerization of the polymers described herein.

In some examples, the electrolyte of the electrochromic layer 410 comprises KCl, tetraalkyl quaternary ammonium salts, ionic liquids, or other inorganic or organic salts, including inorganic or organic salts containing metal ions. In some examples, the concentration of the electrolyte in the electrochromic layer 410 is from 0.01 M to 10.0 M, such as from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M.

In some examples, the host unit is derived from a biological source. In some examples, the host unit is extracted from a biological source into water. In some examples, the biological source is corn, potato, and/or mung bean starch. In some examples, the host unit comprises a starch or a cyclic polyether. In some examples, the host unit comprises cyclodextrin, dextrin, a starch, amylose, a cellulose, amylopectin, chitosan, pillararene, cucurbituril, calixarene, or a crown ether. In some examples, the host unit optionally does not comprise a metal. In some examples, the concentration of the host unit in the electrochromic layer 410 is from 0.01 M to 10.0 M, such as from 0.01 M to 0.05 M, from 0.05 M to 0.1 M, from 0.1 M to 0.5 M, from 0.5 M to 1.0 M, from 1.0 M to 5.0 M, or from 5.0 M to 10.0 M.

In some examples, the guest unit comprises an anion or an organic redox molecule. In some examples, the guest unit comprises I⁻, Br⁻, Cl⁻, SO₃²⁻, NO₃²⁻, ClO⁻, PO₄³⁻, a p-benzoquinone derivative, a urea derivative, a hydroquinone derivative, or an organic redox molecule containing a carbonyl, carboxyl, amino and/or sulfhydryl group. In some examples, the guest unit optionally does not comprise a metal. In some examples, the concentration of the guest unit in the electrochromic layer 410 is from 0.01 M to 10.0 M.

In some examples, the optional first substrate 430 comprises glass, polymer, plastic, metal, a semi-rigid (semi-pliant) material, rigid (non-pliant) material, a pliant/flexible material, and/or combinations thereof. In some examples, the optional second substrate 435 comprises glass, polymer, plastic, metal, a semi-rigid (semi-pliant) material, rigid (non-pliant) material, a pliant/flexible material, and/or combinations thereof.

In some examples, any suitable or desired thickness for each layer of the EC device prepared using the method 400 can be used. In some examples, the thickness of the electrochromic layer 410 can be from 15 nm to 2.0 cm, such as from 15 nm to 50 nm, from 50 nm to 100 nm, from 100 nm to 500 nm, from 500 nm to 1 μm, from 1 μm to 5 μm, from 5 μm to 10 μm, from 10 μm to 50 μm, from 50 μm to 100 μm, from 100 μm to 500 μm, from 500 μm to 1 mm, from 1 mm to 5 mm, from 5 mm to 1 cm, or from 1 cm to 2 cm. In some examples, the thickness of the ion conducting layer 415 can be from 15 nm to 2.0 cm, such as from 15 nm to 50 nm, from 50 nm to 100 nm, from 100 nm to 500 nm, from 500 nm to 1 μm, from 1 μm to 5 μm, from 5 μm to 10 μm, from 10 μm to 50 μm, from 50 μm to 100 μm, from 100 μm to 500 μm, from 500 μm to 1 mm, from 1 mm to 5 mm, from 5 mm to 1 cm, or from 1 cm to 2 cm. In some examples, the thickness of the ion storage layer 420 can be from 15 nm to 2.0 cm, such as from 15 nm to 50 nm, from 50 nm to 100 nm, from 100 nm to 500 nm, from 500 nm to 1 μm, from 1 μm to 5 μm, from 5 μm to 10 μm, from 10 μm to 50 μm, from 50 μm to 100 μm, from 100 μm to 500 μm, from 500 μm to 1 mm, from 1 mm to 5 mm, from 5 mm to 1 cm, or from 1 cm to 2 cm. In some examples, the thickness of the optional first substrate 430 and/or the optional second substrate 435 is from 15 nm to 2.0 cm, such as from 15 nm to 50 nm, from 50 nm to 100 nm, from 100 nm to 500 nm, from 500 nm to 1 μm, from 1 μm to 5 μm, from 5 μm to 10 μm, from 10 μm to 50 μm, from 50 μm to 100 m, from 100 μm to 500 μm, from 500 μm to 1 mm, from 1 mm to 5 mm, from 5 mm to 1 cm, or from 1 cm to 2 cm. In some examples, the thickness of the EC device prepared using the method 400 can be adjusted by positioning frames (e.g., frames comprising PDMS) of varying thicknesses on the first electrode 405 and second electrode 425 prior to assembling the EC device prepared using the method 400.

Additional features of an electrochromic system are shown in FIG. 5. For example, FIG. 5 provides a scheme for converting corn/potato starch to an EC system as described herein. Image 505 shows a digital photograph of corn/potato, which was used to extract amylose by a simple repeated dissolution-centrifugation process. Image 510 shows a schematic illustration of related EC mechanism and display based on dynamic host-guest interaction. The amylose chain 515 features a helix structure, offering nanochannels for ion transportation.

### 3. Methods of Using Electrochromic Devices

FIG. 2 provides an overview of operation of an example electrochromic device, wherein the electrochromic device is switched between a colorless state and a colored state based on voltage stimulations. In some examples, the electrochromic device is transparent or colorless prior to a first voltage stimulation. Upon the first voltage stimulation step comprising applying an oxidizing or reducing voltage, the electrochromic device switches to a colored state (e.g., “ON(+)” in either the top graph 205 or the bottom graph 210). Upon a second voltage stimulation comprising applying a reducing or oxidizing voltage (e.g., “ON(−)” in the top graph 205), the electrochromic device returns to the transparent or colorless state. In some embodiments, stopping the application of the first voltage (e.g., “Power off” in the bottom graph 210) returns the electrochromic device to a colorless state.

Also provided herein are methods of using EC devices as described herein. In some examples, the method of using the EC device described herein comprises applying a first voltage between the first electrode and the second electrode corresponding to a first reduction or oxidation stimulation, and applying a second voltage between the first electrode and the second electrode corresponding to a second reduction or oxidation stimulation. In some examples, the EC device exhibits a decay ratio of from 10% to 20% with respect to transmittance between applying the first voltage and applying the second voltage. For example, the electrochromic device can exhibit a decay ratio of 10%, 11%, 12%, 13%, 14%, 15%, 16%, 17%, 18%, 19%, 20%, or anywhere in between.

In some examples, the first voltage corresponds to a reduction stimulation and the second voltage corresponds to an oxidation stimulation. In other examples, the first voltage corresponds to an oxidation stimulation and the second voltage corresponds to a reduction stimulation. For example, the first voltage stimulation may oxidize one or more components (e.g., a guest unit or a host unit) and induce host-guest complexation and the second voltage stimulation may include host-guest decomplexation and reduce one or more components (e.g., a guest unit or a host unit). In another example, the first voltage stimulation may reduce one or more components (e.g., a guest unit or a host unit) and induce host-guest complexation and the second voltage stimulation may include host-guest decomplexation and oxidize one or more components (e.g., a guest unit or a host unit). In some examples, the first voltage is greater than or about 0.1 V (e.g., greater than or about 0.2 V, 0.3 V, 0.4 V, 0.5 V, 0.6 V, 0.7 V, 0.8 V, 0.9 V, or 1.0 V), and the second voltage is less than or about 0.1 V (e.g., less than 0.05 V or 0.025 V). In other examples, the first voltage is less than or about 0.1 V (e.g., less than 0.05 V or 0.025 V), and the second voltage is greater than or about 0.1 V (e.g., greater than or about 0.2 V, 0.3 V, 0.4 V, 0.5 V, 0.6 V, 0.7 V, 0.8 V, 0.9 V, or 1.0 V). In some examples, the first voltage is from about −5 V to about 5 V and wherein the second voltage is from about −10 V to about 10 V (e.g., −9.5 V to 9.5 V, −9.0 V to 9.0 V, −8.5 V to 8.5 V, −8.0 V to 8.0 V, −7.5 V to 7.5 V, −7.0 V to 7.0 V, −6.5 V to 6.5 V, −6.0 V to 6.0 V, −5.5 V to 5.5 V, −5.0 V to 5.0 V, −4.5 V to 4.5 V, −4.0 V to 4.0 V, −3.5 V to 3.5 V, −3.0 V to 3.0 V, −2.5 V to 2.5 V, −2.0 V to 2.0 V, or −1.5 V to 1.5 V). It will be appreciated that, in some examples, the first and second voltages are independent of one another and will have a different magnitude and optionally a different sign.

Embodiments of the present invention may be further understood by the following non-limiting examples.

### Example 1

Smart windows, which may contribute energy saving in buildings via reducing lighting, cooling and heating loads, may be useful for decarbonization. Electrochromic (EC) displays, the transmittance of which can be reversibly switched under voltage stimulation, can be applied in the smart window and related infotainment content display due to their active control mode, reversibility, and optical properties. Various EC materials, including inorganic EC materials, organic EC materials, and metal-organic EC complexes may be included smart windows. Some examples include WO₃-based solid or liquid EC devices, as well as other EC windows that are based on reversible electrodeposition of metal ions, such as Bi³⁺ and Cu²⁺.

Previous EC systems including complicated materials synthesis and device fabrication processes, high cost as well as unsatisfied durability, have hindered market penetration. Due to the deposition of insoluble products and metal atoms caused by the previous preparation methods, it is generally difficult to reuse the ITO electrode of discarded devices without the use of harsh solvents.

Hence, avoiding complicated chemical synthesis and fabrication processes, as well as improving EC performances with environmentally and economically friendly reusable transparent electrodes, are considered useful features to develop in EC devices and thus to accelerate greater availability of EC devices.

Described herein is a new EC mechanism and system based on dynamic host-guest interactions that can be useful for smart windows and non-emissive transparent displays. The electrochromic system may contain host units, guest units, electrolytes, redox molecules, electrodes, one or more solvents, and/or one or more polymer carriers. Without being limited by theory, under voltage stimulation, the color of the system described herein can be switched reversibly because of the reversible change of the inclusion complexes formed by the dynamic interaction between host and guest units. The color and structure of the system described herein can be maintained without electricity. The EC materials described herein may be extracted from biomass or obtained through synthesis. The electrode described herein may be a transparent electrode, wherein the transparent electrode may be reused repeatedly. The EC materials described herein may be dissolved in water, optionally with no insoluble intermediate products generated during the device preparation process and related EC reaction. In one embodiment, the EC device as described herein exhibits high transmittance change (>85%), low open voltage (0.9 V), broad grayscale display, pleasant multicolor, excellent durability (e.g., no chemical degradation and performance degradation were observed after 1.5 months of continuous UV irradiation) and reusability (>6500 cycles), and sustainability.

### Results and Experiments

### 1. Electrochromic Materials and Mechanism

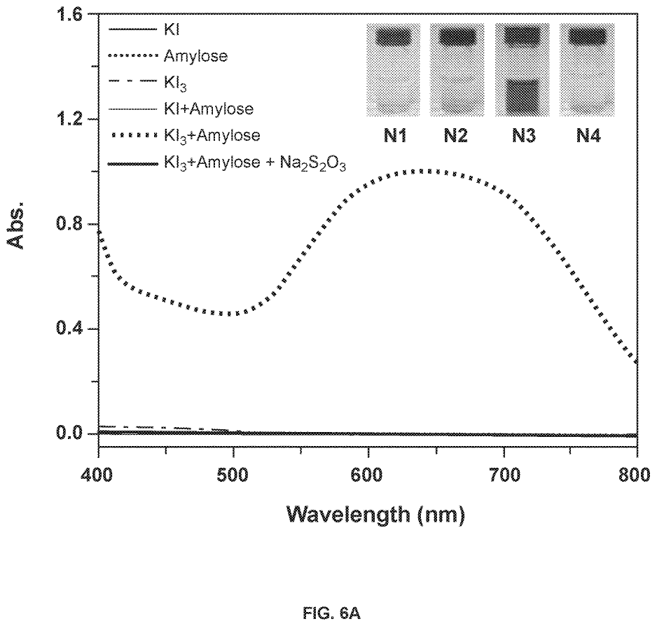

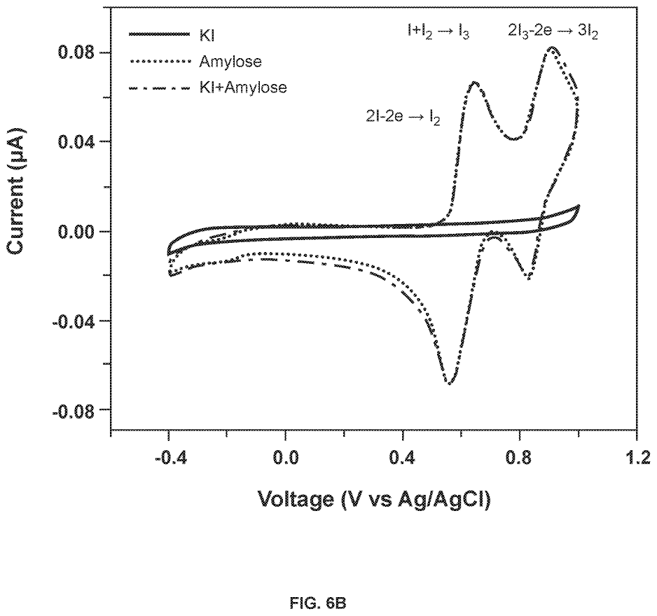

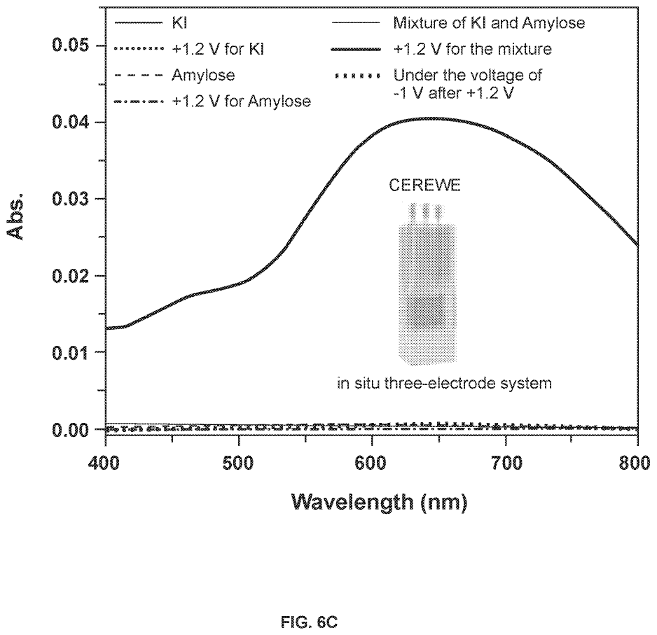

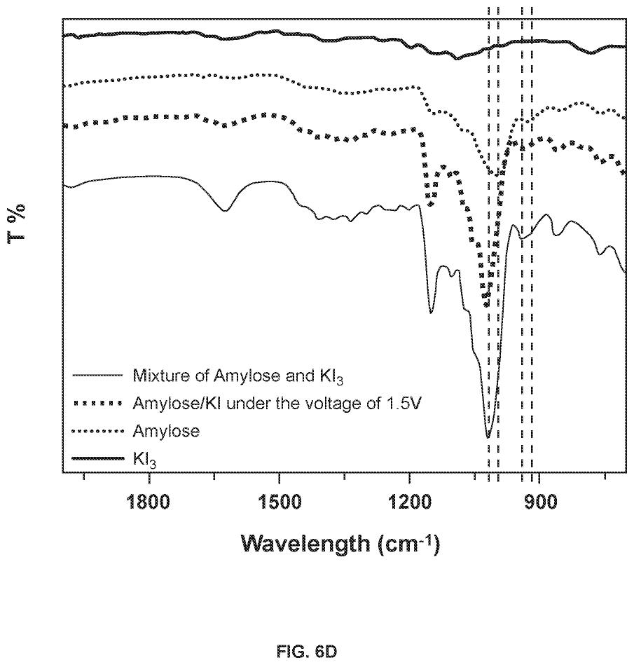

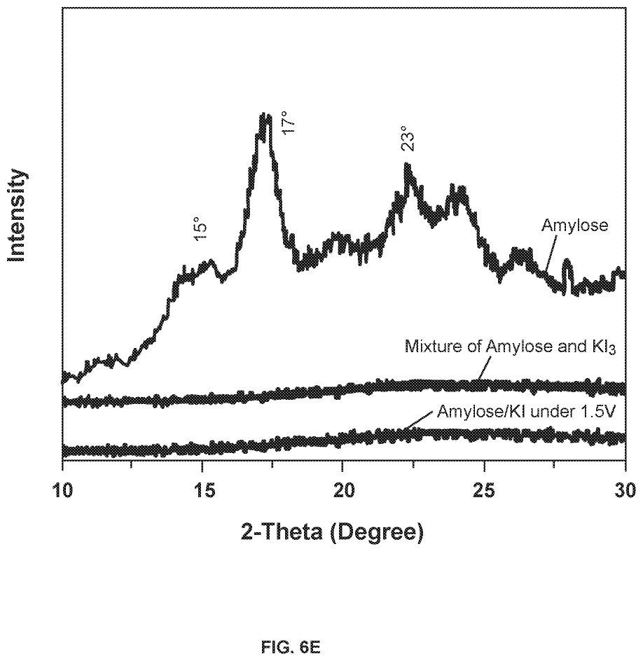

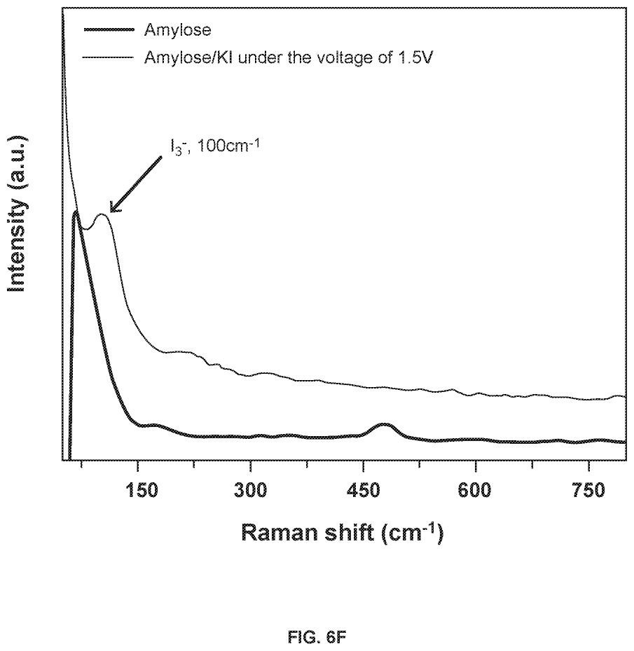

The color of the system containing the host and guest units described herein can be reversibly switched under reversible voltage stimulation. This mechanism can be referred to as bistable electrochromism. Initially, the system is colorless due to no interaction between the host molecule and guest molecule. When the host molecule is oxidized and the host-guest clathrate forms between these two units, the color of the clathrate becomes visibly apparent. Meanwhile, the clathrate can be dissociated to the original state upon opposite voltage stimulation, which may correspond to the color fading away. The host unit described herein may include biomass materials such as cyclodextrins, cucurbituril, and amylose. Amylose is used herein as non-limiting example can be extracted from biomass including potato, corn, and mung beans. A guest unit possessing electrochemical activity, which can interact with the host unit reversibly, accompanied by the color change, was selected. As a non-limiting example of a guest unit, iodide was selected. Blue color generates when iodine molecules are added to the amylose solution to form the clathrate based on the host-guest interaction. In comparison, no interaction exists when iodide ions mix with amylose, as shown in FIG. 6A. FIG. 6A provides absorption spectra of KI (1.0×10⁻⁴ mol/L), amylose (1.0×10−4 mol/L), KI₃ (1.0×10−4 mol/L), amylose/KI (1.0×10⁻³ mol/L/1.0×10⁻⁴ mol/L), amylose/KI₃ (1.0×10⁻³ mol/L/1.0×10⁻⁴ mol/L), and amylose/KI₃/Na₂S₂O₃ (1.0×10⁻³ mol/L/1.0×10⁻⁴ mol/L/1.0×10⁻⁴ mol/L) in water. This iodide ion with electrochemical activity was selected as a suitable potential host molecule. The inset of FIG. 6A shows a digital photograph of aqueous solutions containing amylose (1.0×10⁻³ mol/L) for N1, amylose/KI (1.0×10⁻³ mol/L/1.0×10⁻⁴ mol/L) for N2, amylose/KI₃ (1.0×10⁻³ mol/L/1.0×10⁻⁴ mol/L) for N3 and amylose/KI₃/Na₂S₂O₃ (1.0×10⁻³ mol/L/1.0×10⁻⁴ mol/L/1.0×10⁻⁴ mol/L) for N4.

The host-guest interaction system containing amylose as the host unit and iodide ion as the guest unit is described in this Example in further detail. Firstly, the color change was tested. As shown in FIG. 6A, not only were amylose solution and KI solution colorless when they were separate, but also there were no relevant color and spectral absorption when they were mixed, indicating that no interaction existed between KI and amylose. The blue color and corresponding absorption peak could be observed when KI₃ mixed with amylose, which illustrated the clathrate formed between KI₃ and amylose. Interestingly, when the reducing agent Na₂S₂O₃ was added to the mixture, the color and absorption of the mixture disappeared. Without being limited by theory, this observation demonstrates that the interaction between KI₃ and amylose could change when I₃⁻ was reduced to I⁻. In some examples, to meet suitable electrochemical feasibility, the redox potential of the guest unit may be below the oxidative potential of the host unit, due to the guest unit offering the redox center rather than host unit in the system. As shown in cyclic voltammograms of KI (1.0×10⁻³ mol/L), amylose (1.0×10⁻³ mol/L) and amylose/KI (1.0×10⁻³ mol/L/1.0×10⁻³ mol/L) provided in FIG. 6B, the oxidative potentials of I⁻ were 0.64 V and 0.90 V, which are lower than the oxidation potential of amylose (greater than 1.0 V). The dynamic host-guest interaction between amylose with KI switched by reversible electric field was then investigated in the following experiments. FIG. 6C shows absorption spectra of KI (1.0×10⁻⁴ mol/L), amylose (2.0×10⁻⁴ mol/L) and KI/amylose (1.0×10⁻⁴ mol/L/2.0×10⁻⁴ mol/L) before and after voltage stimulation. No absorption peak of mixed KI and amylose aqueous solution was observed in the visible region of the absorption spectrum from 400 to 800 nm initially. A blue color with the absorption peak at 630 nm was observed right after being stimulated with the positive voltage. In contrast, under the stimulation of voltage, the unmixed solution of KI and amylose did not induce corresponding absorption peaks, indicating that the color was generated by the oxidation of the “amylose and I⁻” inclusion compound/ionic complex, rather than the oxidation of the pure I⁻.

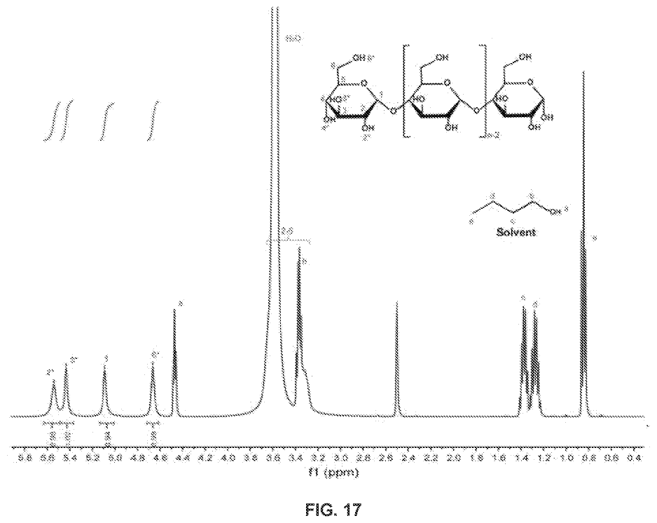

To investigate the underlying electrochromic mechanism, relevant experiments and spectral analyses were carried out, including Fourier Transform Infrared Spectroscopy (FT-IR), Raman spectra, X-ray powder diffraction (XRD). To characterize the host-guest interaction in the clathrate of amylose and oxidized KI and the reaction site in amylose, FTIR spectra of the clathrate were obtained (FIG. 6D and FIG. 17). FIG. 6D shows infrared (IR) spectra of the mixture of amylose and KI₃, the mixture of KI and amylose under the voltage of 1.5 V, amylose, KI₃. It was observed that the C—O stretch vibration of the glucose part at 995.26 cm⁻¹ and C—O—C stretching vibration at 850 cm⁻¹ in the mixture of KI and amylose had undergone a large shift to 1021.14 cm-1 and 861 cm⁻¹ under the voltage stimulation, which is consistent with the amylose stimulated by KI₃. Without being limited by theory, this observation indicates that the oxidized I⁻ interacted with the hydroxyl group in amylose. X-ray crystallography (“XRD”) of the clathrate of amylose and oxidized KI was conducted to investigate the bonding relationship of the amylose and oxidized I⁻. The reflections at approximately 15°, 17° and 23° indicate the typical A-type amylose structure, in which helix is packed in monoclinic unit cells. FIG. 6E shows X-ray diffraction (XRD) of amylose, amylose and KI₃, the mixture of KI and amylose under the voltage of 1.5 V, amylose, KI₃. The diffraction peaks are significantly suppressed after polyiodide interacted with amylose, which suggests that polyiodide ions are trapped inside the helix structure of amylose. To further investigate the as-acquired amylose/polyiodide clathrate and oxidized form of I⁻, the Raman spectra were obtained as shown in FIG. 6F. FIG. 6F shows Raman spectra of amylose, the mixture of KI and amylose under the voltage of 1.5 V. A Raman peak at 478 cm⁻¹ corresponds to the skeletal vibrations of the pyranose structure in the α-D-glucose units of amylose. The vibration of the pyranose structure is suppressed after the polyiodide capture, indicating the significant interaction between amylose structure and polyiodide. The new Raman peak located at 110 cm⁻¹ corresponds to the triiodide ion (I₃⁻). Without being limited by theory, these observations suggest that I⁻ was oxidized into I₃⁻ to form the colored clathrate with amylose.

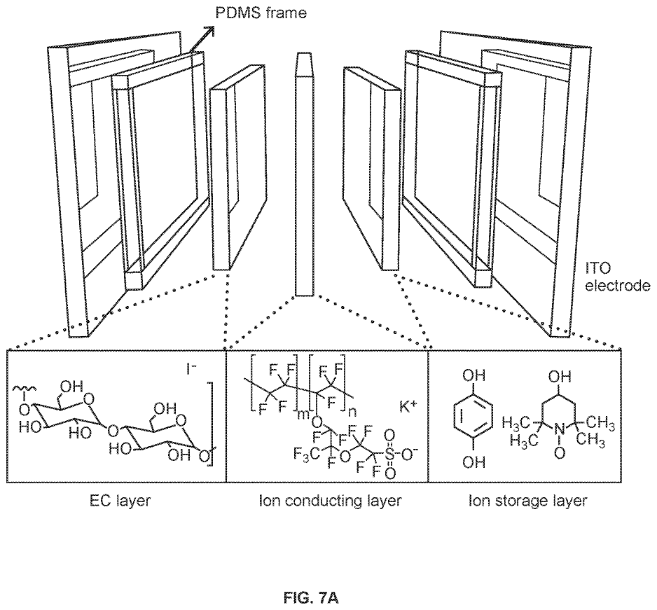

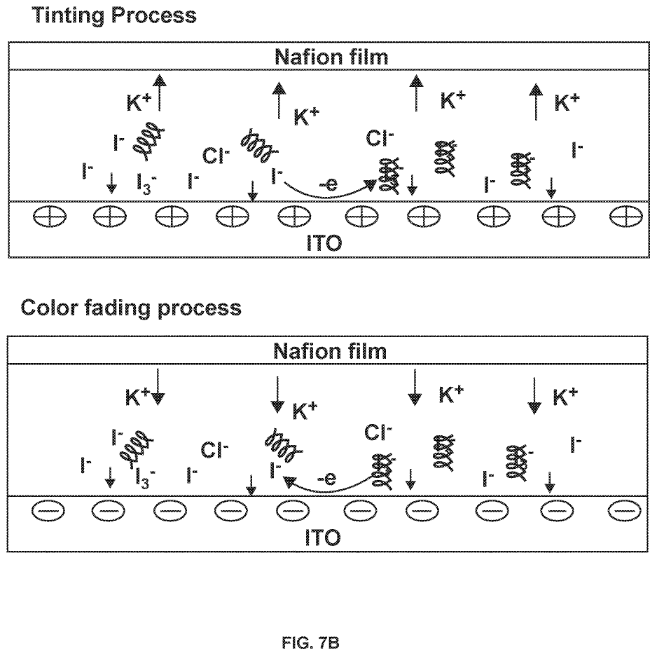

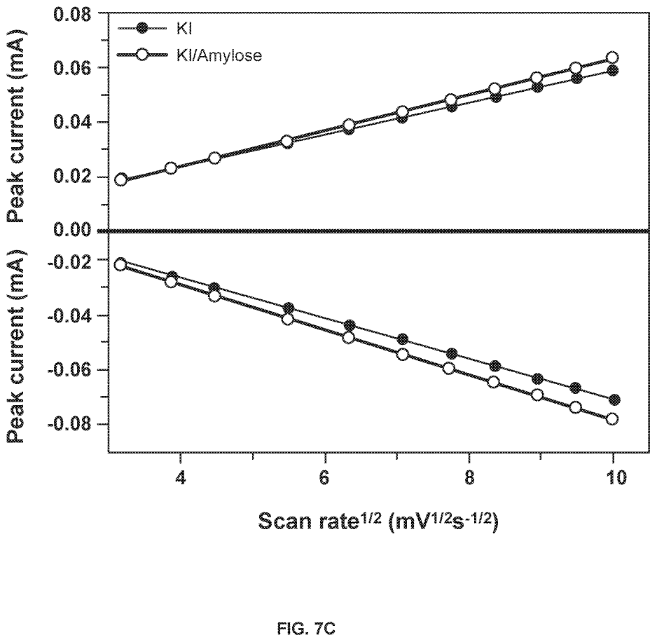

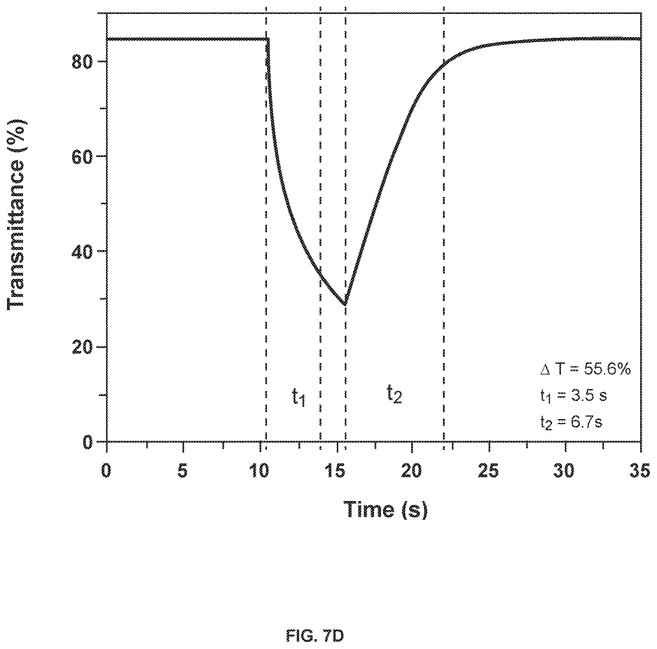

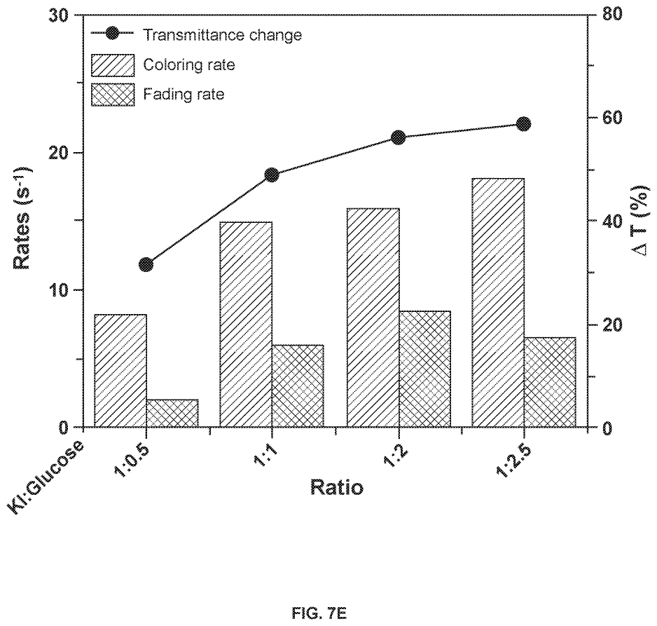

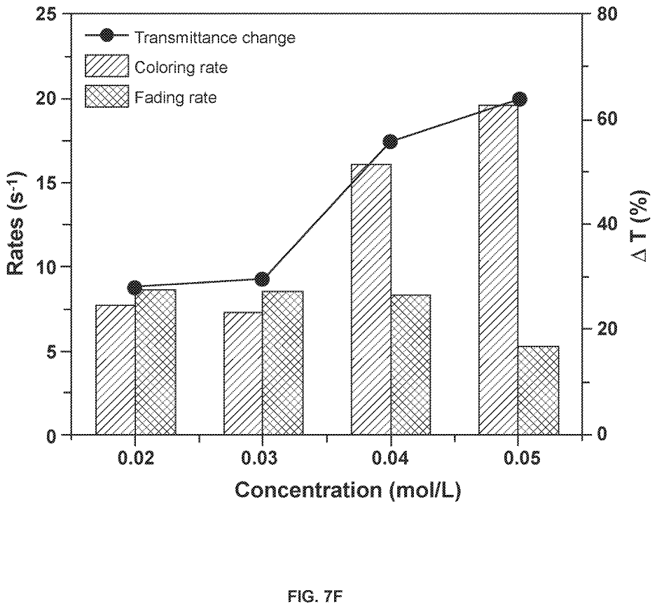

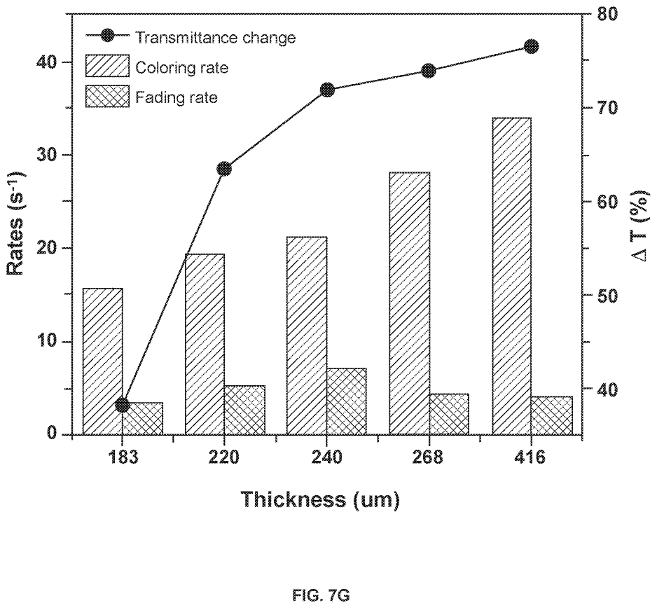

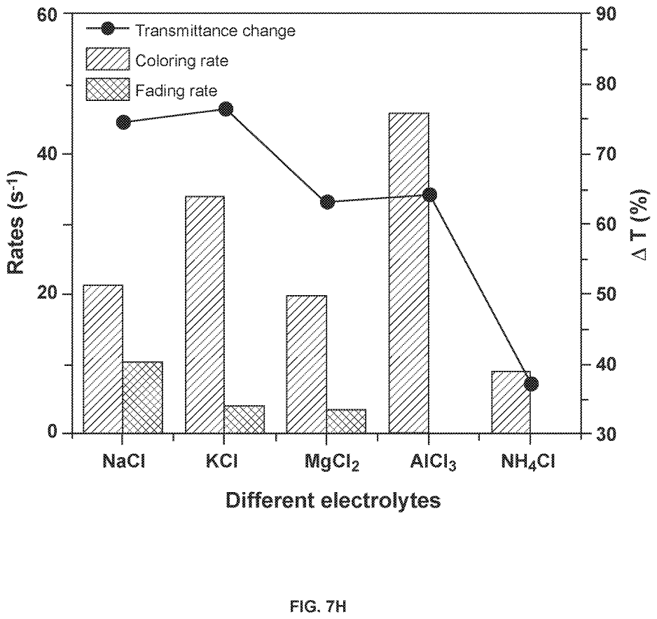

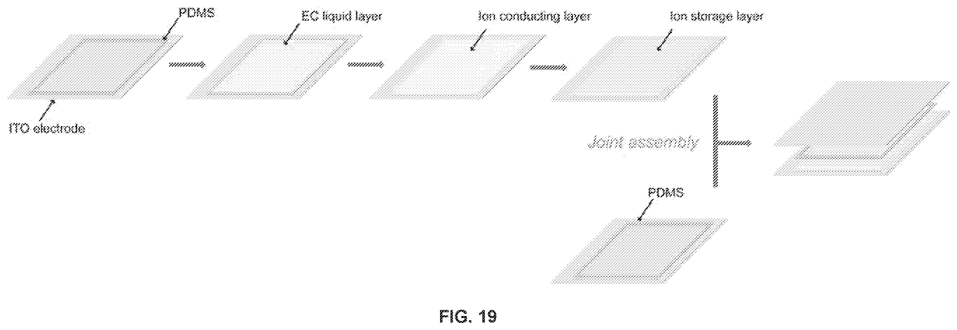

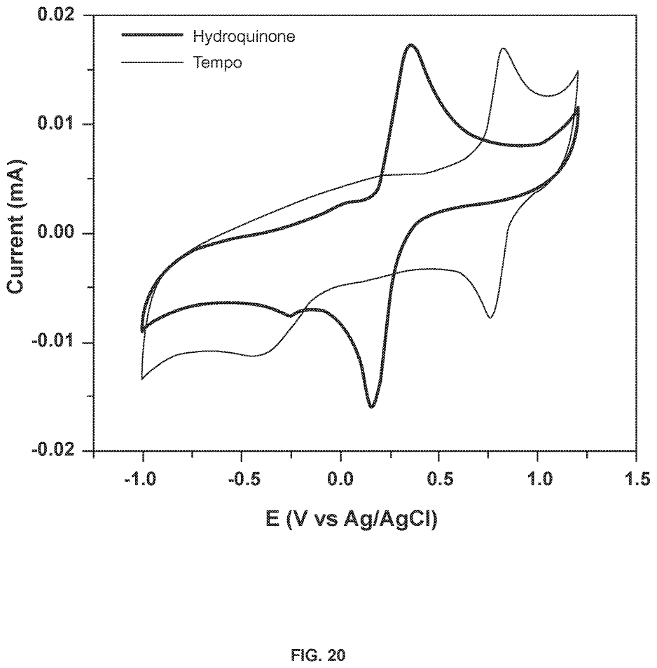

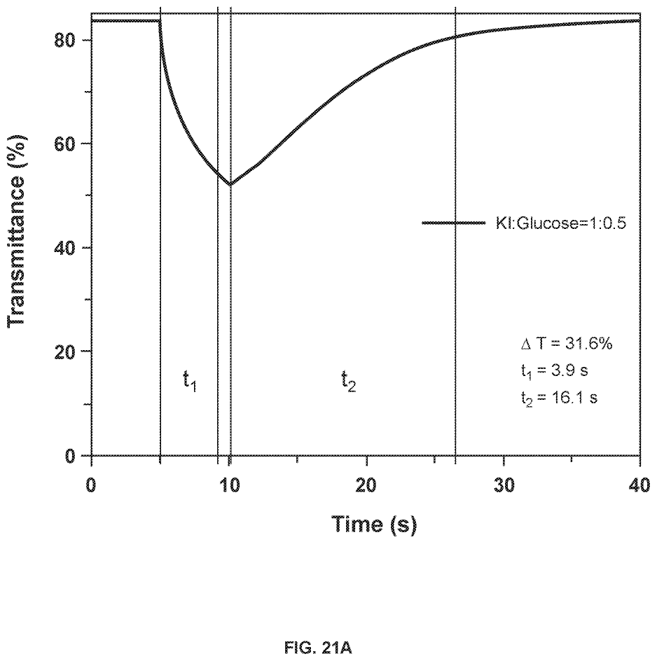

The EC properties of the above-described I⁻/amylose system were then studied systematically. Electrochromic devices containing five layers, an electrochromic layer, an ion conducting layer, an ion storage layer, and two ITO glasses, were fabricated (FIG. 7A and FIG. 19). As an example, FIG. 7A shows a schematic of an electrochromic device. Each layer may contain various components to affect the electron transfer and ion transfer process as well as the amount of the reaction involved in the system, to provide for useful EC performance of the device. FIG. 7B shows a schematic illustration of the ion and electron transfer involved in the tinting and color fading process. Without being limited by theory, as shown in FIG. 7B, when the I⁻ around the electrode was oxidized and rapidly transformed into I₃⁻, the excess counterions of K⁺ and other cations from the electrolyte migrate to the cathode electrode; meanwhile, the electroactive substances in the ion storage layer near the cathode electrode undergo opposite electrochemical reactions to maintain the charge balance of the system (FIG. 20). According to the Randles-Sevcik equation, the redox ion diffusion coefficient (I⁻/I₃⁻) and K⁺ of the inclusion compound formed with amylose for the related redox ions seems to be slightly larger than that of the pure (I⁻/I⁻) and K₊ without amylose, although such changes are not significant, determined from the data in FIG. 7C. FIG. 7C shows plots of the peak current densities of KI and amylose/KI versus the square root of the scan rates. Without being limited by theory, this phenomenon suggests that the interaction between amylose and the anions and cations of KI/KI₃ promotes the transfer of ions in the relevant electrochemical reactions. It is likely that the aggregation/“inclusion complex” assisted “ion/electron-jumping-transfer” formed by anions and cations of KI and amylose led to the above results of the increase of the detected ion diffusion coefficient. Herein, in order to improve the components and facilitate the selection, the coloring and fading response rates of the system was assessed by introducing the response rate, depicted as α=ΔT/Δt, which can estimate transmittance change and response time simultaneously (FIG. 7D). For example, FIG. 7D shows transmittance (at 630 nm) of the KI/amylose (0.04 mol/L/0.08 mol/L) in the EC device under the voltage of 1.9 V/−0.9 V.

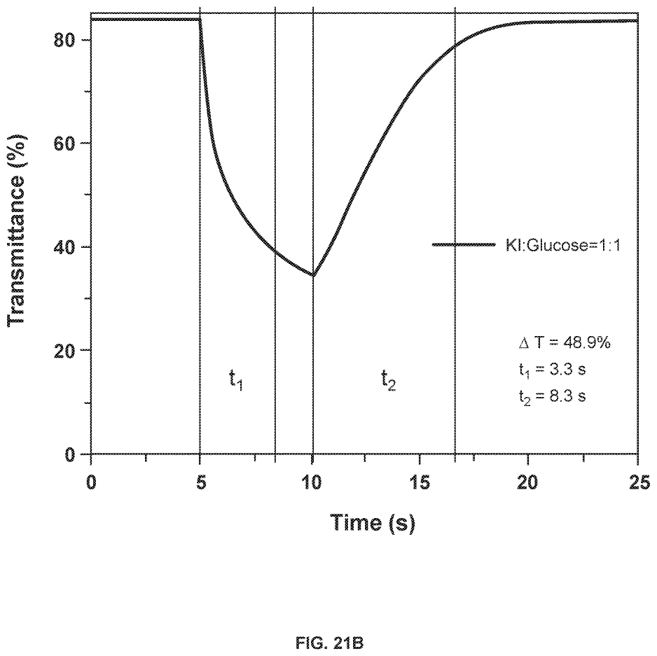

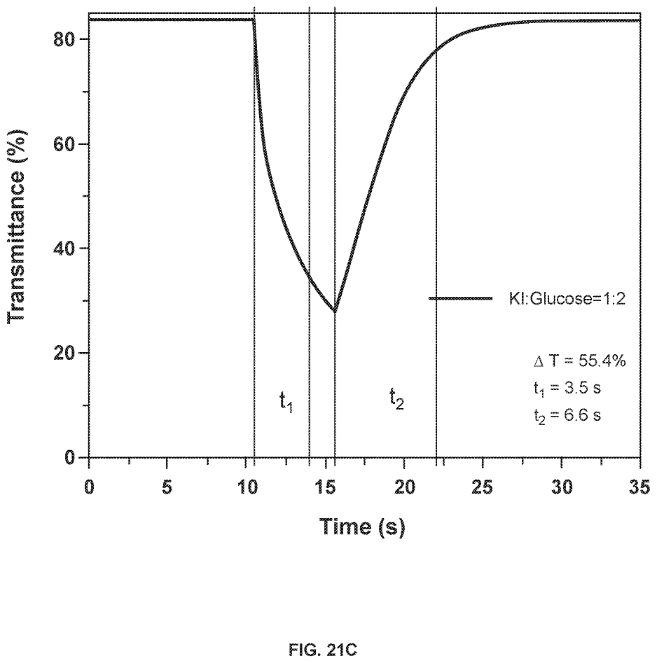

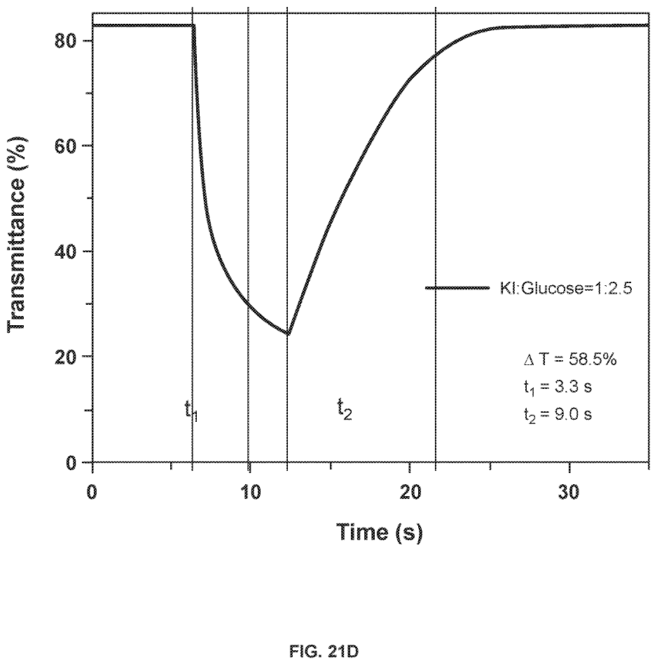

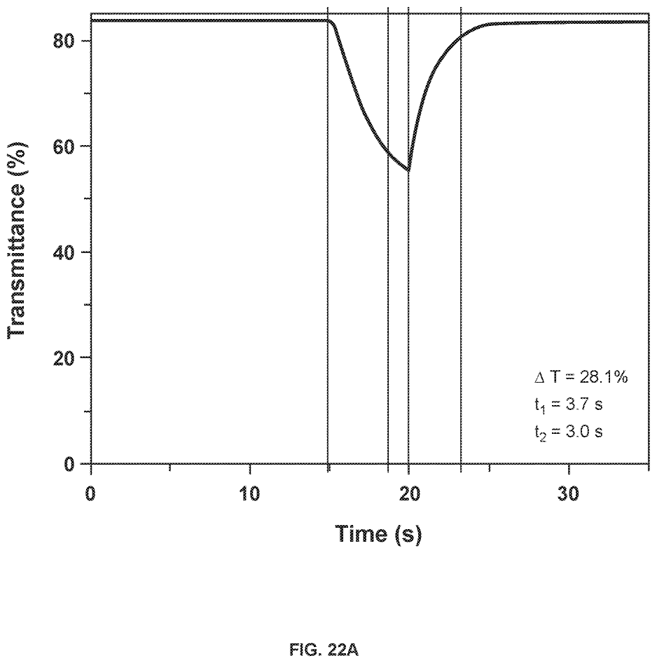

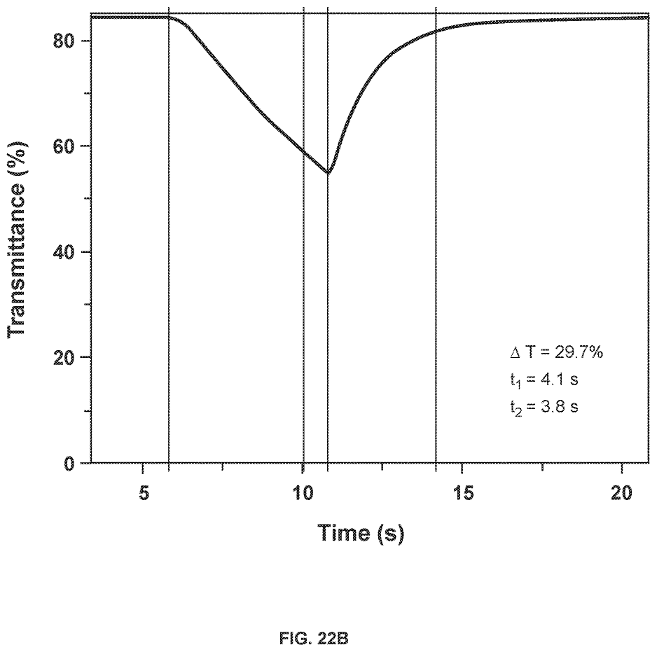

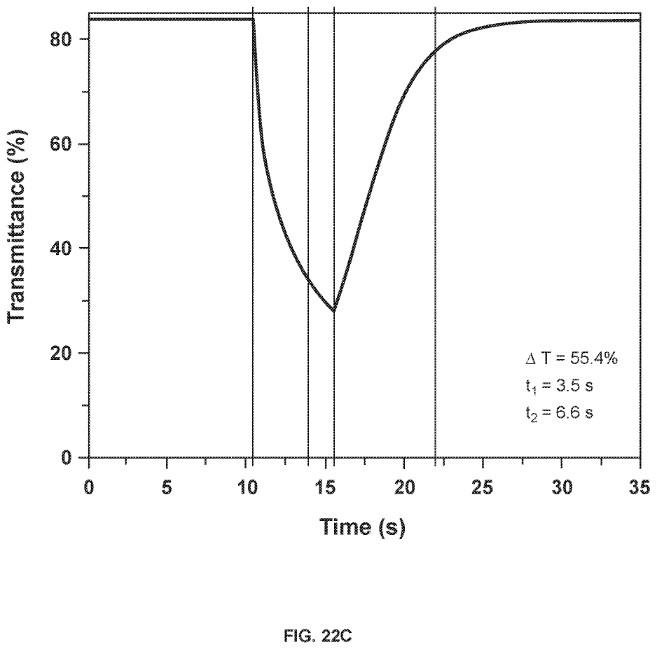

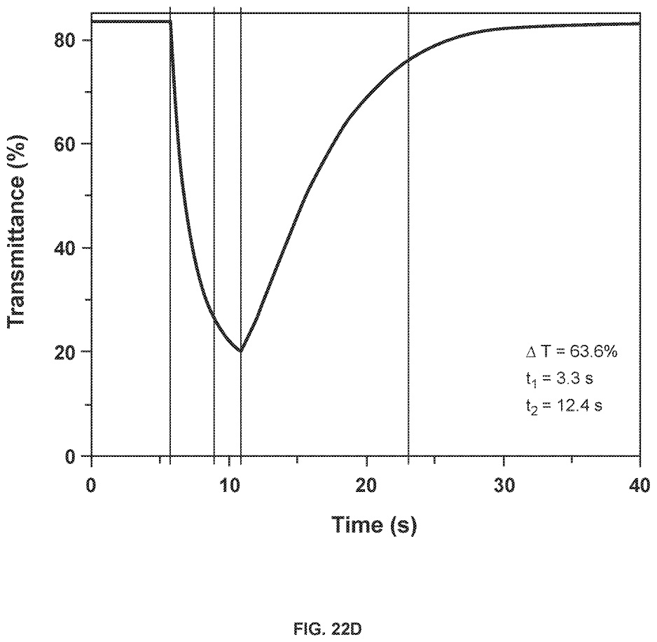

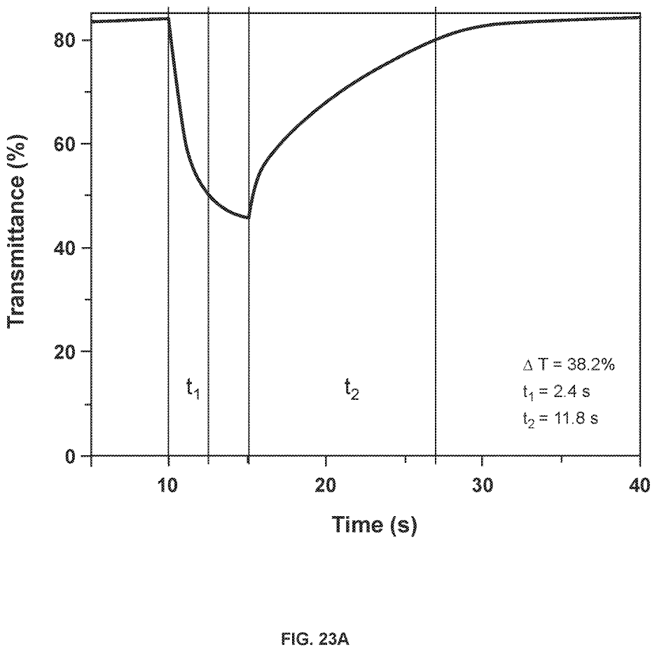

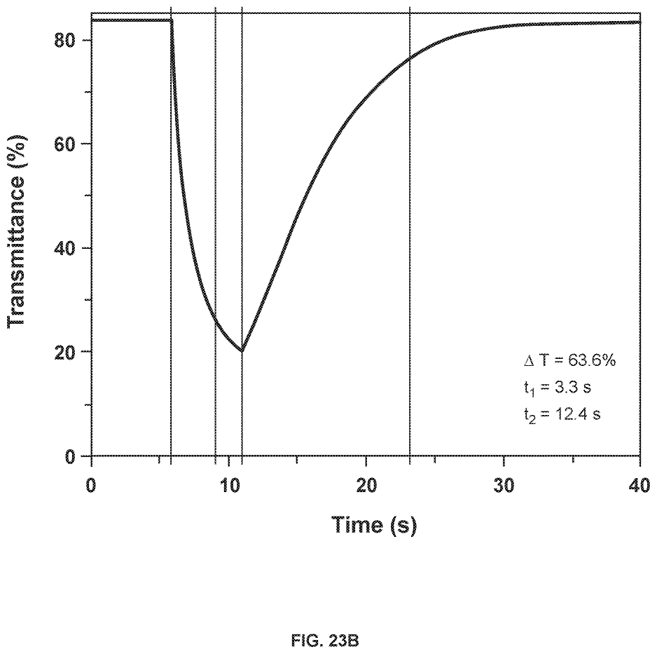

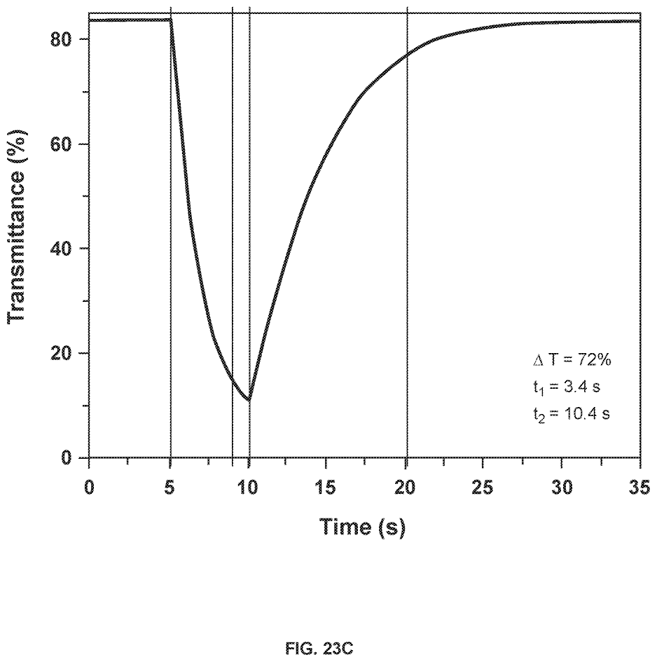

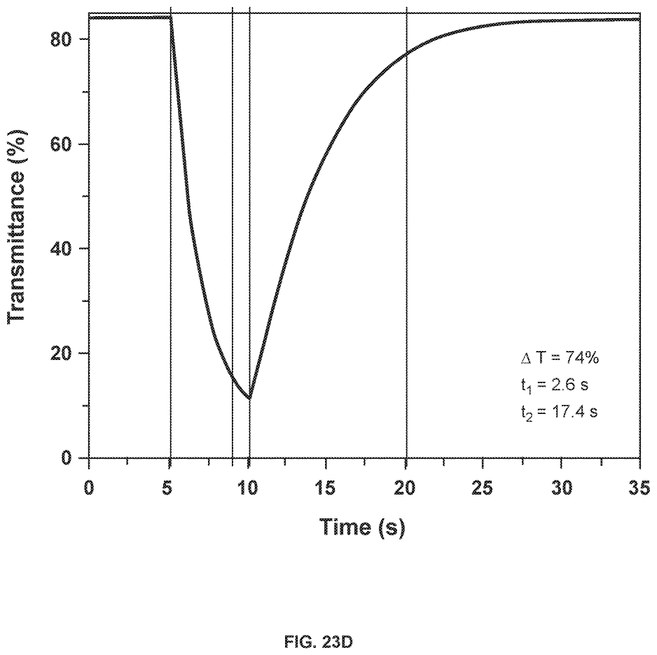

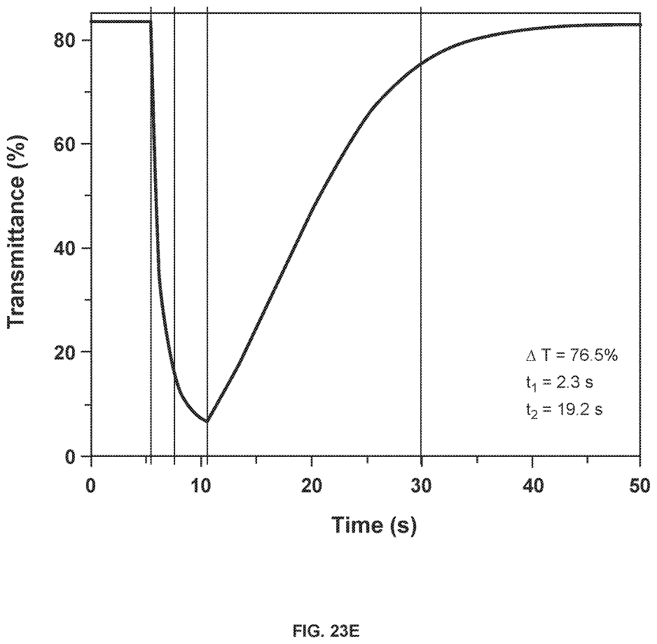

The influence of the ratio of amylose and KI for the response rate and transmittance change of the device was explored. Herein, the amylose was quantified by glucose, a subgroup that interacts with KI₃ in amylose. FIG. 7E shows transmittance of the EC device containing different ratios of KI/glucose (subunit in amylose) under the voltage of 1.9 V/−0.9 V. The response rate and transmittance change increased constantly along with increasing the ratio of KI and glucose, which indicates that each pair of I⁻/I₃⁻ could interact with multiple glucose units (FIG. 7E and FIG. 21). Although the coloring rate of EC system constituted by KI/Glucose (in amylose) with the ratio of 1:2 is slightly smaller than that of 1:2.5, the EC system with the ratio of 1:2 is more beneficial for further adjusting the overall concentration of KI and amylose. And with increasing the concentrations of KI and amylose, the transmittance change and the response rate increase are shown in FIG. 7F and FIG. 22. In particular, FIG. 7F shows transmittance of the EC device containing different concentrations of KI with the ratio of 1:2 for KI/glucose (subunit in amylose) under the voltage of 1.9 V/−0.9 V. The EC system constituted by KI/Glucose (in amylose) with the concentration of 0.05 mol/L/0.1 mol/L showed performance with transmittance change of 63.6%, coloration rate of 19.2 s⁻¹ and the fading rate of 5.1 s⁻¹. The impact of EC layer thickness was also investigated. Increased thickness of the electrochromic layer correlated with an increasing number of functional molecules including iodide ions, redox ions, amylose, and electrolytes diffusing to the electrode surface to participate in the reaction, producing a significant increase of the transmittance change and response rate (FIG. 7G and FIG. 23). For example, FIG. 7G shows transmittance of the EC device containing different thicknesses of the EC layers under the voltage of 1.9 V/−0.9 V. Conductibility of the device was observed to affect the EC performance, which is dependent on the concentration, the type, the size of electrolyte used.

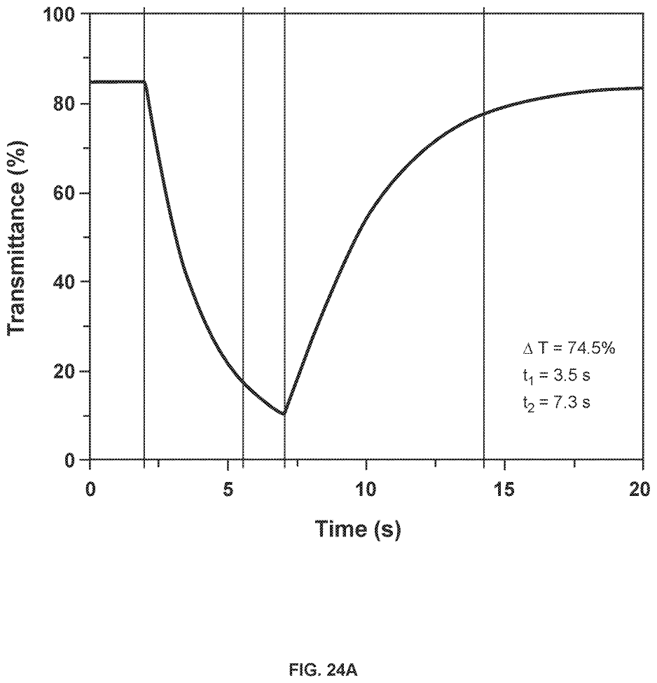

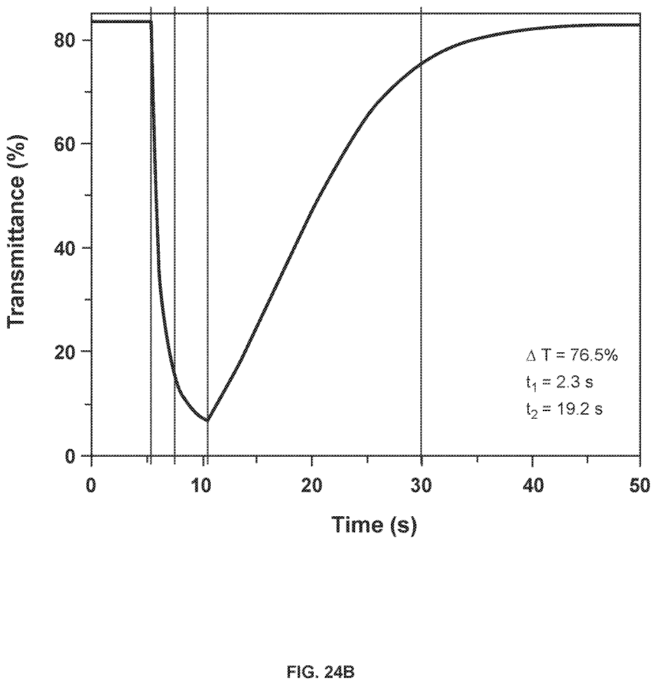

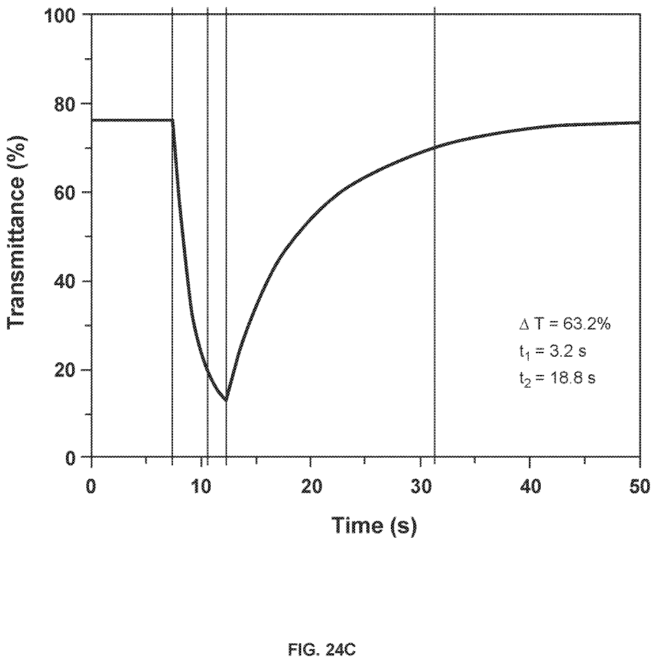

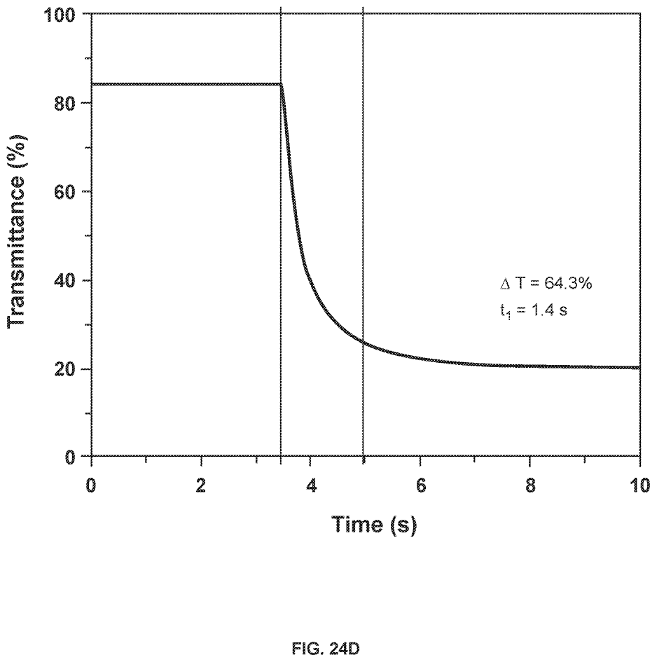

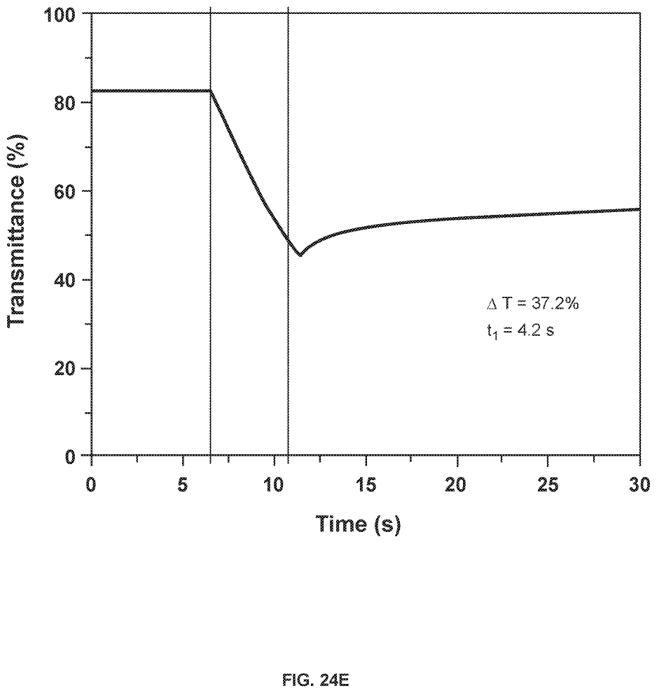

Since the cation exchange membrane was used as the ion conducting layer, the influence of the electrolytes with different cations on the EC performance was explored (FIG. 7H and FIG. 24). FIG. 7H shows transmittance of the EC device containing different electrolytes under the voltage of 1.9 V/−0.9 V. NH₄⁺ and Al⁺ electrolytes were not further considered in this Example due to their irreversible color change behavior, which may be due to the inconvenient diffusion in Nafion film caused by their polyhydrogen bond or polyvalent cations participating in ionic and hydrogen bond interactions in Nafion membrane at the same time. FIG. 7I shows radius and diffusion coefficient for different hydrated cations in aqueous solution. Compared with other cations, the transmittance change and coloration rate of the EC system containing K⁺ are slightly faster benefiting from its diffusion coefficient, although its cationic size is not the smallest. The transmittance change and response rate of the EC system containing Mg²⁺ was observed to be smaller than that of K⁺ and Na⁺, which is closely with its lower diffusion coefficient in solvent and inconvenient diffusion in Nafion film. Without being limited by theory, these results suggest that thermodynamic diffusion rate, valence charge, and sizes of the ions affect the coloration and conductivity of the devices described herein.

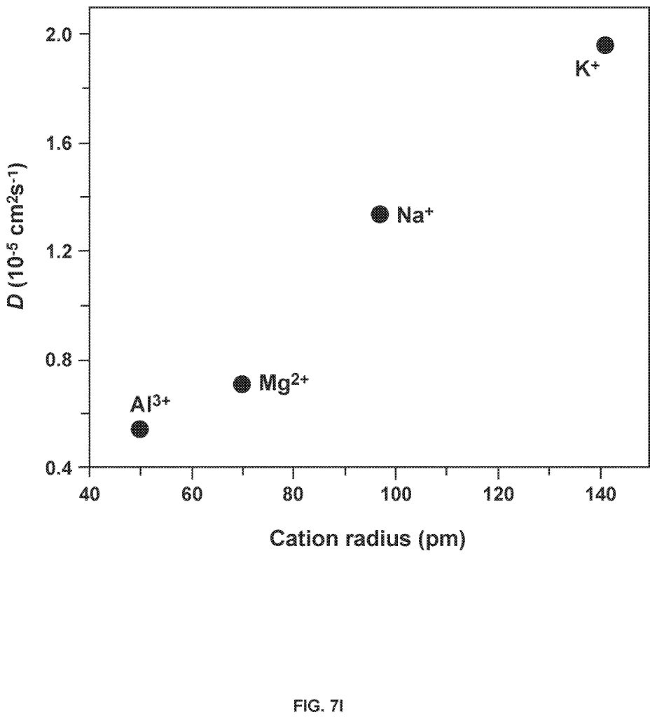

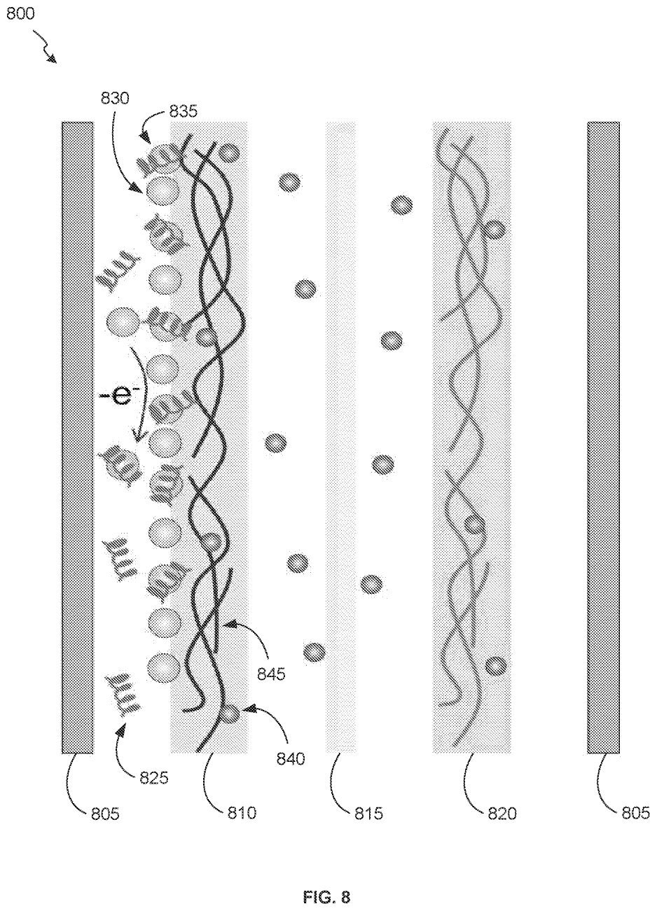

FIG. 8 provides an example schematic of an example electrochromic device 800 containing two electrode layers 805, an electrochromic layer 810, a cation conducting membrane 815, and an ion storage layer 820. The EC properties of the electrochromic devices described herein can depend on the host-guest interactions described herein. For example, a stability of the colorless state of the electrochromic devices can correspond to the stability of a respective structure of host units 825 and guest units 830 in the electrochromic layer 810. Host-guest interactions, such as non-covalent bonds, can stabilize the structure of host-guest complexes 835, resulting in suitable stability of the colored state of the electrochromic devices.

Additionally, the EC properties of the electrochromic devices can be based on thermal diffusion of electrochromic molecules in the electrochromic layer, a self-erasing effect resulting from a reaction between redox ions in the electrochromic layer and the ion storage layer, or a combination thereof. In some examples, the self-erasing effect can correspond to a spontaneous electron transfer between electrochromic materials of the electrochromic layer and redox ions of the ion storage layer. As shown in FIG. 8, the cation conducting membrane 815 can transfer electrolytes 840 rather than redox ions, such as the guest units 830. This selective diffusion through the cation conducting membrane 815 or other suitable ion conducting layers can allow the redox ions in the electrochromic layer 810 and the ion storage layer 820 to remain separated. Accordingly, the cation conducting membrane 815 or other suitable ion conducting layers can prevent a self-erasing reaction that can occur between the redox ions of the electrochromic layer 810 and of the ion storage layer 820.

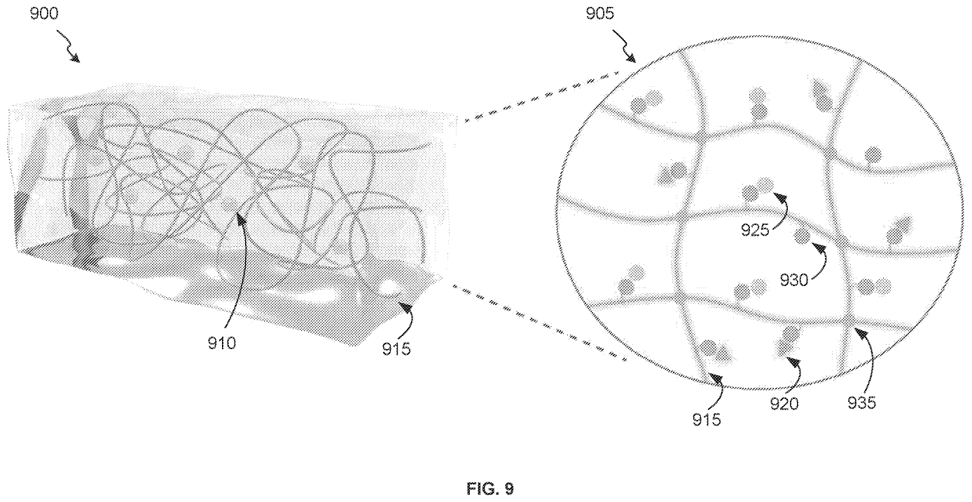

In some examples, as shown in FIG. 8, the electrochromic layer 810 includes an ionic gel 845 that inhibits a diffusion of the host units 825, the guest units 830, and the host-guest complexes 835 through the electrochromic layer 810. The ionic gel 845 can be selected as a matrix of the electrochromic layer 810 to provide electrostatic interactions with electrochromic materials in the electrochromic layer 810. In some examples, the electrostatic interactions can hinder a thermal diffusion of the host units 825, guest units 830, and redox ions. FIG. 9 depicts a sectional view 900 of an example electrochromic layer, such as the electrochromic layer 810 of FIG. 8, and includes a callout image 905 showing a detailed view of components in the electrochromic layer. In the sectional view 900, the electrochromic layer includes one or more initiators 910, such as lithium phenyl-2,4,6-trimethylbenzoylphosphinate (LAP), dispersed in a ionic gel matrix 915 of the electrochromic layer. As shown in the callout image 905 of FIG. 9, the electrochromic materials can include amylose 920 and iodide ions 925 dispersed in an ionic gel matrix 915 of poly(N,N-dimethylaminoethyl methacrylate) (PDMAEA). The ionic gel matrix 915 can comprise monomers 930 of dimethylaminoethyl methacrylate (DMAEA) that have undergone crosslinking using a crosslinker 935, such as bisacrylamide, to form the ionic gel matrix 915. In some examples, the amylose 920 and iodide ions 925 can be coupled to the monomers 930 of the PDMAEA of the ionic gel matrix 915, such as via electrostatic interactions. Accordingly, the ionic gel matrix 915 can interact with the components of the electrochromic layer to inhibit thermal diffusion of the components.

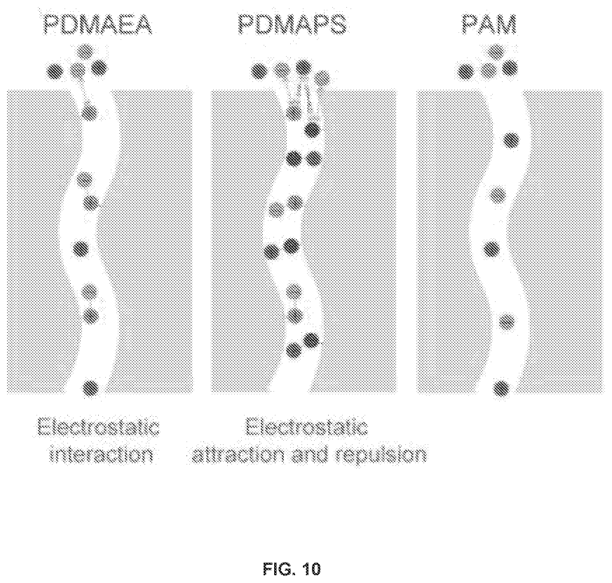

Different ionic gel matrices can adjust the diffusion of the electrochromic materials in the electrochromic layer, resulting in varied electrochromic properties. As shown in FIG. 10, different ionic gels used as the ionic gel matrix can exhibit different electrostatic interactions when interacting with the guest unit (e.g., iodide ions). For example, PDMAEA can selectively interact with the electrochromic materials to prevent the electrochromic materials from thermally diffusing through the electrochromic layer while allowing other ions or materials to pass. In some embodiments, certain cations may pair with anions in the ionic gel matrix comprising PDMAEA to form ion pairs that remain in the ionic gel matrix. Other cations that remain uncoupled can pass through the ionic gel matrix. On the other hand, another ionic gel, such as poly(2-(N-3-Sulfopropyl-N,N-dimethyl ammonium)ethyl methacrylate) (PDMAPS), may exhibit electrostatic attraction and repulsion causing each cation and anion to form ion pairs that remain in the ionic gel of PDMAPS. As another example shown in FIG. 10, polyacrylamide (PAM) lacks electrostatic interaction with the ions of the electrochromic layer such that the ions remain uncoupled and can diffuse through the ionic gel matrix of PAM unhindered.

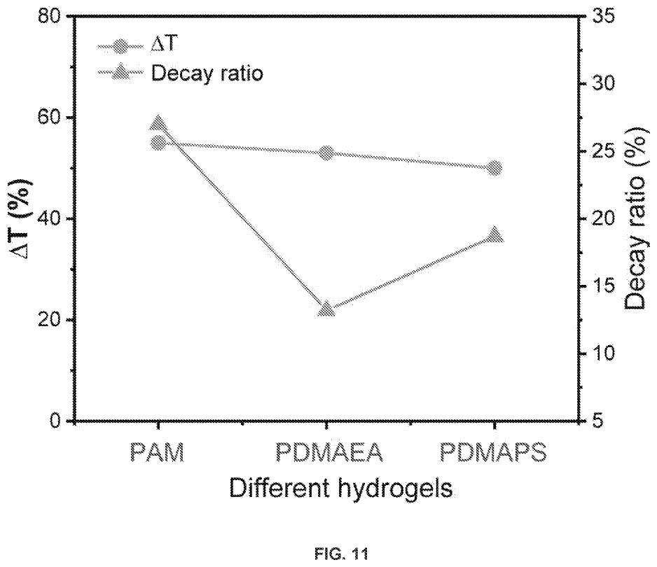

FIG. 11 provides a plot comparing a respective change in transmittance and a respective decay ratio of example electrochromic devices including ionic gels of PAM, PDMAEA, and PDMAPS. As shown in FIG. 11, the respective changes in transmittance corresponding to the ionic gels including PAM, PDMAEA, and PDMAPS were generally between 50% and about 55%. The PAM ionic gel had the highest change in transmittance, while the PDMAPS ionic gel has the lowest change in transmittance. With respect to the decay ratio, the PAM ionic gel had the highest decay ratio of about 27%. The PDMAPS ionic gel had the next highest decay ratio of about 18%, while the PDMAEA ionic gel had the lowest decay ratio of about 13%, indicating that the PDAMEA ionic gel had the highest bistability of the three ionic gels. Accordingly, the PDMAEA ionic gel can provide the highest image retention time when the electrochromic device is used as a display.

### 2. Electrochromic Device Characteristics

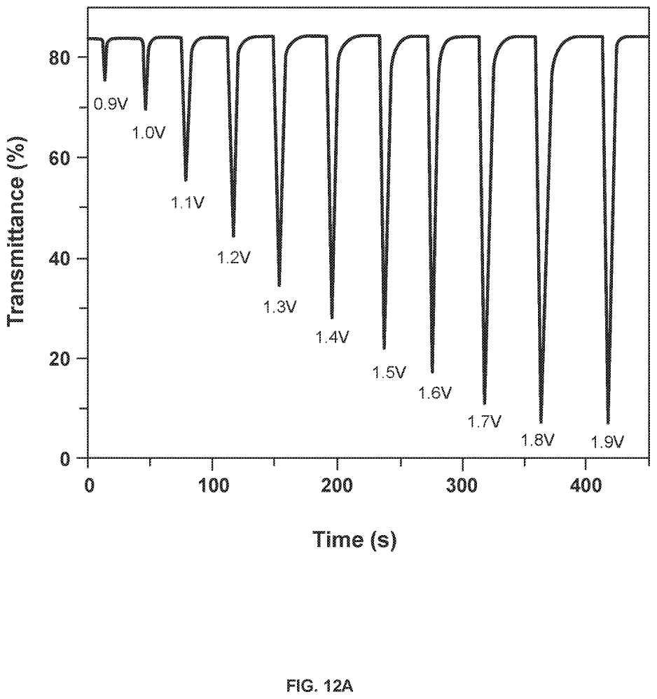

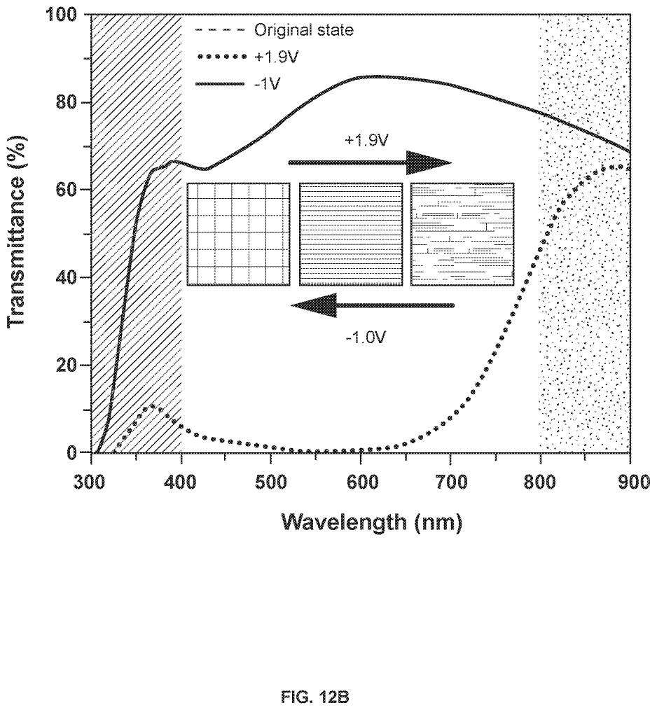

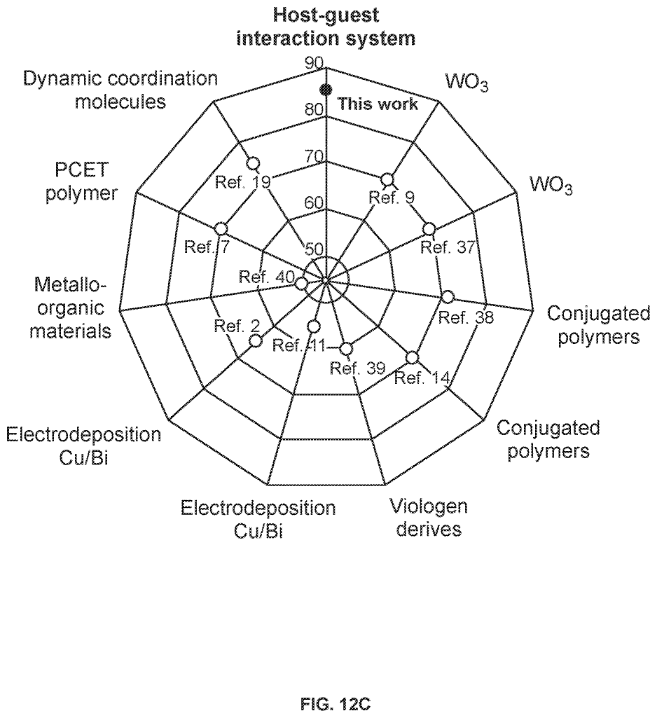

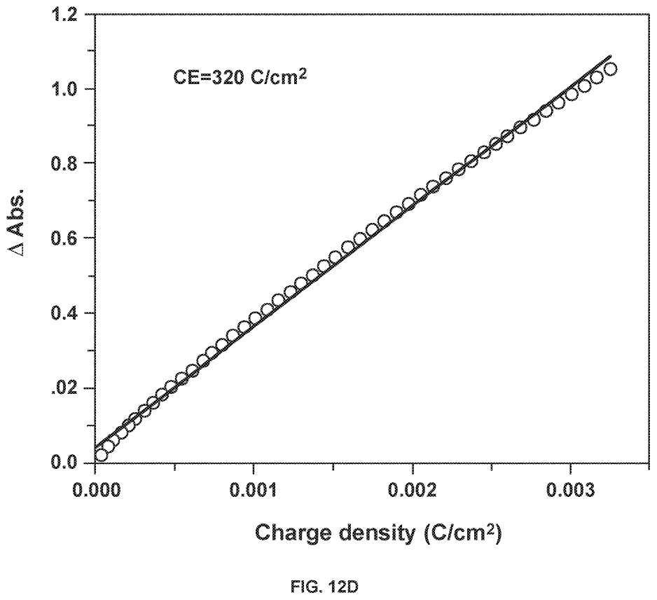

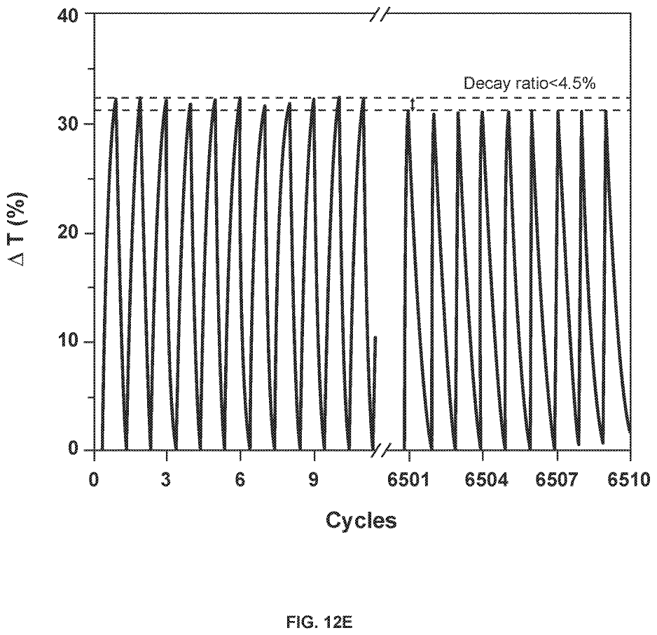

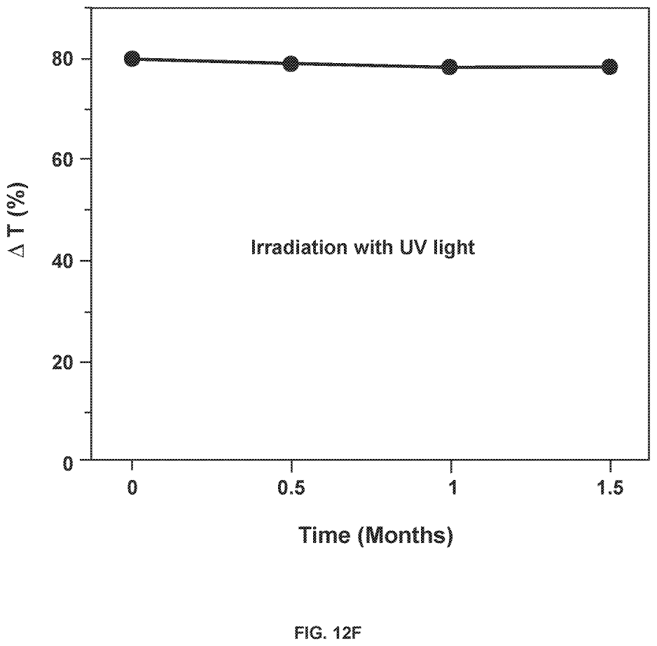

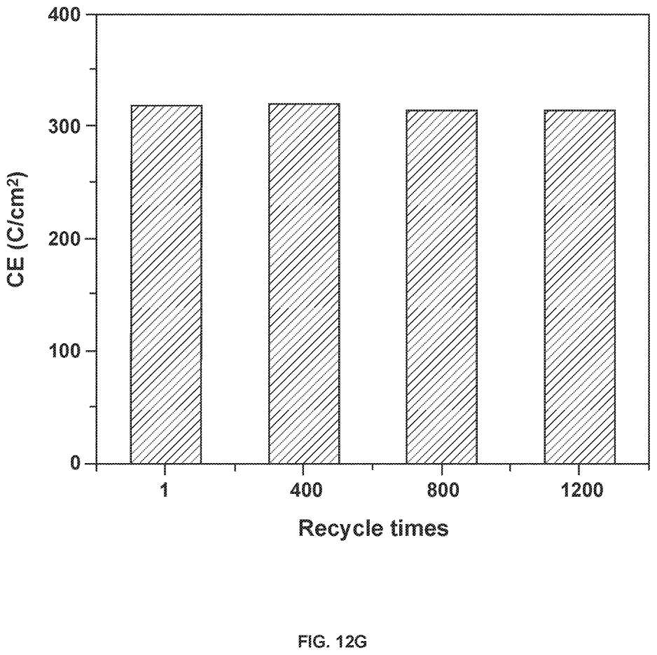

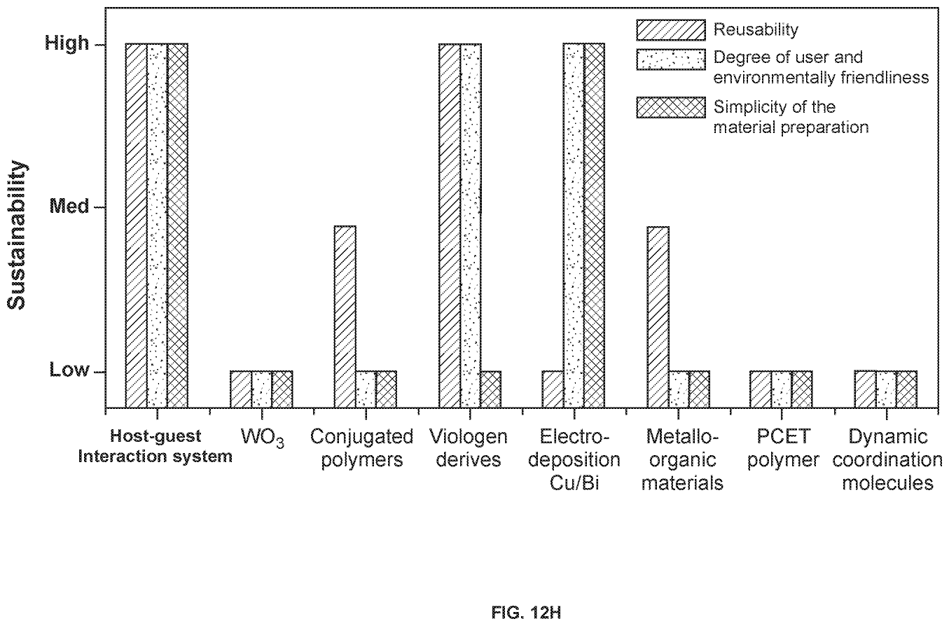

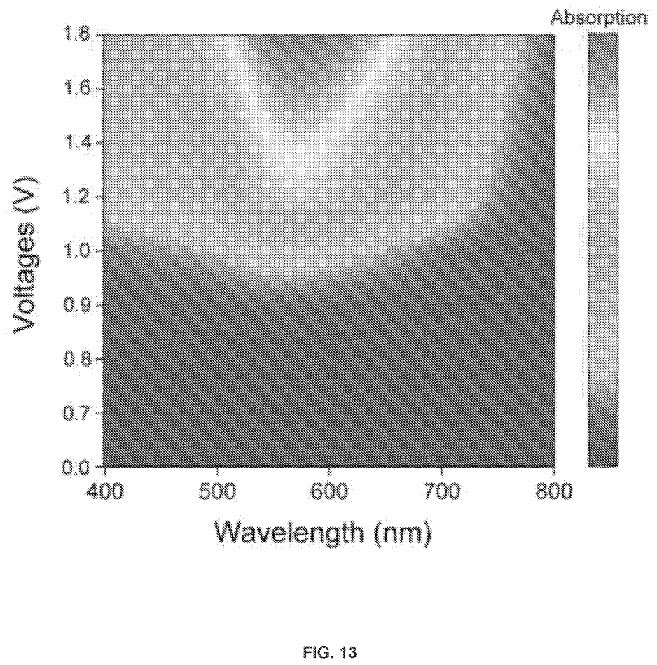

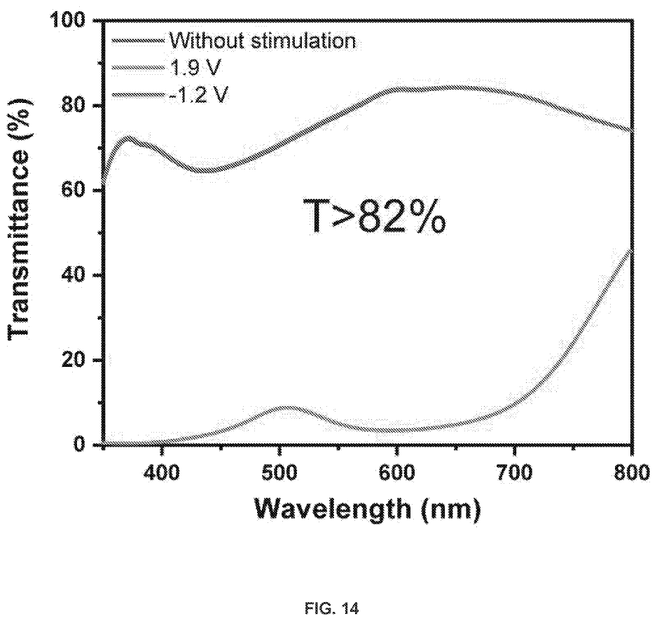

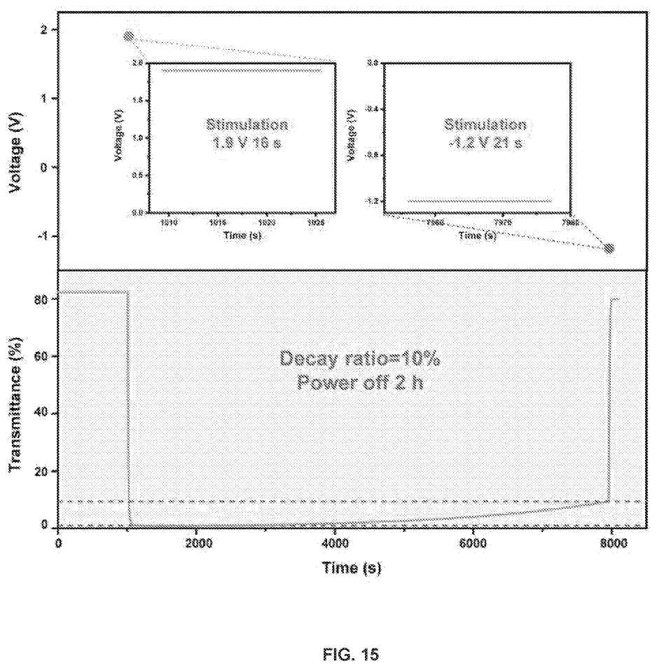

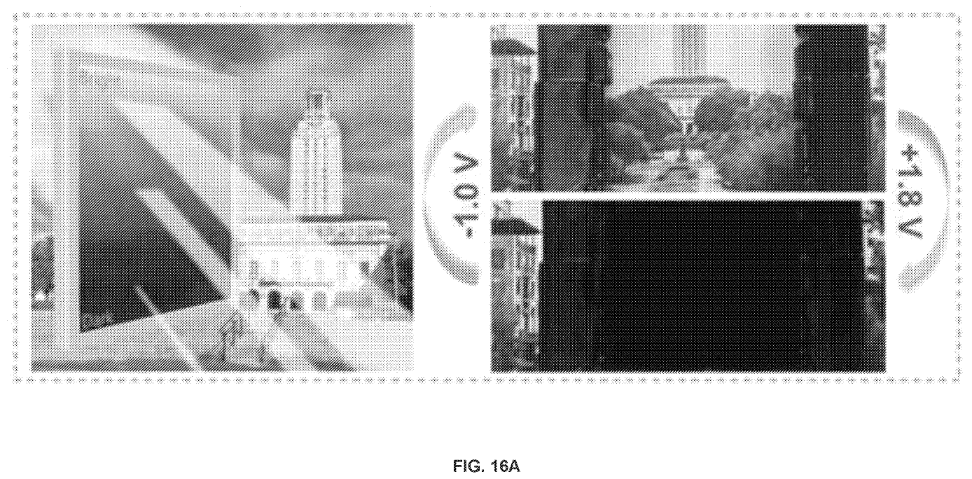

The performance of the device was investigated in detail as follows. Transmittance change of a non-limiting example of a device as described herein was observed to be highly dependent on the stimulated voltage. An immediate color change was generated when the voltages were above +0.9 V, as shown in FIG. 12A and FIG. 13. For example, FIG. 12A shows different grayscale displays with different voltage stimulation. This low turn-on voltage may be a result of the low oxidation potential of KI, which is beneficial for optimizing its service life. Meanwhile, as shown in FIG. 13, the color/transmittance gradient display can be obtained by adjusting the applied voltages, which is an important property for electronic display and facilitates broad color depth variations. A large transmittance change of 85.7% has been achieved under the voltage stimulation, along with the color change from the original colorless transparent state (T=86.2% at 615 nm) to black color (T=0.5%) in one embodiment of the EC system as described herein. FIG. 12B shows transmittance spectra of the device under different voltage stimulations. FIG. 12C shows maximum transmittance changes of different reported EC systems. Another example of a large transmittance change of greater than 82% is shown in FIG. 14, where a voltage of −1.2 V increases transmittance and a voltage of 1.9 V decreases transmittance. High contrast and transmittance change of the device may be useful for non-emissive transparent display avoiding interference from external background light. Coloration efficiency was calculated by CE=(Aa−Ab)/Q, where Aa and Ab stand for the absorbance of the EC system in colorless and colored state, and Q stands for the charge injected in the system. And the relatively high CE (320 cm²/C, FIG. 12D) indicated that a large optical modulation could be achieved under the same amount of injected electric charge. For example, FIG. 12D shows coloration efficiency of the EC system. The coloring-bleaching cycles were tested under a potential switch between 1.8 V to −1.0 V to evaluate the service life of one embodiment of the EC device described herein. FIG. 12E shows reversibility of the device under the voltage of 1.9 V/−0.9 V. Over 6500 cycles were conducted for the device, and no obvious attenuation (decay less than 4.5%), showing that the device possesses good stability. Additionally, as shown in FIG. 15, the colored state of the device can persist for approximately two hours without applying voltage, demonstrating suitable image retention capabilities without energy consumption.

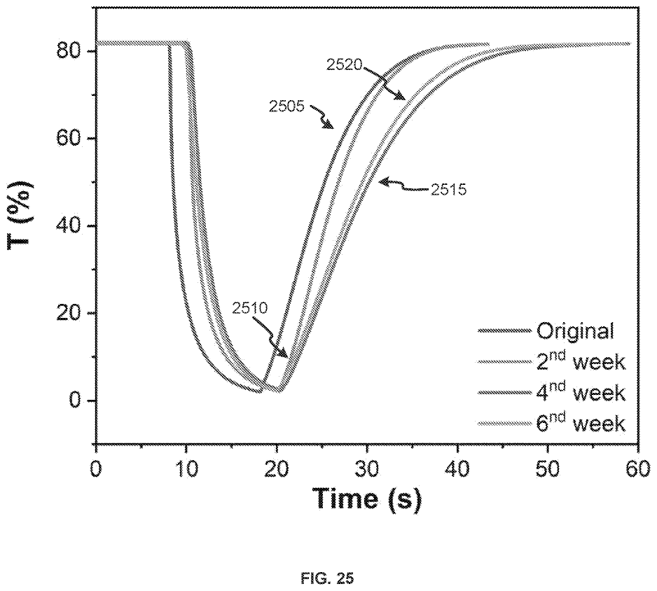

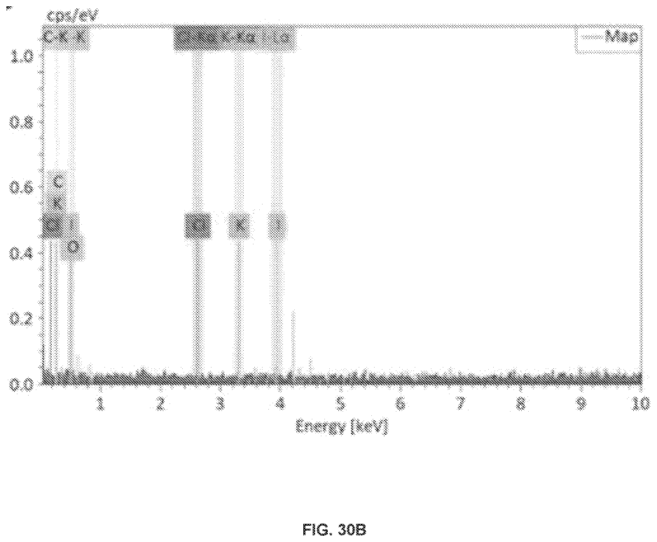

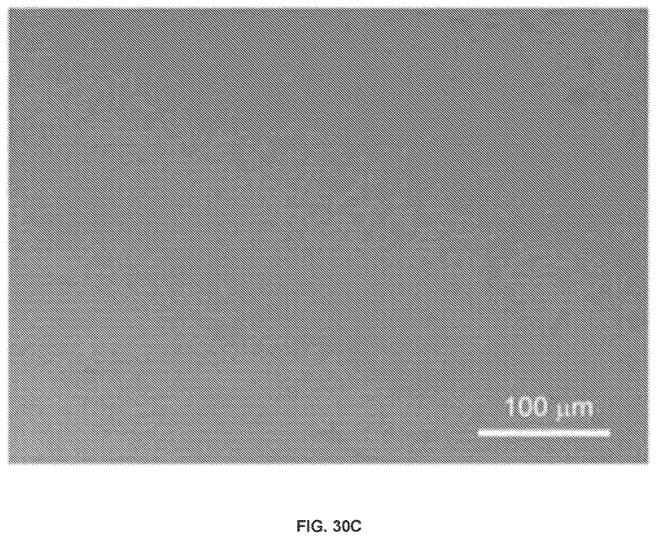

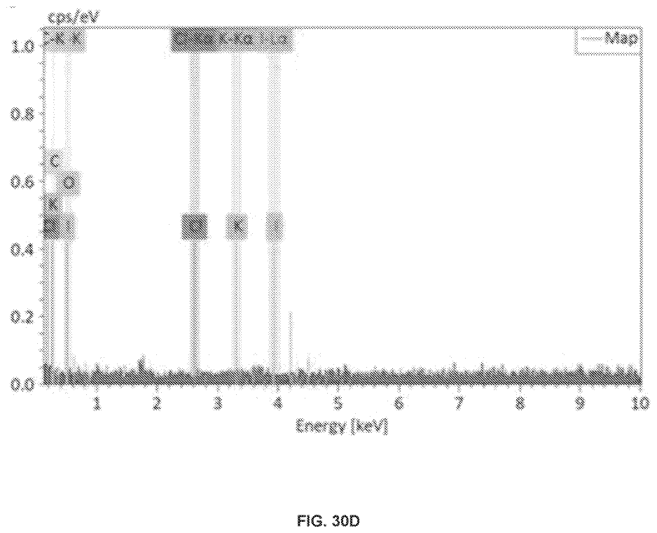

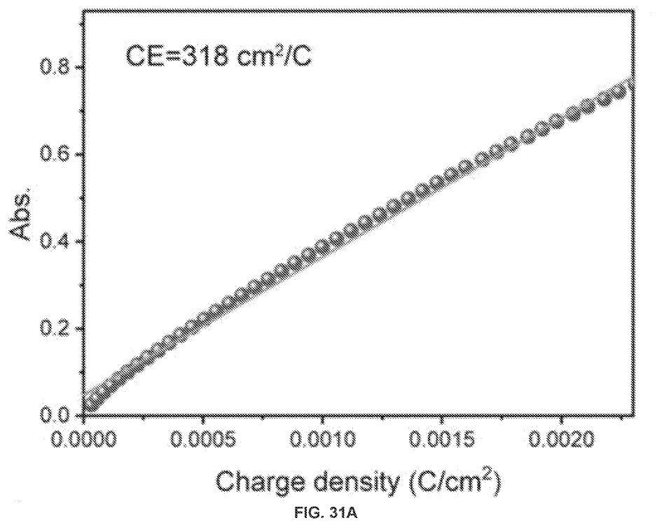

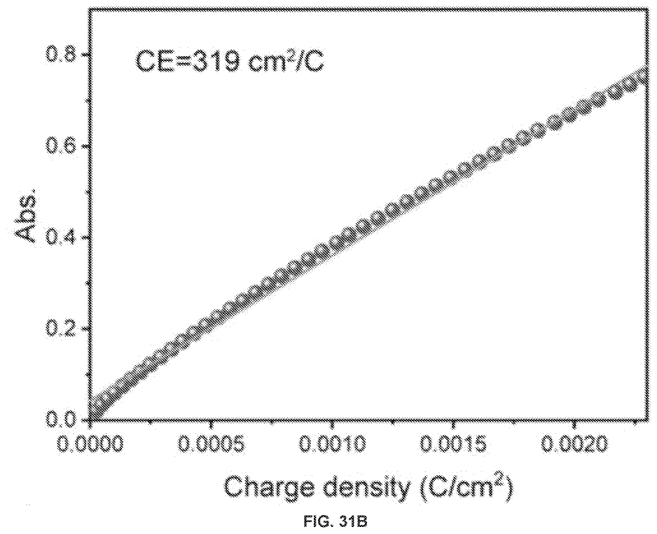

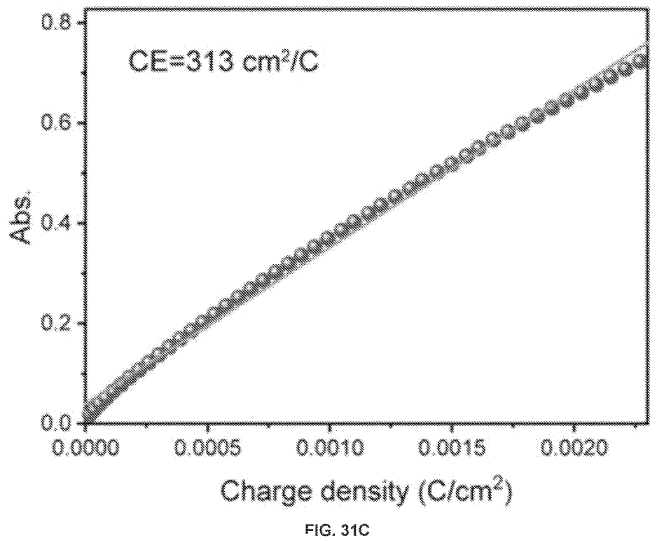

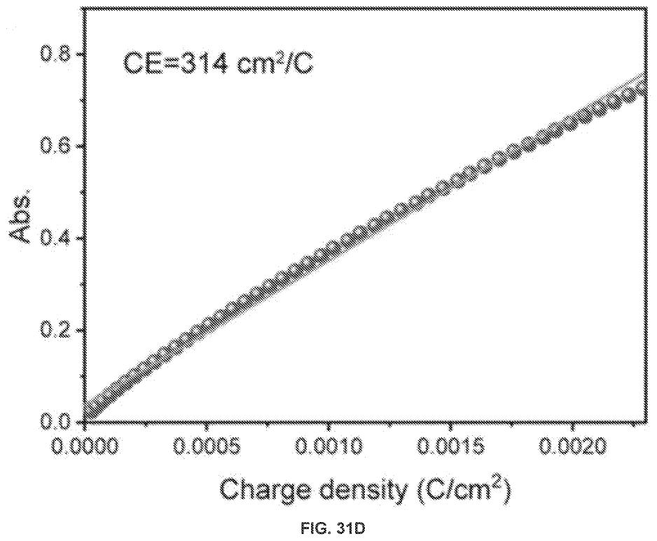

The stability of the EC device under UV stimulation is a relevant property because EC windows are typically exposed to sunlight containing ultraviolet light. Compared with the instability of the dye-based EC system and photochromic behavior of WO₃ system under the UV light, the transmittance change of one embodiment of the EC device described herein could maintain for at least 1.5 months without decay exposed to UV light (FIG. 12F and FIG. 25). For example, FIG. 25 shows transmittance of one embodiment of the EC device described herein over a period of six weeks. Line 2505 corresponds to an initial transmittance change of the EC device. Line 2510, line 2515, and line 2520 correspond to later transmittance changes of the EC device when tested after two weeks of UV light exposure, after four weeks of UV light exposure, and after six weeks of UV light exposure, respectively. FIG. 12F shows transmittance change of the EC device under the voltage of 1.9 V/−0.9V with different irradiation time of UV light. Electrode reuse may be a useful way to enhance recyclability and reuse of prepared components. The facile device disassembly process, excellent water solubility of EC materials and no insoluble product generated during the reaction process contribute to the reusability of electrodes. The ITO electrode and ion conducting film of one embodiment of the EC device described herein can be reused for more than 1200 cycles (FIG. 12G and FIG. 30 and FIG. 31). FIG. 12G shows coloration efficiency of the EC device by reusing the ITO electrode and ion conducting film. Therefore, the sustainability of different EC systems was firstly proposed and compared (FIG. 12H), which comprehensively considers the cost, involved solvents, and hazardous substances, the complexity of the synthesis and fabrication, reusability of electrodes and devices. The high sustainability shown in these EC systems and devices will accelerate the commercialization and popularization of EC technology, as well as the sustainable development of optoelectronic technology.

### 3. Application Demonstration

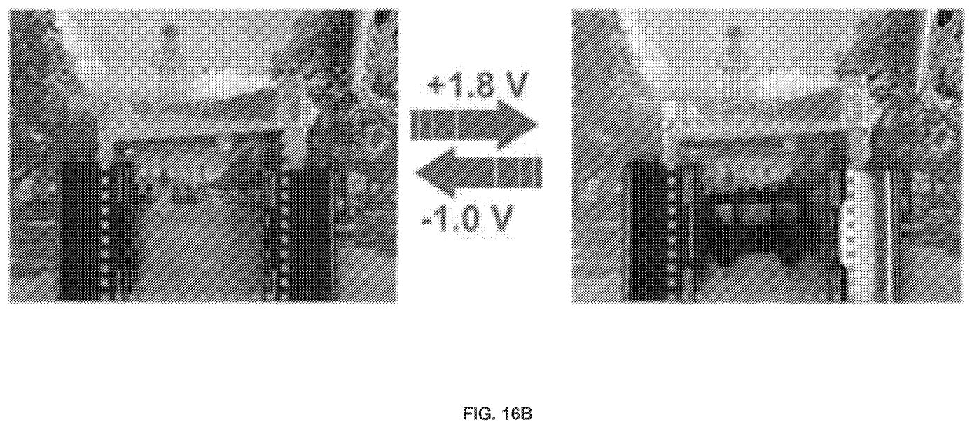

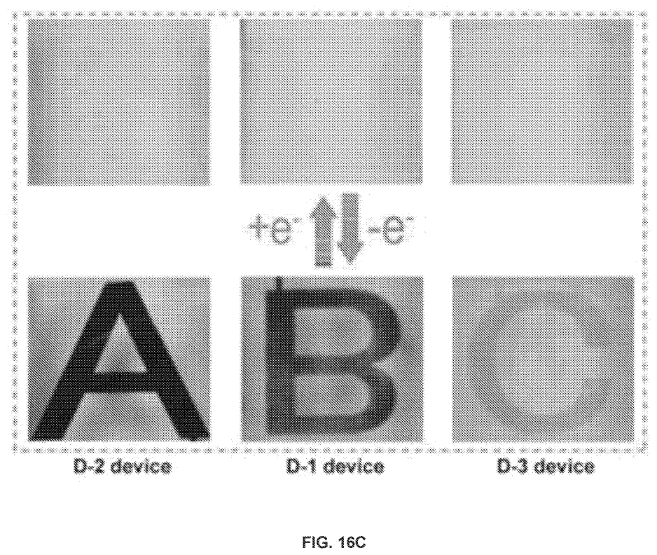

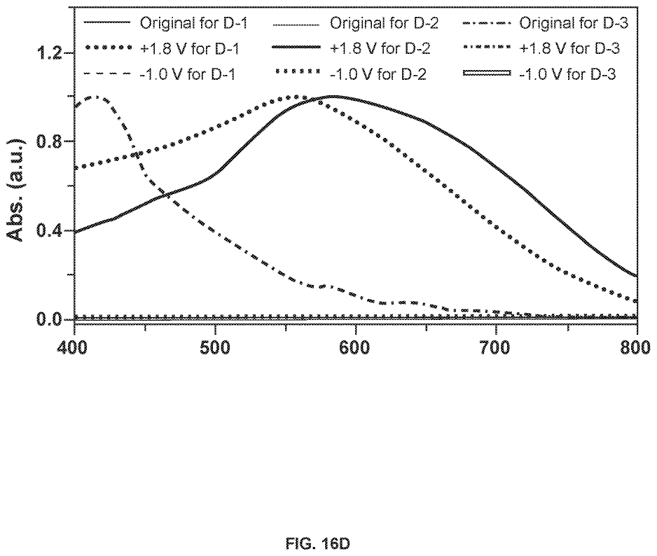

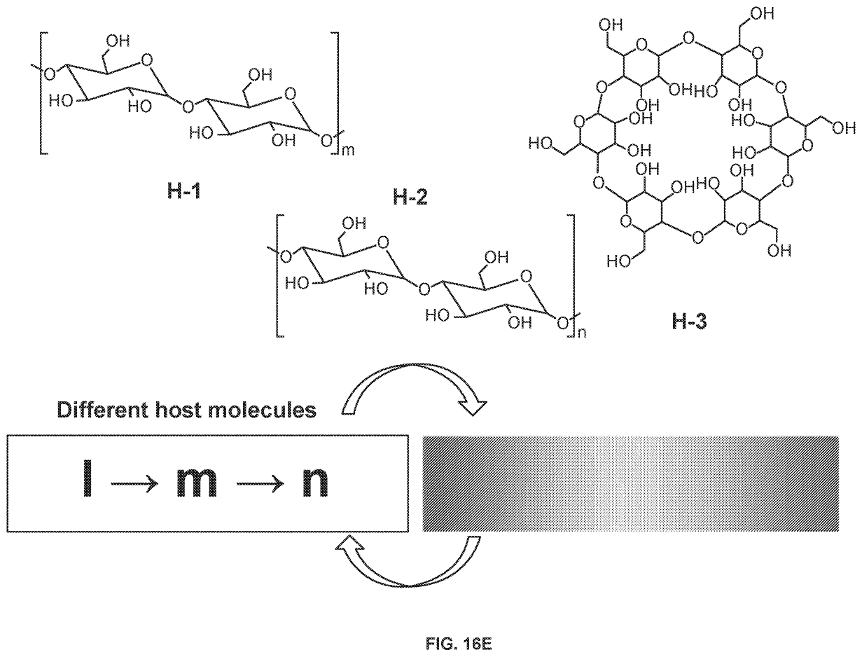

One embodiment of the EC device as described herein was fabricated as shown in FIG. 16A. In particular, FIG. 16A shows a display process of the EC window having a size of 5 cm by 4.5 cm. The device can convert from the original transparent colorless state to a completely black state, which shows the outstanding shading effect of the fabricated window. Excessive temperature caused by dark windows absorbing sunlight during the day may be relevant for implementation of smart windows. An effective strategy to ameliorate this may include adding a thin interlayer with flowing water near the discoloration side of the EC device, such as for enhancing thermal management. Another embodiment of the EC device described herein, having a non-emissive transparent EC display, was also fabricated by simple pre-treatment and laser-etching, and exhibited readable script and high contrast in the display (FIG. 16B and FIG. 32). FIGS. 16C and 16D show a multicolor transparent EC display prototype and related absorption spectra, respectively. For the D-1 EC device of FIG. 16D, H-1 is amylose extracted from potato. For the D-2 EC device of FIG. 16D, H-2 is amylose extracted from corn. For the D-3 EC device of FIG. 16D, H-3 corresponds to α-cyclodextrin. l, n, and m represent different numbers of fragments in the amylose. By replacing different guest molecules/polymers within the EC device, a multicolor display was also demonstrated. Without being bound by theory, it was observed that when oxidized iodine interacts with amylose extracted from potato and corn separately, different colors of the iodine-amylose complex generate, and may be related to the molecular weight and number of fragments in amylose polymer. Along with the increasing length of the glucan chain, the number of involved iodine molecules that can be also accommodated increases, increasing the iodine binding capacity. In some examples, the maximum absorbance wavelength of the iodine-amylose complex can even reach more than 650 nm due to the increased binding that can induce a shift the maximum absorbance wavelength. FIG. 16E shows HOMO and LUMO frontier orbitals of KI₃-amylose clathrate with different lengths of an amylose chain.

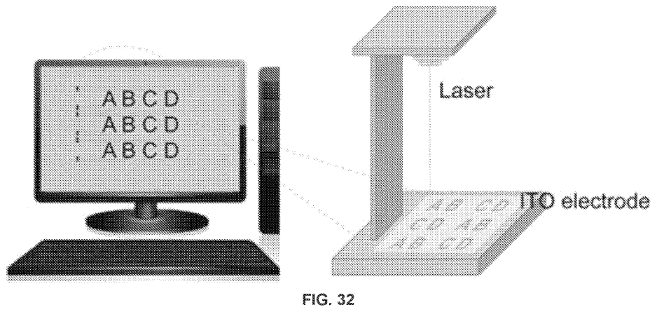

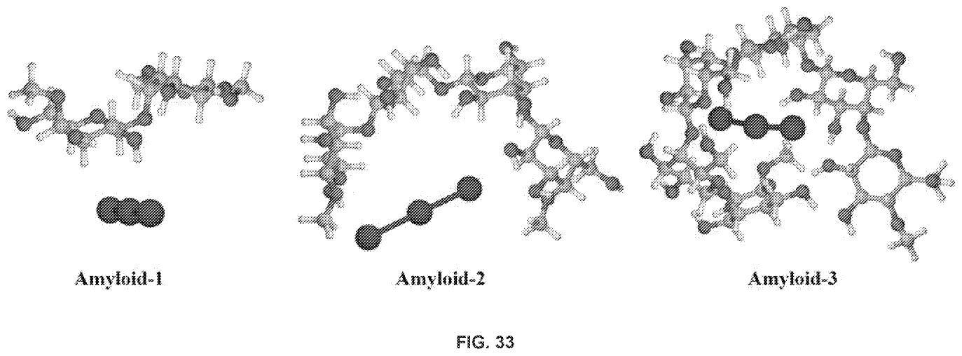

To illustrate the relationship between the color and related structures, the HOMO and LUMO snapshots of amylose-I⁻ complexes with different fragments number of amylose was calculated utilizing density functional theory (“DFT”) as an example (FIG. 16E and FIG. 33). FIG. 33 provides the optimized structure of the amyloid fragments. The white, gray, red, and purple colors denote H, C, O, and I atoms. The geometries of amylose fragments (amyloid-1, amyloid-2 and amyloid-3) and I₃-ion dimer were optimized via Gaussian 09 E01 with ultrafine integration grids at Lee-Yang-Parr gradient-corrected correlation functional (B3LYP) hybrid functional that comprises Grimme's DFT-D3 (BJ) empirical dispersion correction, and the def2-SVP basis set level of theory. Harmonic frequencies were performed at the same level to verify that these structures correspond to the minima on the potential energy surfaces. The HOMO (Highest occupied molecular orbital) and LUMO (Lowest unoccupied molecular orbital) were obtained from Multiwfn 3.8, whose input files were extracted by Gaussian checkpoint files, and plotted by VMD 1.9.3. Water solvent was introduced as an implicit solvent in all above calculations by the solvation model density (SMD) model. Notably, the HOMO-LUMO gaps become smaller with the increase in length of amylose chain, indicating that the optical spectrum gradually becomes blue shift when the number of fragments increases.

Described herein is a class of sustainable EC materials and devices based on host-guest interactions. Their reaction mechanisms were studied with FTIR, XRD, Raman spectra, and in-situ spectra-electrochemistry analyses. One embodiment of the EC device and multi-color non-emissive transparent display thus prepared herein showed a high transmission change, low switching voltage and high coloring efficiency. In addition, it offers advantages of user-/environmentally friendly, reusable, compatible with sustainability development.

### Preparation of an Example of the Electrochromic Device.

Electrochromic solution: A mixture of KI (0.05 mol/L), amylose (0.1 mol/L for glucose units), KCl (746 mg, 0.1 mol/L) in 10 mL deionized water was stirred for 30 min under 80° C. The ion conducting film was immersed in the electrolyte solution (KCl) with the concentration of 0.1 mol/L before assembling the device. Ion storage solution: A mixture of hydroquinone (33 mg, 0.03 mol/L), 4-Hydroxy-Tempo (25.8 mg, 0.015 mol/L), and KCl (746 mg, 0.1 mol/L) in 10 mL deionized water with was stirred for 30 min.

The fabricated PDMS frames were placed on the surface of both ITO electrodes. The EC solution was then drop coated in the cell of the first ITO electrode. Subsequently, the ion conducting film was placed on the top of the EC solution and followed by dropping the ion storage solution on the surface of the other side of the ion conducting film. Finally, both the ITO electrodes were assembled together. Herein, the thickness of the EC layer could be adjusted by the thickness of the PDMS frame.

### The Calculation of the Coloration Efficiency, Transmittance Change and Response Rate.

The coloration efficiency (CE) is defined as the absorbance change (ΔA) obtained by injecting a specific amount of charge per unit area (Q). The CE was calculated from the following formula: CE=ΔA/Q. Air was used as reference for absorption measurements. Herein, the area of the fabricated EC device is 4.2 cm².

Transmittance change: ΔT=T₁−T₂, T₁ represents the transmittance of colorless state, and T₂ represents the transmittance of colored state. Air was used as reference for these transmittance measurements.

Response rate: α=ΔT/At (s¹). Wherein, the ΔT denotes as the transmittance change of the device under the electric stimulation, and the Δt represents the time it takes during the tinting or bleaching process to modulate transmittance of the fabricated device from 0% to 90% of transmittance change ratio.

Table 1 provides a comparison of one non-limiting example of an EC device as described herein and other EC devices made with various materials. The example of the EC device described herein includes a host-guest complex system as the EC material to provide suitable color variation, durability, and reusability with relatively low voltage stimulation. As shown in Table 1, the host-guest complex system enables the highest change in transmittance of all EC materials provided in Table 1. Additionally, the host-guest complex system uses a relatively low response voltage of 0.9 V while having a comparatively fast response time of 3.2 seconds. The host-guest complex system can contribute to sustainability by providing a reversibility of 6500 cycles. By providing an UV durability of 1.5 months, the EC device prepared using the host-complex system exhibits stability under UV stimulation that is suitable for implementation as an EC window. Further, the EC device with the host-guest complex system provides a high optical modulation in multiple spectra. In contrast to the other EC devices, the EC device with the host-guest complex system can provide optical modulation in the UV spectrum as well as in the Vis-IR and multicolor spectra.

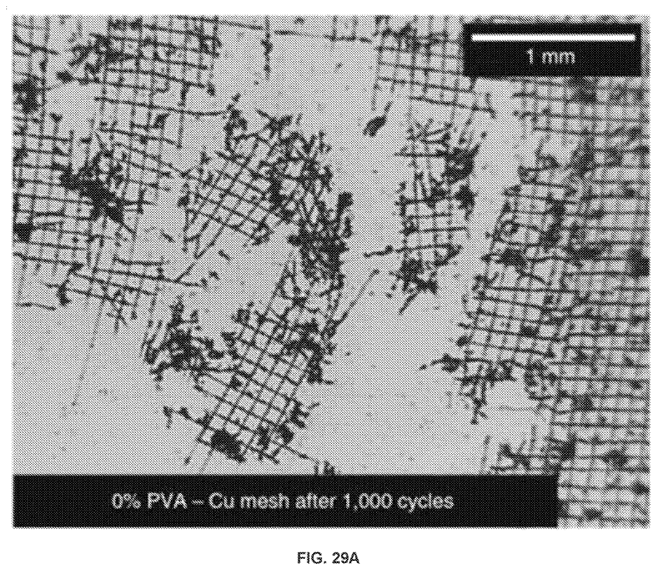

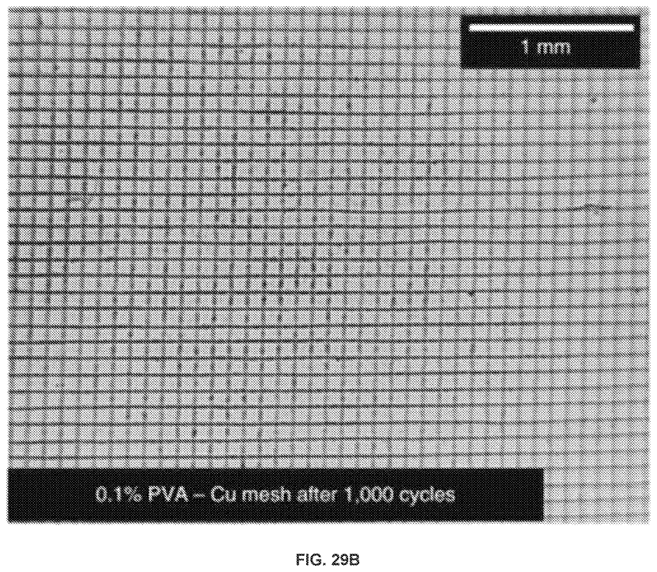

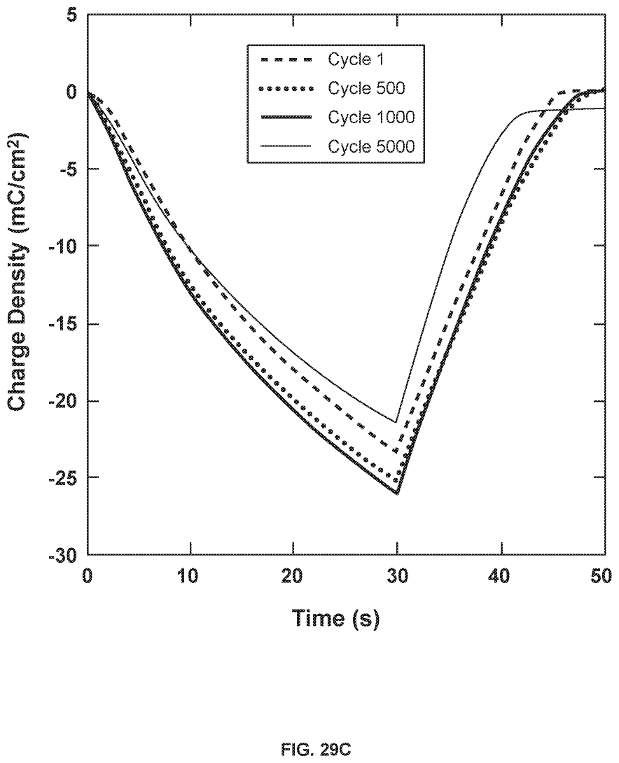

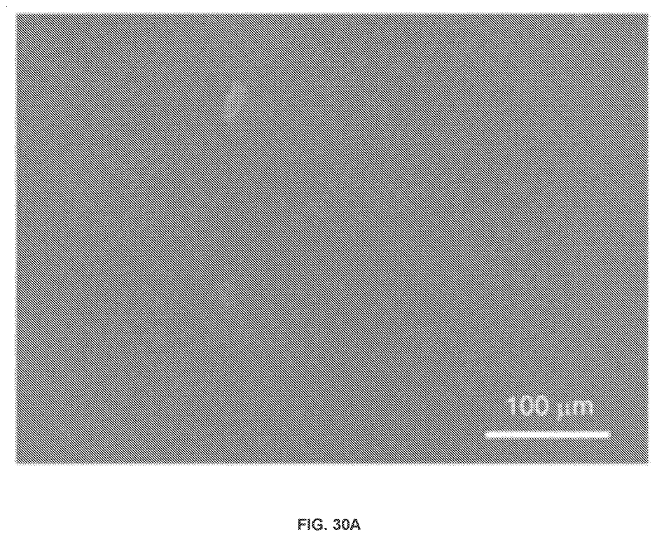

FIGS. 29A and 29B provide a Cu mesh counter electrode involved in the electrodeposition Cu²⁺/Bi⁺ system after 1,000 cycles in the device without PVA and device improved by adding 0.1 wt % PVA to the electrolyte. FIG. 29C provides the reversibility of the EC device involved in improved electrolytes.

TABLE 1

| Different EC | ΔT | Response | | Response | | Reversibility | UV | Optical |
|---|---|---|---|---|---|---|---|---|
| materials | (%) | voltage | | time | | (cycles) | Durability | modulation |
| Host-guest complex | 85 | 0.9 | V | 3.2 | s | 6500 | 1.5 months | UV-Vis-IR |
| system (one example | | | | | | | | Multicolor |
| embodiment as | | | | | | | | |
| described herein) | | | | | | | | |
| Cu/Bi | 65 | −2.5 | V | 65 | s | 4000 | N/A | Vis-IR |
| Electrodeposition | | | | | | | | (black) |
| WO₃ films | 70 | 3.5 | V | 12 | s | 1000 | N/A | Vis-IR |
| | | | | | | | | (black) |
| WO₃ PEDOT-PSS | 70 | −0.7 | V | 12.7 | s | 150 | N/A | Vis-IR |
| | | | | | | | | (blue) |
| WO₃ nanorolls | 25 | −2.0 | V | 8.0 | s | 2000 | N/A | Vis-IR |
| | | | | | | | | (blue) |
| Conjugated polymer | 72 | 1.5 | V | 0.5 | s | 3000 | N/A | Vis (blue) |
| Conjugated polymer | 49 | −0.8 | V | 3.0 | s | 1000 | N/A | Vis (gray) |
| Metallo-organic | 50 | −2.5 | V | 2 | s | 500 | N/A | Vis, |
| nanoscale films | | | | | | | | multicolor |
| Viologen | 60 | −1.5 | V | 0.5 | s | 500 | N/A | Vis (black) |
| Asymmetric | 56 | −0.8 | V | 15 | s | 15,000 | N/A | Vis (green) |
| viologens | | | | | | | | |
| Intramolecular | 70 | 0.7 | V | 1.5 | s | 12,000 | N/A | Vis, |

| | | | | | | | |
|---|---|---|---|---|---|---|---|
| concerted PCET | | | | | | | multicolor |
| polymer | | | | | | | |
| Dynamic metal- | 74 | 0.8 | V | 2.0 s for | 2400 | N/A | Vis, |

| | | |
|---|---|---|
| ligand coordination/ | ΔT = 70% | multicolor |
| dissociation | | |
| molecules | | |

### Example 2

Instrumentation. UV-Vis absorption spectra were performed on a UV-vis-NIR spectrometer (Cary 5000). The X-ray diffraction pattern was conducted on Rigaku Miniflex 600 Diffractometer. The Raman spectra were carried out by spectrometer (WITec alpha300). The FTIR spectra were measured on the FTIR Spectrometer (Thermo Mattson, Infinity Gold FTIR) equipped with liquid nitrogen cooled narrow band mercury cadmium telluride (MCT) detector, using an attenuated total reflection cell equipped with a Ge crystal. Scanning electron microscopy (SEM) images were performed on Scanning Electron Microscopy (Hitachi, S5500, and Navo Nano SEM450). The thickness of different layers was measured on the step profiler DEKTAK 150.

Electrochemistry. Cyclic voltammetry (CV) tests were measured on a Bio-logic electrochemical workstation under room temperature (25° C.). All electrochemical experiments were conducted using the three-electrode system in water unless other mentioned, which contained KCl (1.0 mol/L) as supporting electrolyte. The three-electrode cell included an Ag/AgCl reference electrode, a glass-carbon working electrode (3 mm diameter), and Pt (platinum) wire counter electrode. The working electrode was well polished with 0.3 m and 0.05 m nano alumina powder, and then was ultrasonic cleaned in deionized water three times. Unless otherwise stated, the tested molecules were dissolved in water, and the concentration was 1.0×10³ mol/L.

The in-situ synchronizing electrochemistry-spectra method was conducted on an in-situ three-electrode cell including an Ag/AgCl reference electrode, a Pt wire counter electrode and a platinum networking electrode.

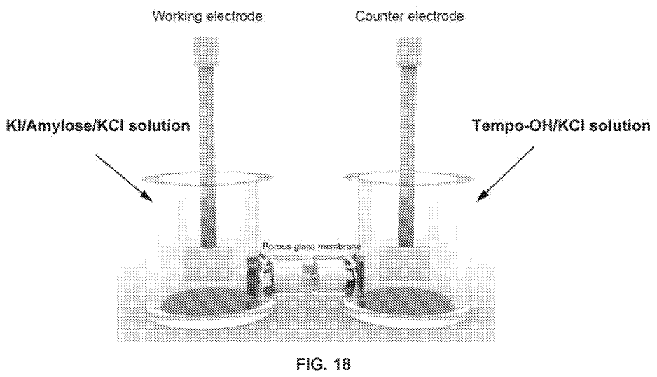

The mixture of oxidized KI/amylose in FIGS. 6D, 6E, and 6F was fabricated in the electrolyte cell with a two-electrode system under the voltage of 1.5 V, as shown in FIG. 18. FIG. 18 provides a diagram of electrolytic cell for fabricating oxidized KI/amylose mixture. The solution of KI/amylose/KCl was stimulated with 1.5 V for 12 hours. After then, related mixture solid product was obtained via a freeze-drying method.

In addition, the applied voltage is referred to the counter electrode due to the structure of the EC device is a two-electrode system.

Test of visible absorption spectra. All the in-situ absorption spectra were measured in the cell of an in-situ three electrodes system by using KCl as the electrolyte during the electric stimulation under room temperature (25° C.). The samples to be tested herein were all dissolved initially in water. Air was used as a reference for the measurements. The optical path of the sample cell was 1 mm.

The absorption spectra of KI, amylose, the mixture of KI and amylose, and the mixture of KI, amylose and Na₂S₂O₄ were tested in water at room temperature (25° C.) and the thickness of the sample cell was 1 cm. The water was used as a reference for the absorption measurements.

The thickness of the electrochromic layer was 220 m before optimizing the devices' structure by investigating the thickness of the EC layer. And the thickness of the ion storage layer was 268 m unless otherwise stated.

The transmittance and absorption spectra of electrochromic devices under voltages were tested and the air was used as a reference for the measurements. The area of the device is about 2 cm×2.5 cm unless otherwise stated.

Randles-Sevcik equation to calculate the diffusion coefficient.

$${i}_{p} = ( 2.69 \times 1 {0}^{5} ) \times A {n}^{3 / 2} {D}^{1 / 2} c {v}^{1 / 2}$$

where n represents the number of electrons (assumed to be 1), D is in the unit of cm² s⁻¹, A represents the area (cm²) of the working electrode, c represents the concentration of active ions (mol cm⁻³), v is the scan rate (mVs⁻¹) and iₚ represents the peak current (mA).

Cation ion exchange procedure for Nafion-117 film. Nafion-117 membrane was first treated with 5% hydrogen peroxide at 80° C. for 1 hour, and then soaked in deionized water for half an hour. After then, it was boiled in 5% dilute sulfuric acid at 80° C. for 1 hour, followed by soaking it in deionized water for half an hour. Finally, the obtained films were soaked with different electrolyte solutions overnight to obtain Nafion ion exchange films with different cations. Herein, the Nafion-K⁺ film was obtained by being treated with KCl solution (0.1 mol/L).

Fabrication of the non-emissive transparent display. The demonstrated information had been laser ablated or chemically etched on the ITO glass accordingly. For example, FIG. 32 provides an etching ITO process for non-emissive transparent display by the laser marking machine HPWU300-SKS. The PDMS frame was then placed on the surface of the etched ITO, followed by dropping the EC solution in the cell. And then the ion conducting film was placed on the top of the EC solution and followed by dropping the ion storage solution on the surface of the other side of the ion conducting film. Finally, the other unetched ITO electrode was involved to assemble the device together.

The fabrication procedure of different classes of electrochromic devices.
a. EC devices using proton-coupled electron transfer (PCET) polymer.

The fabrication procedure of the PCET polymer follows.

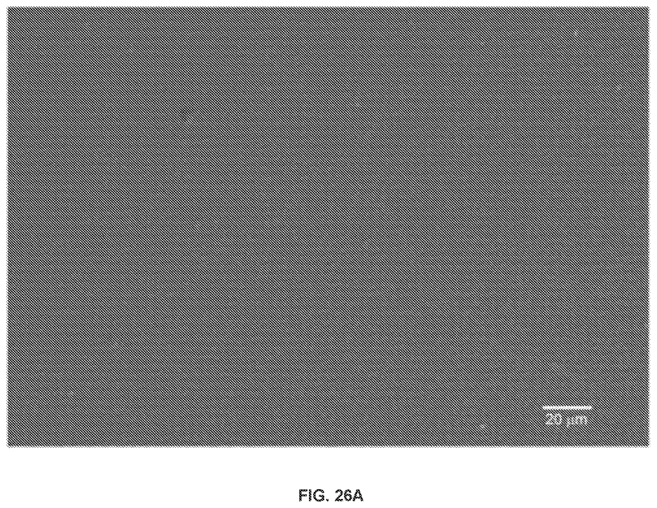

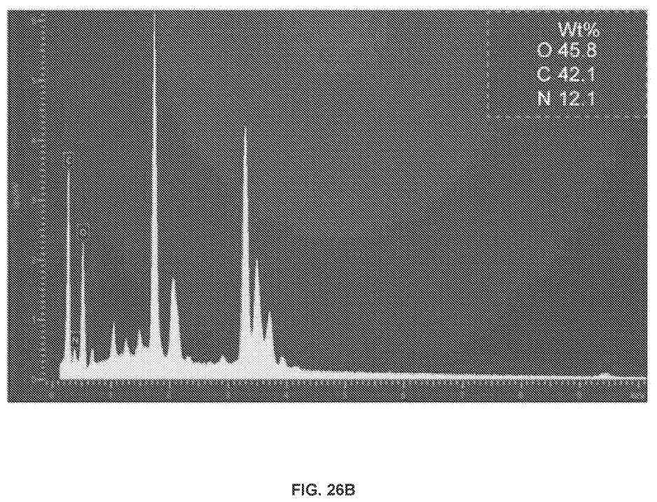

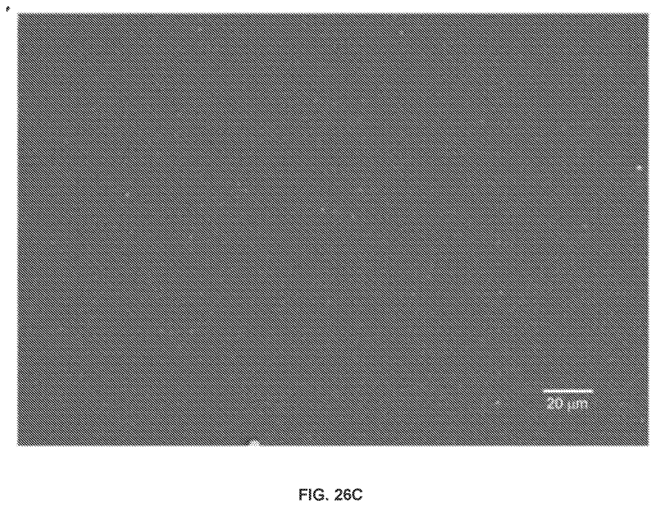

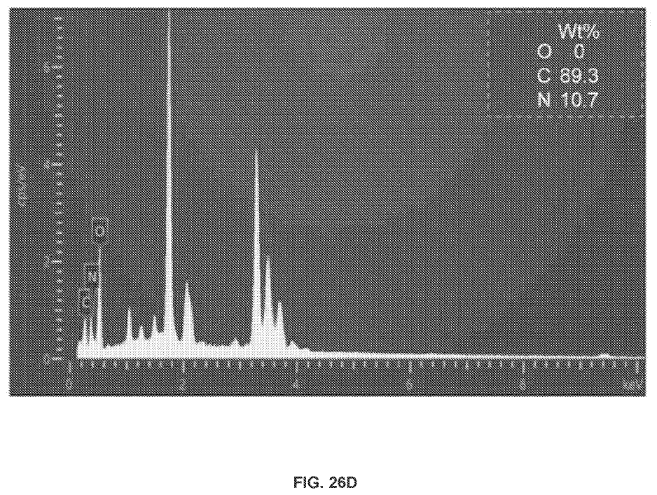

The solid EC device consists of five layers including an EC layer, an ion storage layer, an ion conducting layer and two indium tin oxide glasses (ITO). First, the EC solution was spin-coated (15 s, 2000 r.p.m.) on the first ITO electrode to form an EC film, followed by coating ion conducting film on top of the prepared EC film. Second, the ion storage film was spin-coated onto the second ITO electrode. Finally, both the ITO glasses were assembled together. FIG. 26A and FIG. 26B provide SEM images and EDS elemental mappings, respectively, of an ITO electrode involved in the PCET EC device, which has been cleaned by water. FIG. 26C and FIG. 26D provide SEM images and EDS elemental mappings, respectively, of an ITO electrode involved in the PCET EC device, which has been cleaned by CH₂Cl₂.

Electrochromic solution: A mixture of propylene carbonate (PC) (5.0 mg, 10%, wt %), TBAPF₆ (5.0 mg, 10%, wt %) and RHMA (40.0 mg, 80%, wt %) dissolved in 1.0 mL THF.

Ion storage solution: A mixture of propylene carbonate (0.58 g, 15%, wt %), PMMA (2.70 g, 70%, wt %), TBAPF₆ (0.58 g, 15%, wt %) in 30 mL CH₃CN solvent with benzoquinone (0.05 mol/L) and hydroquinone (0.05 mol/L) was stirred for about 2 hours.

Ion conducting solution: A mixture of propylene carbonate (0.58 g, 15%, wt %), TBAPF₆ (0.58 g, 15%, wt %), PMMA (2.70 g, 70%, wt %) dissolved in 15 mL acetonitrile.
b. EC device using WO₃₋ₓ nanowires.

The fabrication procedure of the m-WO₃₋ₓNW film and related EC device follows.

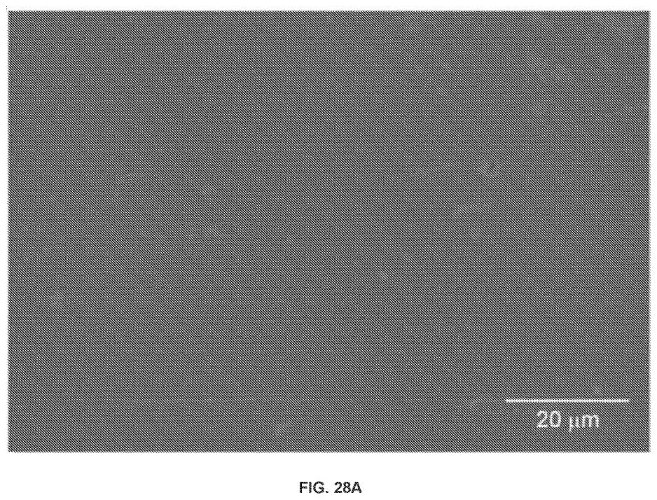

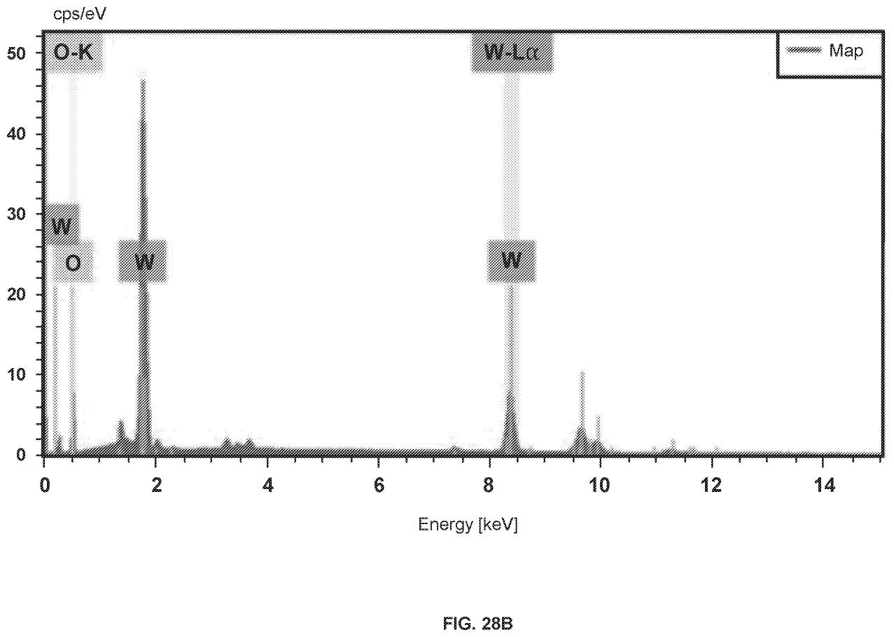

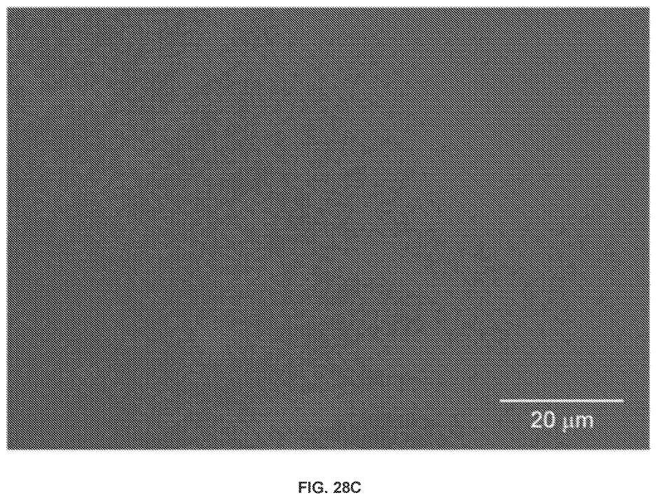

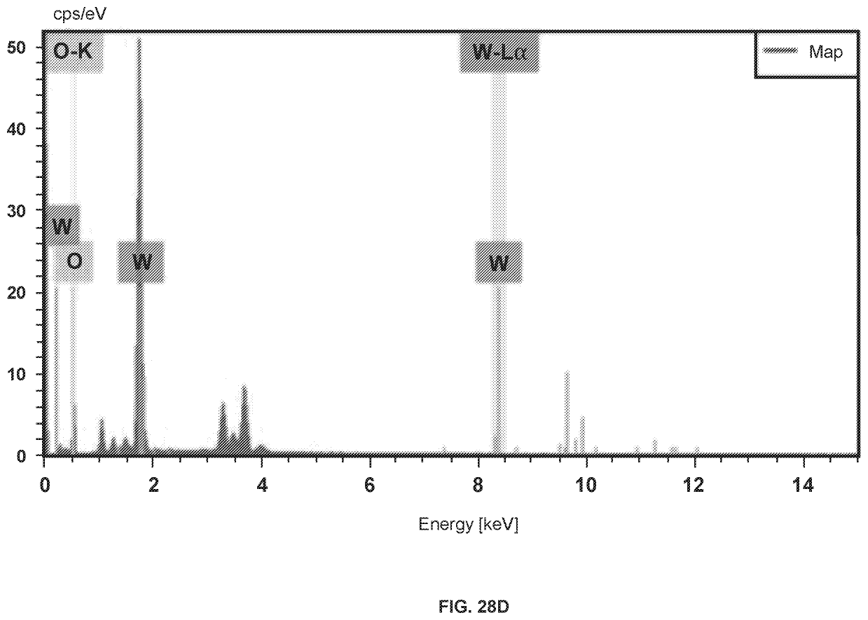

The device consists of the ITO working electrode coated with m-WO₃₋ₓ NW film, a transparent ITO glass counter electrode, and a spacer (product number: LB-3768) structured by heating-curing adhesive. The ion conducting solution (that is, 1 mol/L Al(ClO₄)₃ in propylene carbonate) was then injected, followed by being sealed and cured with a UV curing adhesive. FIGS. 28A and 28B provides SEM images and EDS elemental mappings, respectively, of an ITO electrode involved in the WO_{3-X} nanowires EC device, which has been cleaned by water. FIGS. 28C and 28D provide SEM images and EDS elemental mappings, respectively, of an ITO electrode involved in the WO_{3-X} nanowires EC device, which has been cleaned by toluene.
c. EC device using dynamic coordination EC system.

Electrochromic solution: A mixture of 2-anilino-6-(dibutylamino)-3-methylfluoran (M1) (85.12 mg, 1.6×10⁻² mol/L), CuI (7.60 mg, 4.0×10⁻³ mol/L), p-Benzoquinone (10.80 mg, 1.0×10⁻² mol/L), [BMIM]PF₆ (0.62 mL, 0.3 mol/L) in 10.0 mL acetonitrile was stirred for about 30 min.

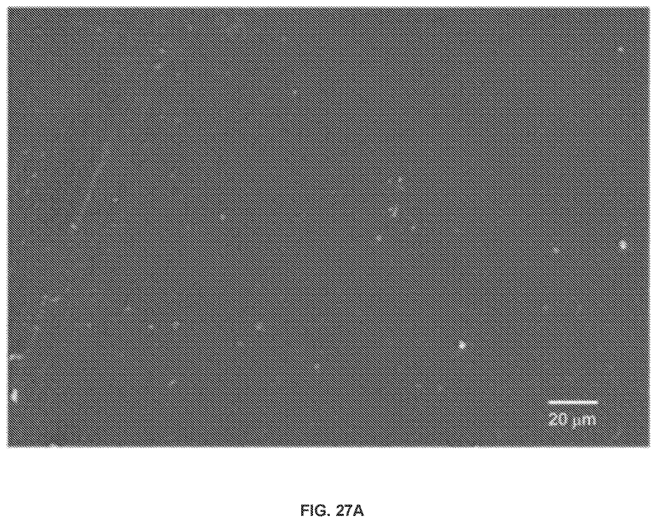

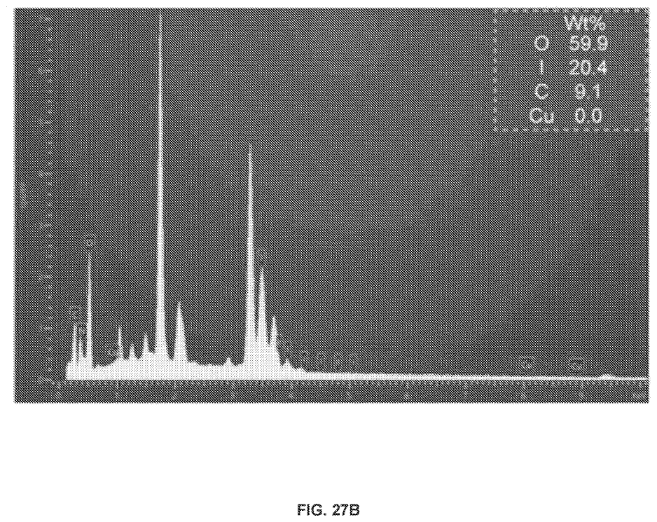

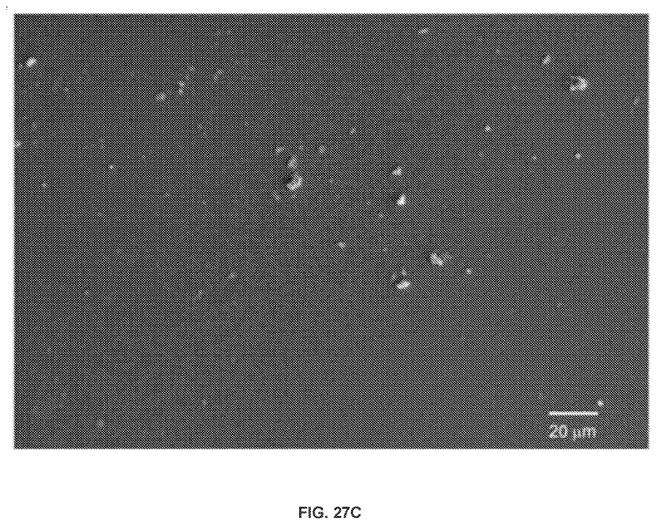

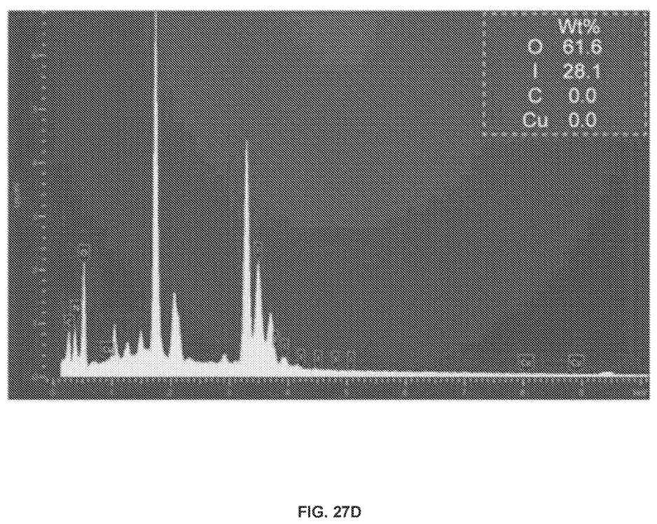

FIGS. 27A and 27B provides SEM images and EDS elemental mappings, respectively, of an ITO electrode involved in the dynamic coordination EC device, which has been cleaned by water. FIGS. 27C and 27D provide SEM images and EDS elemental mappings, respectively, of an ITO electrode involved in the dynamic coordination EC device, which has been cleaned by acetonitrile.

### Example 3

Extraction of amylose. Corn/potato starch (5 g) and NaOH aqueous solution (180 mL, 0.5 mol/L) were placed in a 250 mL round bottom flask with stirring for 10 minutes at 100° C. to make the substances dissolved. After then, the mixture was centrifuged at 8000 rpm for 10 minutes after being cooled at 2~4° C. for 0.5 h. The mixture was neutralized with HCl solution (2 mol/L) and then a mixture of butanol (38 mL) and isoamyl alcohol (13 mL) was added, followed by storing the mixture at 2~4° C. for 24 hours. After the suspensions were centrifuged at 8000 rpm for 10 min, the solid crude amylose was obtained.

Purification of amylose. The above crude amylose was added to deionized water saturated with butanol (200 mL) with stirring at 100° C. to make the substance dissolved. The mixture was then centrifuged at 8000 rpm for 10 minutes to obtain a residue after being cooled at 2-4° C. for 12 h. At last, the above purification operation was repeated 5-10 times.

### REFERENCES

U.S. Pat. Nos. 6,039,390; 6,586,256; 7,267,875; 8,867,132; 9,254,789; 9,405,164; 10,253,559; 10,281,791; 10,962,783; 11,355,774; 11,367,824.
U.S. Patent Application Publication No. US 2016/0027391.
PCT International Application Publication Nos. WO 1997/035332, WO 2007/094840, WO 2020/179433, and WO 2022/153998.
JP Publication Nos. JP2007163744, JPH0927141, JPH0610734, JP2008210570, JP2007163744.
PT Publication No. 108905A.
DE Publication No. 3444944.
KR Publication No. 20140085755.
CN Publication No. 111929932.
Alesanco, Y., Vinuales, A., Cabanero, G., Rodriguez, J., & Tena-Zaera, R. “Colorless to neutral color electrochromic devices based on asymmetric viologens.” ACS Appl. Mater. & Interfaces 8, 29619-29627 (2016). DOI: 10.1021/acsami.6b11321.
Building Technologies Ofce. “R&D Roadmap for Emerging Window and Building Envelope Technologies” (US Department of Energy, 2014).
Bailey, J. M., & Whelan, W. J. “Physical properties of starch.” J. Biol. Chem., 236, 969-73 (1961). DOI: 10.1016/S0021-9258 (18)64226-7
Beaujuge, P. M., Ellinger, S., & Reynolds, J. R. “The donor-acceptor approach allows a black-to-transmissive switching polymeric electrochrome.” Nat. Mater. 7, 795-799 (2008). DOI: 10.1038/nmat2272.
Beaujuge, P., & Reynolds, J. “Color control in π-conjugated organic polymers for use in electrochromic devices.” Chem. Rev. 110, 268-320 (2010). DOI: 10.1021/cr900129a.
Bourdin, M. et al. “Investigation on the coloring and bleaching processes of WO_{3-X} photochromic thin films.” J. Mater. Chem. C. 8, 9410-9421 (2020). DOI: 10.1039/DOTC02170A.
Cai, G., Darmawan, P., Cheng, X., & Lee, P. S. “Inkjet printed large area multifunctional smart windows.” Adv. Energy Mater. 7, 1602598 (2017). DOI: 10.1002/aenm.201602598.
Cheng, W., He, J., Dettelbach, K. E., Johnson, N. J., Sherbo, R. S., & Berlinguette, C. P. “Photodeposited amorphous oxide films for electrochromic windows.” Chem. 4, 821-832 (2018). DOI: 10.1016/j.chempr.2017.12.030.
Christiansen, D., Tomlinson, A., & Reynolds, J. “New Design Paradigm for Color Control in Anodically Coloring Electrochromic Molecules.” J. Am. Chem. Soc. 141, 3859-3862 (2019). DOI: 10.1021/jacs.9b01507.
Elool Dov, N. et al. “Electrochromic metallo-organic nanoscale films: fabrication, color range, and devices.” J. Am. Chem. Soc. 139, 11471-11481 (2017). DOI: 10.1021/jacs.7b04217.
Geng, W.-C., Sessler, J., Guo, D.-S. “Supramolecular prodrugs based on host-guest interactions.” Chem. Soc. Rev. 49, 2303-2315 (2020). DOI:10.1039/C9CS00622B.
Grätzel, M. “Materials science: ultrafast colour displays.” Nature, 409, 575-576 (2001). DOI:10.1038/35054655.
Hassid, W. & McCready, R. “The Molecular Constitution of Amylose and Amylopectin of Potato Starch.” J Am. Chem. Soc. 65, 61157-1161 (1943). DOI: 10.1021/ja01246a039.
Hernandez, T. et al. “Bistable Black Electrochromic Windows Based on the Reversible Metal Electrodeposition of Bi and Cu.” ACS Energy Lett., 3, 104-111 (2017). DOI: 10.1021/acsenergylett.7b01072.
Islam, S., Hernandez, T., McGehee, & M. Barile, C. “Hybrid dynamic windows using reversible metal electrodeposition and ion insertion.” Nat. Energy, 4, 223-229 (2019). DOI:10.1038/s41560-019-0332-3.
Kim, Y. et al. “Energy saving electrochromic polymer windows with a highly transparent charge-balancing layer.” Adv. Funct. Mater., 27, 1701192 (2017). DOI: DOI:10.1002/adfm.201701192.
Knutson, C. A. “Evaluation of variations in amylose-iodine absorbance spectra.” Carbohydr. Polym., 42, 65-72 (2000). DOI:10.1016/S0144-8617 (99)00126-5.
Kortz, C., Hein, A., Ciobanu, M., Walder, L., & Oesterschulze, E. “Complementary hybrid electrodes for high contrast electrochromic devices with fast response.” Nat. Commun., 10, 4874 (2019). DOI:10.1038/s41467-019-12617-4.
Lahav, M., & van der Boom, M. E. “Polypyridyl Metallo-Organic Assemblies for Electrochromic Applications.” Adv. Mater., 30, 1706641 (2018). DOI: 10.1002/adma.201706641.
Li, Z., & Merz Jr, K. M. “Systematic Evaluation of Ion Diffusion and Water Exchange.” J. Chem. Theory Comput. 18, 3017-3026 (2022). DOI: 10.1021/acs.jctc.1c01189.
Ma, X., Zhao, Y. “Biomedical Applications of Supramolecular Systems Based on Host-Guest Interactions.” Chem. Rev., 115, 7794-7839 (2015). DOI: 10.1021/cr500392w.
Marcus, Y. “Ionic radii in aqueous solutions.” Chem. Rev. 88, 1475-1498 (1988). DOI: 10.1021/cr00090a003.
Nakahata, M. et al, “Redox-responsive self-healing materials formed from host-guest polymers.” Nat. Commun., 2, 511 (2011). DOI: 10.1038/ncomms1521.
Pleasants, S. “Wide-angle head-up display.” Nat. Photonics, 8, 84 (2014). DOI: 10.1038/nphoton.2014.16.
Rai, V., Singh, R., Blackwood, D., & Zhili, D. “A review on recent advances in electrochromic devices: a material approach.” Adv. Eng. Mater., 22, 2000082 (2020). DOI:10.1002/adem.202000082.
Sassi, M., Salamone, M. M., Ruffo, R., Patriarca, G. E., Mari, C. M., Pagani, G. A., Posset. U. & Beverina, L. “State-of-the-Art neutral tint multichromophoric polymers for high-contrast see-through electrochromic devices.” Adv. Funct. Mater., 26, 5240-5246 (2016). DOI: 10.1002/adfm.201601819.
Sévery, L. et al. “Immobilization of molecular catalysts on electrode surfaces using host-guest interactions.” Nat. Catal., 13, 523-529 (2021). DOI: 10.1038/s41557-021-00652-y.
Shao, Z. et al. “All-solid-state proton-based tandem structures for fast-switching electrochromic devices.” Nat. Electron., 5, 45-52 (2022). DOI:10.21203/rs.3.rs-321790/v1.
Shin, H. et al. “Energy saving electrochromic windows from bistable low-HOMO level conjugated polymers.” Energy Environ. Sci. 9, 117-122 (2016). DOI: 10.1039/C5EE03160E.
Skoog, D., Holler, F. & Nieman, T. “Principles of Instrumental Analysis,” 6th Ed. (Cengage Learning, 2006).
Strand, M. et al. “Polymer inhibitors enable >900 cm² dynamic windows based on reversible metal electrodeposition with high solar modulation.” Nat. Energy 6, 546-554 (2021). DOI: 10.1038/s41560-021-00816-7.
Takashima, Y. et al. “Expansion-contraction of photoresponsive artificial muscle regulated by host-guest interactions,” Nat. Commun. 3, 1207 (2012). DOI: 10.1038/ncomms2280.
Tayi, S. et al. “Supramolecular ferroelectrics.” Nat. Chem. 7, 281-294 (2015). DOI: 10.1038/nchem.2206.
Teitelbaum, R., Ruby, S., & Marks, T. “On the structure of starch-iodine.” J. Am. Chem. Soc. 100, 3215 (1978). DOI: 10.1021/ja00478a045.
Thakur, V., Ding, G., Ma, J., Lee, P., & Lu, X. “Hybrid materials and polymer electrolytes for electrochromic device applications.” Adv. Mater. 24, 4071-4096 (2012). DOI: 10.1002/adma.201200213.
Vankova, S. et al. “WO₃ nanorolls self-assembled as thin films by hydrothermal synthesis.” Nanoscale, 7, 7174-7177 (2015). DOI:10.1039/C4NR07290A.
Wang, Y. et al. “A multicolour bistable electronic shelf label based on intramolecular proton-coupled electron transfer.” Nat. Mater. 18, 1335-1342 (2019). DOI: 10.1038/s41563-019-0471-8.
Wang, Y. et al. “A see-through electrochromic display via dynamic metal-ligand interactions.” Chem. 7, 1308-1320 (2021). DOI: 10.1016/j.chempr.2021.02.005.
Wang, Y. et al. “High Performance of Simple Organic Phosphorescence Host-Guest Materials and their Application in Time Resolved Bioimaging.” Adv. Mater. 33, 2007811 (2021). DOI: 10.1002/adma.202007811.
Wang, Y., Nie, H., Han, J., An, Y., Zhang, Y.-M. & Zhang, X.-A. “Green Revolution in Electronic Displays Expected to Ease Energy and Health Crises.” Light: Sci. & Appl. 10, 33 (2021). DOI:10.1038/s41377-020-00455-9.
Wang, Y., Shen, R., Wang, S., Zhang, Y.-M., Zhang, S. X.-A. “Dynamic Metal-Ligand Interaction of Synergistic Polymers for Bistable See-Through Electrochromic Devices.” Adv. Mater. 34, 2104413 (2022). DOI: 10.1002/adma.202104413.
Wang, Y., Zhang, Y.-M., Zhang, S. X.-A. “Stimuli-induced reversible proton transfer for stimuli-responsive materials and devices.” Acc. Chem. Res. 54, 2216-2226 (2021). DOI: 10.1021/acs.accounts.1c00061.
Welsh, D. M., Kumar, A., Meijer, E. W., & Reynolds, J. R. “Enhanced contrast ratios and rapid switching in electrochromics based on poly (3, 4-propylenedioxythiophene) derivatives.” Adv. Mater. 11, 1379-1382 (1999). DOI: 10.1002/(SICI)1521-4095 (199911)11:16<1379::AID-ADMA1379>3.0.CO;2-Q.
Wen, R., Granqvist, C., & Niklasson, G. “Eliminating degradation and uncovering ion-trapping dynamics in electrochromic WO₃ thin films.” Nat. Mater. 14, 996-1001 (2015). DOI: 10.1038/nmat4368.
Wu, X. et al. “The role of host-guest interactions in organic emitters employing MR-TADF.” Photonics, 15, 780-786 (2021). DOI: 10.1038/s41566-021-00870-3.
Yang, G. et al. “Advances in nanomaterials for electrochromic devices.” Chem. Soc. Rev. 49, 8687-8720 (2020). DOI: 10.1039/DOCS00317D.
Zhang, S., Cao, S., Zhang, T., Fisher, A., & Lee, J. “Al³ intercalation/de-intercalation-enabled dual-band electrochromic smart windows with a high optical modulation, quick response and long cycle life.” Energy Environ. Sci. 11, 2884-2892 (2018). DOI: 10.1039/C8EE01718B.
Zhang, S.-J. et al. “Polyiodide Confinement by Starch Enables Shuttle-Free Zn-Iodine Batteries.” Adv. Mater. 34, 2201716. DOI: 10.1002/adma.202201716.
Zhang, W. et al. “Bio-inspired ultra-high energy efficiency bistable electronic billboard and reader.” Nat. Commun. 10, 1559 (2019). DOI: 10.1038/s41467-019-09556-5.

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/of” means that one, all, or any combination of items in a list separated by “and/of” are included in the list; for example “1, 2 and/or 3” is equivalent to “1, 2, 3, 1 and 2, 1 and 3, 2 and 3, or 1, 2, and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. An electrochromic device, comprising:
a first electrode;
an electrochromic layer over the first electrode, wherein the electrochromic layer comprises an electrolyte, a host unit, and a guest unit;
an ion conducting layer over the electrochromic layer;
an ion storage layer over the ion conducting layer; and
a second electrode over the ion storage layer,
wherein the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex.

2. The electrochromic device of claim 1, further comprising a solvent or polymer carrier.

3. The electrochromic device of claim 1, wherein:
the first reduction or oxidation stimulation comprises a first voltage application between the first electrode and the second electrode,
wherein the second oxidation or reduction stimulation comprises a second voltage application between the first electrode and the second electrode,
the first voltage application is greater than or about 0.1 V, and
wherein the second voltage application is less than or about 0.1 V.

4-6. (canceled)

7. The electrochromic device of claim 1, wherein the host unit comprises a starch, a cyclodextrin, or a cyclic polyether.

8. The electrochromic device of claim 1, wherein the host unit comprises cyclodextrin, dextrin, amylose, a cellulose, amylopectin, chitosan, pillararene, cucurbituril, calixarene, or a crown ether.

9-11. (canceled)

12. The electrochromic device of claim 1, wherein the guest unit comprises an anion or an organic redox molecule.

13. The electrochromic device of claim 12, wherein the guest unit comprises I−, B−, Cl−, SO₃²⁻, NO₃²⁻, ClO−, PO₄³⁻, a p-benzoquinone derivative, a urea derivative, a hydroquinone derivative, a viologen derivative, or an organic redox molecule containing a carbonyl, carboxyl, amino, or sulfhydryl group.

14-15. (canceled)

16. The electrochromic device of claim 1, wherein the ion conducting layer is configured to prevent an intermixing of redox ions from the electrochromic layer and from the ion storage layer.

17. The electrochromic device of claim 1, wherein the electrochromic layer comprises an aqueous state, a gel, or a solid film state.

18. The electrochromic device of claim 17, wherein the electrochromic layer comprises an ionic gel selected to provide an electrostatic interaction with the host unit, the guest unit, the host-guest complex, and any combination thereof.

19. The electrochromic device of claim 18, wherein the electrostatic interaction between the ionic gel and the host unit, the guest unit, the host-guest complex, and any combination thereof inhibits thermal diffusion of the host unit, the guest unit, the host-guest complex, and any combination thereof.

20. (canceled)

21. The electrochromic device of claim 1, wherein the host unit and guest unit interact to form the host-guest complex via dynamic hydrogen-bonding, Van der Waals interactions, or other supramolecular interactions upon oxidation or reduction.

22. The electrochromic device of claim 1, wherein a magnitude of transmittance of visible, infrared, ultraviolet electromagnetic radiation, or a combination thereof through the first electrode, the electrochromic layer, the ion conducting layer, the ion storage layer, and the second electrode is at least 70% during the second oxidation or reduction stimulation.

23. The electrochromic device of claim 1, wherein the first electrode, the electrochromic layer, the ion conducting layer, the ion storage layer, and the second electrode exhibit a colorless state upon the second oxidation or reduction stimulation.

24. The electrochromic device of claim 1, wherein a magnitude of transmittance of visible, infrared, ultraviolet electromagnetic radiation, or a combination thereof through the first electrode, the electrochromic layer, the ion conducting layer, the ion storage layer, and the second electrode is at most 70% during the first reduction or oxidation stimulation.

25. The electrochromic device of claim 1, wherein the first electrode, the electrochromic layer, the ion conducting layer, the ion storage layer, and the second electrode exhibit a colored state upon the first reduction or oxidation stimulation.

26. The electrochromic device of claim 25, wherein the colored state persists for 2 hours.

27. The electrochromic device of claim 1, wherein a magnitude of transmittance of visible, infrared, ultraviolet electromagnetic radiation, or a combination thereof through the first electrode, the electrochromic layer, the ion conducting layer, the ion storage layer, and the second electrode varies upon application of different voltages between the first electrode and the second electrode.

28. (canceled)

29. A method of making an electrochromic device, the method comprising:
positioning an electrochromic layer over a first electrode, wherein the electrochromic layer comprises an electrolyte, a host unit, and a guest unit;
positioning an ion conducting layer over the electrochromic layer;
positioning an ion storage layer over the ion conducting layer; and
positioning a second electrode over the ion storage layer,
wherein the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex.

30-41. (canceled)

42. A method comprising:
providing an electrochromic device, the electrochromic device comprising:
a first electrode;
an electrochromic layer over the first electrode, wherein the electrochromic layer comprises an electrolyte, a host unit, and a guest unit;
an ion conducting layer over the electrochromic layer;
an ion storage layer over the ion conducting layer; and a second electrode over the ion storage layer,
wherein the host unit and guest unit are configured to form a host-guest complex upon a first reduction or oxidation stimulation to the host unit or the guest unit and wherein the host-guest complex is configured to reversibly dissociate to the host unit and the guest unit upon a second oxidation or reduction stimulation to the host-guest complex;
applying a first voltage between the first electrode and the second electrode corresponding to a first reduction or oxidation stimulation; and
applying a second voltage between the first electrode and the second electrode corresponding to a second reduction or oxidation stimulation.

43-55. (canceled)
